(19) United States
(12) Patent Application Publication
(10) Pub. No.: US 2022/0046722 A1
(43) Pub. Date: Feb. 10, 2022

(54) METHOD FOR OPERATING TERMINAL AND BASE STATION IN WIRELESS COMMUNICATION SYSTEM SUPPORTING UNLICENSED BAND, AND DEVICE SUPPORTING SAME

(71) Applicant: LG ELECTRONICS INC., Seoul (KR)

(72) Inventors: Seonwook KIM, Seoul (KR); Changhwan PARK, Seoul (KR); Duckhyun BAE, Seoul (KR); Suckchel YANG, Seoul (KR); Sukhyon YOON, Seoul (KR)

(73) Assignee: LG ELECTRONICS INC., Seoul (KR)

(21) Appl. No.: 17/312,345

(22) PCT Filed: May 17, 2019
(86) PCT No.: PCT/KR2019/005927

§ 371 Date: Jun. 9, 2021

(30) Foreign Application Priority Data
Jan. 10, 2019 (KR) 10-2019-0003570

(51) Int. Cl. H04W 74/08; H04W 74/00; H04W 24/08; H04W 76/28; H04W 72/04

(52) U.S. Cl. CPC H04W 74/0841; H04W 74/006; H04W 74/0866; H04W 72/042; H04W 76/28; H04W 72/0446; H04W 24/08

(57) ABSTRACT

Disclosed are: a method for transmitting and receiving a downlink signal between a terminal and a base station in a wireless communication system supporting an unlicensed band; and a device supporting same. As a more specific embodiment, disclosed are: an operation method in which a base station and a terminal set for discontinuous reception (DRX) perform signal transmission and reception set through higher layer signaling; and a device supporting same.

### TECHNICAL FIELD

The following description relates to a wireless communication system, and more particularly, to a method for operating a terminal and a base station in a wireless communication system supporting an unlicensed band, and a device supporting the same.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

As a number of communication devices have required higher communication capacity, the necessity of the mobile broadband communication much improved than the existing radio access technology (RAT) has increased. In addition, massive machine type communications (MTC) capable of providing various services at anytime and anywhere by connecting a number of devices or things to each other has been considered in the next generation communication system. Moreover, a communication system design capable of supporting services/UEs sensitive to reliability and latency has been discussed.

As described above, the introduction of the next generation RAT considering the enhanced mobile broadband communication, massive MTC, ultra-reliable and low latency communication (URLLC), and the like has been discussed.

The present disclosure may relate to the following technical configurations.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving or Autonomous Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

FIG. 1 illustrates an AI device 100 according to an embodiment of the present disclosure.

The AI device 100 may be implemented by a stationary device or a mobile device, such as a TV, a projector, a mobile phone, a smartphone, a desktop computer, a notebook, a digital broadcasting UE, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes global system for mobile communication (GSM), code division multi access (CDMA), long term evolution (LTE), 5^{th} generation (5G), wireless local area network (WLAN), wireless fidelity (Wi-Fi), Bluetooth™, radio frequency identification (RFID), infrared data association (IrDA), ZigBee, near field communication (NFC), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

### DISCLOSURE

### Technical Problem

An object of the present disclosure is to provide a method for operating a terminal and a base station in a wireless communication system supporting an unlicensed band, and devices supporting the same.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

The present disclosure provides a method of operating a terminal and a base station in a wireless communication system supporting an unlicensed band, and apparatuses supporting the same.

In one aspect of the present disclosure, provided herein is a method of operating a terminal in a wireless communication system supporting an unlicensed band, the method including: receiving, through higher layer signaling, configuration information related to one or more of reception of one or more downlink (DL) signals or transmission of one or more uplink (UL) signals on a resource not configured either as a DL resource or as a UL resource; performing physical downlink control channel (PDCCH) monitoring in the unlicensed band for an on duration, based on discontinuous reception (DRX) being configured for the terminal; based on the configuration information related to the reception of the one or more DL signals being received, and downlink control information (DCI) including slot format indicator (SFI) information being detected through the PDCCH monitoring, performing the reception of the one or more DL signals on the DL resource in the unlicensed band only when the SFI information indicates that the resource for the reception of the one or more DL signals is a DL resource; and based on the configuration information related to the transmission of the one or more UL signals being received, performing the transmission of the one or more UL signals through the unlicensed band regardless of whether the DCI is detected through the PDCCH monitoring.

As an example, the resource not configured either as the DL resource or as the UL resource may be configured as a flexible resource through the higher layer signaling.

As another example, the resource not configured either as the DL resource or as the UL resource may be a resource not configured as a flexible resource by the higher layer signaling.

In the present disclosure, the performing of the transmission of the one or more UL signals by the terminal may include transmitting the one or more UL signals in the unlicensed band using a channel access procedure (CAP) to the unlicensed band.

In the present disclosure, the SFI information may indicate that each symbol included in one or more slots is related to one of a DL symbol, a UL symbol, or a flexible symbol.

Herein, the one slot may include 14 symbols.

In the present disclosure, the one or more DL signals may include one or more of a physical downlink shared channel (PDSCH) signal or a channel state information reference signal (CSI-RS).

In the present disclosure, the one or more UL signals may include one or more of a sounding reference signal (SRS), a physical uplink control channel (PUCCH) signal, a physical uplink shared channel (PUSCH) signal, or a physical random access channel (PRACH) signal.

In the present disclosure, the DCI may be configured to be commonly transmitted to a plurality of terminals including the terminal.

In the present disclosure, based on the DRX being configured, the terminal may switch to a sleep state when the terminal fails to receive a PDCCH including the DCI for the on duration of the configuration of the DRX.

In order to perform the one or more of the reception of the one or more DL signals or the transmission of the one or more UL signals, the method may further include the following operations:

Receiving a synchronization signal and a physical broadcast channel (PBCH) signal from a base station; and

Establishing a radio resource control (RRC) connection with the base station based on the synchronization signal and the PBCH signal.

Herein, the establishing of the RRC connection may include the following operations:

Transmitting a random access channel preamble to the base station through a physical random access channel (PRACH) resource determined based on the synchronization signal and the PBCH signal;

Receiving a random access response (RAR) message in response to the random access channel preamble;

Transmitting an RRC connection request message to the base station based on a UL grant included in the RAR message; and

Receiving a contention resolution message from the base station in response to the RRC connection request message.

In another aspect of the present disclosure, provided herein is a method of operating a base station in a wireless communication system supporting an unlicensed band, the method including: transmitting, through higher layer signaling, configuration information related to one or more of reception of one or more downlink (DL) signals or transmission of one or more uplink (UL) signals to a terminal on a resource not configured either as a DL resource or as a UL resource; performing a channel access procedure (CAP) for transmission of downlink control information (DCI) including slot format indicator (SFI) information through the unlicensed band; based on the configuration information being related to the reception of the one or more DL signals and the DCI being transmitted through the unlicensed band based on the CAP, transmitting the one or more DL signals to the terminal through the unlicensed band only when the SFI information indicates that the resource for the reception of the one or more DL signals is a DL resource; and when the configuration information is related to the transmission of the one or more UL signals, receiving the one or more UL signals from the terminal through the unlicensed band, regardless of whether the DCI is transmitted through the unlicensed band based on the CAP.

In another aspect of the present disclosure, provided herein is a terminal operating in a wireless communication system supporting an unlicensed band, the terminal including: at least one radio frequency (RF) module; at least one processor; and at least one memory operatively connected to the at least one processor and configured to store instructions causing, when executed, the at least one processor to perform the following operation, wherein the following operation includes:receiving, through higher layer signaling, configuration information related to one or more of reception of one or more downlink (DL) signals or transmission of one or more uplink (UL) signals on a resource not configured either as a DL resource or as a UL resource by controlling the at least one RF module; performing physical downlink control channel (PDCCH) monitoring in the unlicensed band for an on duration by controlling the at least one RF module, based on discontinuous reception (DRX) being configured for the terminal; based on the configuration information related to the reception of the one or more DL signals being received, and downlink control information (DCI) including slot format indicator (SFI) information being detected through the PDCCH monitoring, performing the reception of the one or more DL signals on the DL resource in the unlicensed band by controlling the at least one RF module only when the SFI information indicates that the resource for the reception of the one or more DL signals is a DL resource; and based on the configuration information related to the transmission of the one or more UL signals being received, performing the transmission of the one or more UL signals through the unlicensed band by controlling the at least one RF module, regardless of whether the DCI is detected through the PDCCH monitoring.

It is to be understood that both the foregoing general description and the following detailed description of the present disclosure are exemplary and explanatory and are intended to provide further explanation of the disclosure as claimed.

### Advantageous Effects

As is apparent from the above description, the embodiments of the present disclosure have the following effects.

According to the present disclosure, even when a base station cannot transmit downlink control information (DCI) including slot format indicator (SFI) information to the terminal through the unlicensed band due to the characteristics of the unlicensed band, which requires competitive channel occupancy for signal transmission, the terminal may perform preconfigured uplink signal transmission (even though a resource for the preconfigured uplink signal transmission is not explicitly indicated/configured as an uplink resource).

Accordingly, when transmission of an uplink signal through an unlicensed band is preconfigured, unnecessary delay/cancellation of transmission and reception of the uplink signal between the terminal and the base station may be minimized.

In addition, by operating in the DRX mode, the terminal may minimize power consumption for reception/detection of downlink control information.

In transmitting and receiving a downlink signal through an unlicensed band, if the BS does not transmit DCI including SFI information to the UE through the unlicensed band, there is a high possibility that the BS does not transmit the downlink signal to the UE (because it does not occupy the unlicensed band), and accordingly, detection of unnecessary downlink signals may be minimized from the viewpoint of the UE.

It will be appreciated by persons skilled in the art that the effects that could be achieved with the present disclosure are not limited to what has been particularly described hereinabove and other advantages of the present disclosure will be more clearly understood from the following detailed description. That is, effects which are not intended by the present disclosure may be derived by those skilled in the art from the embodiments of the present disclosure.

### DESCRIPTION OF DRAWINGS

The accompanying drawings, which are included to provide a further understanding of the present disclosure, illustrate the embodiments of the present disclosure together with detail explanation. However, the technical features of the present disclosure are not limited to a specific drawing. The features disclosed in each of the drawings are combined with each other to configure a new embodiment. Reference numerals in each drawing correspond to structural elements.

FIG. 1 illustrates an artificial intelligence (AI) device according to an embodiment of the present disclosure.

FIG. 2 illustrates an AI server according to an embodiment of the present disclosure.

FIG. 3 illustrates an AI system according to an embodiment of the present disclosure.

FIG. 4 is a diagram illustrating physical channels and a general signal transmission method using the physical channels.

FIGS. 5 and 6 are diagrams illustrating radio frame structures in an LTE system to which the embodiments of the present disclosure are applicable.

FIG. 7 is a diagram illustrating a slot structure in an LTE system to which embodiments of the present disclosure are applied.

FIG. 8 illustrates a DL subframe structure in an LTE system to which the embodiments of the present disclosure are applicable.

FIG. 9 is a diagram illustrating a UL subframe structure in an LTE system to which the embodiments of the present disclosure are applicable.

FIG. 10 is a diagram illustrating a radio frame structure in an NR system to which the embodiments of the present disclosure are applicable.

FIG. 11 is a diagram illustrating a slot structure in an NR system to which the embodiments of the present disclosure are applicable.

FIG. 12 is a diagram illustrating a self-contained slot structures in an NR system to which the embodiments of the present disclosure are applicable.

FIG. 13 is a diagram illustrating the structure of one REG in an NR system to which the embodiments of the present disclosure are applicable.

FIGS. 14 and 15 are diagrams illustrating representative methods for connecting TXRUs to antenna elements.

FIG. 16 is a diagram schematically illustrating an exemplary hybrid BF structure from the perspective of TXRUs and physical antennas according to the present disclosure.

FIG. 17 is a diagram schematically illustrating an exemplary beam sweeping operation for a synchronization signal and system information in a DL transmission procedure according to the present disclosure.

FIG. 18 is a schematic diagram illustrating an SS/PBCH block applicable to the present disclosure.

FIG. 19 is a schematic diagram illustrating an SS/PBCH block transmission structure applicable to the present disclosure.

FIG. 20 illustrates an exemplary wireless communication system supporting an unlicensed band, which is applicable to the present disclosure.

FIG. 21 is a diagram for explaining a CAP for U-band transmission applicable to the present disclosure.

FIG. 22 is a diagram illustrating a partial transmission time interval (TTI) or a partial subframe/slot applicable to the present disclosure.

FIG. 23 is a diagram schematically illustrating the operation of a UE and a BS in an unlicensed band applicable to the present disclosure.

FIG. 24 illustrates an exemplary procedure for network initial access and subsequent communication.

FIG. 25 is a diagram illustrating a DRX cycle (RRC_CONNECTED state).

FIG. 26 is a diagram illustrating operations of a UE and a BS applicable to the present disclosure, FIG. 27 is a flowchart illustrating an operation of a UE according to the present disclosure, and FIG. 28 is a flowchart illustrating an operation of a BS according to the present disclosure.

FIG. 29 is a diagram illustrating configurations of a UE and a BS which may implement proposed embodiments.

FIG. 30 is a block diagram of a communication device which may implement proposed embodiments.

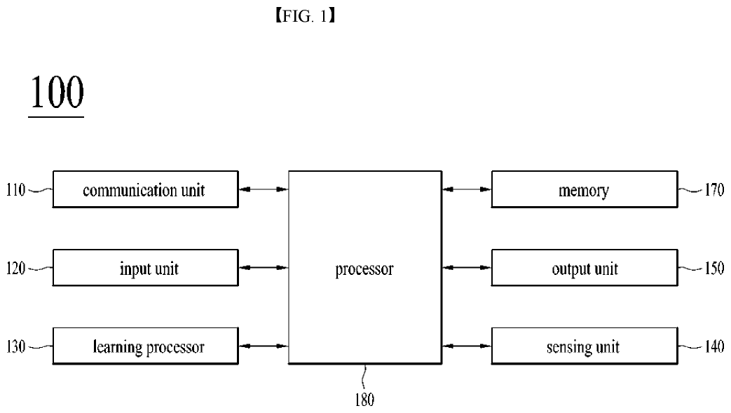

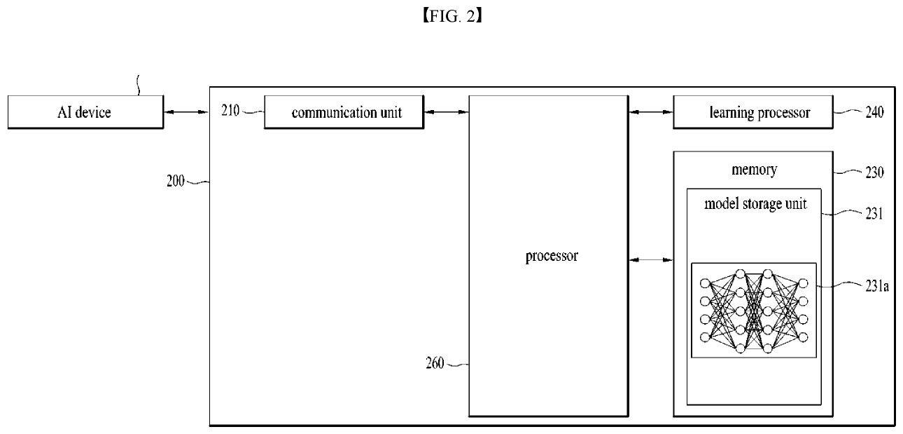

### BEST MODE

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the attached drawings, a detailed description of known procedures or steps of the present disclosure will be avoided lest it should obscure the subject matter of the present disclosure. In addition, procedures or steps that could be understood to those skilled in the art will not be described either.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a user equipment (UE). A BS refers to a terminal node of a network, which directly communicates with a UE. A specific operation described as being performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an evolved Node B (eNode B or eNB), gNode B (gNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmission end is a fixed and/or mobile node that provides a data service or a voice service and a reception end is a fixed and/or mobile node that receives a data service or a voice service. Therefore, a UE may serve as a transmission end and a BS may serve as a reception end, on an uplink (UL). Likewise, the UE may serve as a reception end and the BS may serve as a transmission end, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5G NR system and a 3GPP2 system. In particular, the embodiments of the present disclosure may be supported by the standard specifications, 3GPP TS 36.211, 3GPP TS 36.212, 3GPP TS 36.213, 3GPP TS 36.321, 3GPP TS 36.331, 3GPP TS 37.213, 3GPP TS 38.211, 3GPP TS 38.212, 3GPP TS 38.213, 3GPP TS 38.321 and 3GPP TS 38.331. That is, the steps or parts, which are not described to clearly reveal the technical idea of the present disclosure, in the embodiments of the present disclosure may be explained by the above standard specifications. All terms used in the embodiments of the present disclosure may be explained by the standard specifications.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

Hereinafter, 3GPP LTE/LTE-A systems and 3GPP NR system are explained, which are examples of wireless access systems.

The embodiments of the present disclosure can be applied to various wireless access systems such as code division multiple access (CDMA), frequency division multiple access (FDMA), time division multiple access (TDMA), orthogonal frequency division multiple access (OFDMA), single carrier frequency division multiple access (SC-FDMA), etc.

CDMA may be implemented as a radio technology such as Universal Terrestrial Radio Access (UTRA) or CDMA2000. TDMA may be implemented as a radio technology such as Global System for Mobile communications (GSM)/General packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved UTRA (E-UTRA), etc.

UTRA is a part of Universal Mobile Telecommunications System (UMTS). 3GPP LTE is a part of Evolved UMTS (E-UMTS) using E-UTRA, adopting OFDMA for DL and SC-FDMA for UL. LTE-Advanced (LTE-A) is an evolution of 3GPP LTE.

While the embodiments of the present disclosure are described in the context of 3GPP LTE/LTE-A systems and 3GPP NR system in order to clarify the technical features of the present disclosure, the present disclosure is also applicable to an IEEE 802.16e/m system, etc.

1. 3GPP LTE/LTE-A System

1.1. Physical Channels and Transmitting/Receiving Signal

In a wireless access system, a UE receives information from a base station on a DL and transmits information to the base station on a UL. The information transmitted and received between the UE and the base station includes general data information and various types of control information. There are many physical channels according to the types/usages of information transmitted and received between the base station and the UE.

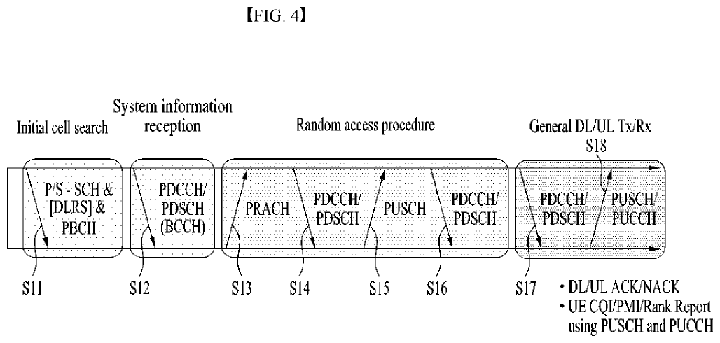

FIG. 4 illustrates physical channels and a general signal transmission method using the physical channels, which may be used in embodiments of the present disclosure.

When a UE is powered on or enters a new cell, the UE performs initial cell search (S11). The initial cell search involves acquisition of synchronization to a BS. Specifically, the UE synchronizes its timing to the base station and acquires information such as a cell identifier (ID) by receiving a primary synchronization channel (P-SCH) and a secondary synchronization channel (S-SCH) from the BS.

Then the UE may acquire information broadcast in the cell by receiving a physical broadcast channel (PBCH) from the base station.

During the initial cell search, the UE may monitor a DL channel state by receiving a Downlink Reference Signal (DL RS).

After the initial cell search, the UE may acquire more detailed system information by receiving a physical downlink control channel (PDCCH) and receiving on a physical downlink shared channel (PDSCH) based on information of the PDCCH (S12).

Subsequently, to complete connection to the eNB, the UE may perform a random access procedure with the eNB (S13 to S16). In the random access procedure, the UE may transmit a preamble on a physical random access channel (PRACH) (S13) and may receive a PDCCH and a random access response (RAR) for the preamble on a PDSCH associated with the PDCCH (S14). The UE may transmit a PUSCH by using scheduling information in the RAR (S15), and perform a contention resolution procedure including reception of a PDCCH signal and a PDSCH signal corresponding to the PDCCH signal (S16).

After the above procedure, the UE may receive a PDCCH and/or a PDSCH from the BS (S17) and transmit a physical uplink shared channel (PUSCH) and/or a physical uplink control channel (PUCCH) to the BS (S18), in a general UL/DL signal transmission procedure.

Control information that the UE transmits to the BS is generically called uplink control information (UCI). The UCI includes a hybrid automatic repeat and request acknowledgement/negative acknowledgement (HARQ-ACK/NACK), a scheduling request (SR), a channel quality indicator (CQI), a precoding matrix index (PMI), a rank indicator (RI), etc.

In general, UCI is transmitted periodically on a PUCCH. However, if control information and traffic data should be transmitted simultaneously, the control information and traffic data may be transmitted on a PUSCH. In addition, the UCI may be transmitted aperiodically on the PUSCH, upon receipt of a request/command from a network.

1.2. Radio Frame Structures

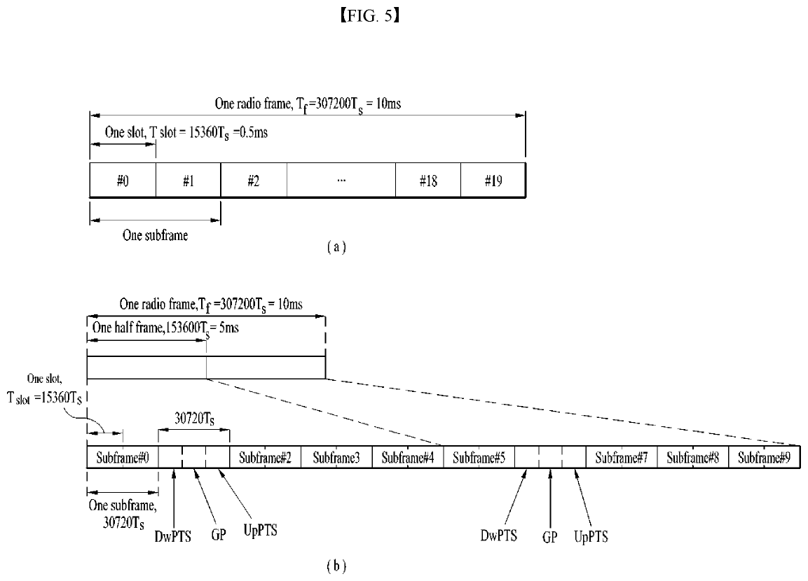

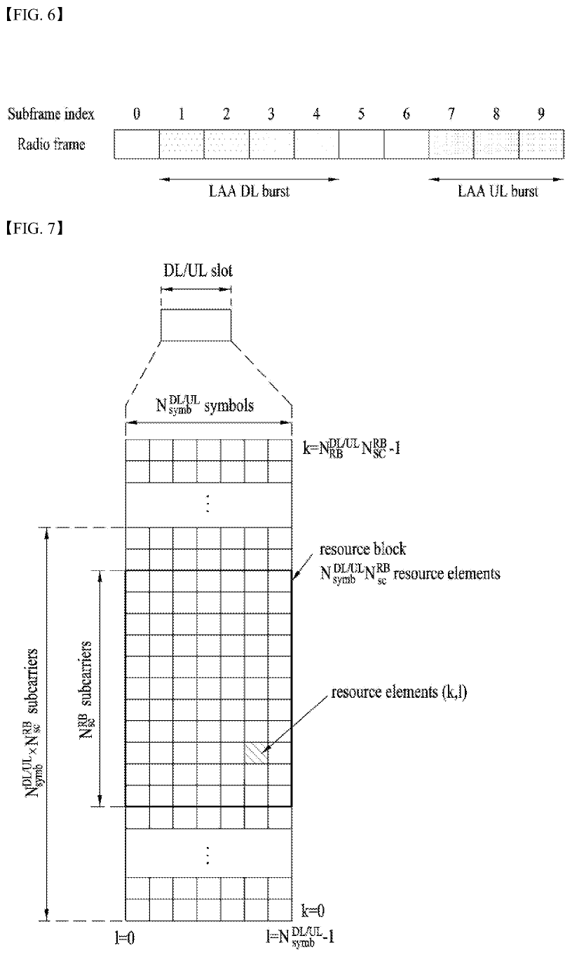

FIGS. 5 and 6 are diagrams illustrating radio frame structures in an LTE system to which the embodiments of the present disclosure are applicable.

The LTE system supports frame structure type 1 for frequency division duplex (FDD), frame structure type 2 for time division duplex (TDD), and frame structure type 3 for an unlicensed cell (UCell). In the LTE system, up to 31 secondary cells (SCells) may be aggregated in addition to a primary cell (PCell). Unless otherwise specified, the following operation may be applied independently on a cell basis.

In multi-cell aggregation, different frame structures may be used for different cells. Further, time resources (e.g., a subframe, a slot, and a subslot) within a frame structure may be generically referred to as a time unit (TU).

FIG. 5(a) illustrates frame structure type 1. Frame type 1 is applicable to both a full Frequency Division Duplex (FDD) system and a half FDD system.

A DL radio frame is defined by 10 1-ms subframes. A subframe includes 14 or 12 symbols according to a cyclic prefix (CP). In a normal CP case, a subframe includes 14 symbols, and in an extended CP case, a subframe includes 12 symbols.

Depending on multiple access schemes, a symbol may be an OFDM(A) symbol or an SC-FDM(A) symbol. For example, a symbol may refer to an OFDM(A) symbol on DL and an SC-FDM(A) symbol on UL. An OFDM(A) symbol may be referred to as a cyclic prefix-OFDMA(A) (CP-OFDM(A)) symbol, and an SC-FMD(A) symbol may be referred to as a discrete Fourier transform-spread-OFDM(A) (DFT-s-OFDM(A)) symbol.

One subframe may be defined by one or more slots according to a subcarrier spacing (SCS) as follows.

When SCS=7.5 kHz or 15 kHz, subframe #i is defined by two 0.5-ms slots, slot #2i and slot #2i+1 (i=0˜9).

When SCS=1.25 kHz, subframe #i is defined by one 1-ms slot, slot #2i.

When SCS=15 kHz, subframe #i may be defined by six subslots as illustrated in Table 1.

Table 1 lists exemplary subslot configurations for one subframe (normal CP).

TABLE 1

| Subslot number | 0 | 1 | 2 | 3 | 4 | 5 |
|---|---|---|---|---|---|---|
| Slot number | 2i | | | 2i + 1 | | |
| Uplink subplot pattern | 0, 1, 2 | 3, 4 | 5, 6 | 0, 1 | 2, 3 | 4, 5, 6 |
| (Symbol number) | | | | | | |
| Downlink subslot pattern 1 | 0, 1, 2 | 3, 4 | 5, 6 | 0, 1 | 2, 3 | 4, 5, 6 |
| (Symbol number) | | | | | | |
| Downlink subsist pattern 2 | 0, 1 | 2, 3, 4 | 5, 6 | 0, 1 | 2, 3 | 4, 5, 6 |
| (Symbol number) | | | | | | |

FIG. 5(b) illustrates frame structure type 2. Frame structure type 2 is applied to a TDD system. Frame structure type 2 includes two half frames. A half frame includes 4 (or 5) general subframes and 1 (or 0) special subframe. According to a UL-DL configuration, a general subframe is used for UL or DL. A subframe includes two slots.

Table 2 lists exemplary subframe configurations for a radio frame according to UL-DL configurations.

TABLE 2

| Uplink- | Downlink-to- | | | | | | | | | | |
|---|---|---|---|---|---|---|---|---|---|---|---|
| downlink | Uplink Switch | | | | | | | | | | |
| con- | point | Subframe number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 2, D represents a DL subframe, U represents a UL subframe, and S represents a special subframe. A special subframe includes a downlink pilot time slot (DwPTS), a guard period (GP), and an uplink pilot time slot (UpPTS). The DwPTS is used for initial cell search, synchronization, or channel estimation at a UE. The UpPTS is used for channel estimation at an eNB and acquisition of UL transmission synchronization at a UE. The GP is a period for cancelling interference of a UL caused by the multipath delay of a DL signal between a DL and the UL.

Table 3 lists exemplary special subframe configurations.

TABLE 3

| | Normal cyclic prefix in downlink | | | Extended cyclic prefix in downlink | | |
|---|---|---|---|---|---|---|
| | | UpPTS | | | UpPTS | |
| Special | | Normal cyclic | Extended cyclic | | Normal cyclic | Extended cyclic |
| subframe | | prefix | prefix | | prefix | prefix |
| configuration | DwPTS | in uplink | in uplink | DwPTS | in uplink | in uplink |
| 0 | 6592 · T_{S} | (1 + X) · 2192 · T_{S} | (l + X) · 2560 · T_{S} | 7680 · T_{S} | (l + X) · 2192 · T_{S} | (1 + X) · 2560 · T_{S} |
| 1 | 19760 · T_{S} | | | 20480 · T_{S} | | |
| 2 | 21952 · T_{S} | | | 23040 · T_{S} | | |
| 3 | 24144 · T_{S} | | | 25600 · T_{S} | | |
| 4 | 26336 · T_{S} | | | 7680 · T_{S} | (2 + X) · 2192 · T_{S} | (2 + X) · 2560 · T_{S} |
| 5 | 6592 · T_{S} | (2 + X) · 2192 · T_{S} | (2 + X) · 2560 · T_{S} | 20480 · T_{S} | | |
| 6 | 19760 · T_{S} | | | 23040 · T_{S} | | |
| 7 | 21952 · T_{S} | | | 12S00 · T_{S} | | |
| 8 | 24144 · T_{S} | | | — | — | — |
| 9 | 13168 · T_{S} | | | — | — | — |
| 10 | 13168 · T_{S} | 13152 · T_{S} | 12800 · T_{S} | — | — | — |

In Table 3, X is configured by higher-layer signaling (e.g., radio resource control (RRC) signaling or the like) or given as 0.

FIG. 6 is a diagram illustrating frame structure type 3.

Frame structure type 3 may be applied to a UCell operation. Frame structure type 3 may be applied to, but not limited to, a licensed assisted access (LAA) SCell with a normal CP. A frame is 10 ms in duration, including 10 1-ms subframes. Subframe #i is defined by two consecutive slots, slot #2i and slot #2i+1. Each subframe in a frame may be used for a DL or UL transmission or may be empty. A DL transmission occupies one or more consecutive subframes, starting from any time in a subframe and ending at a boundary of a subframe or in a DwPTS of Table 3. A UL transmission occupies one or more consecutive subframes.

FIG. 7 is a diagram illustrating a slot structure in an LTE system to which embodiments of the present disclosure are applied.

Referring to FIG. 7, a slot includes a plurality of OFDM symbols in the time domain by a plurality of resource blocks (RBs) in the frequency domain. A symbol may refer to a symbol duration. A slot structure may be described by a resource grid including N^{DL/UL}_{RB}N^{RB}_{sc} subcarriers and N^{DL/UL}_{symb} symbols. N^{DL}_{RB} denotes the number of RBs in a DL slot, and N^{UL}_{RB} denotes the number of RBs in a UL slot. N^{DL}_{RB} and N^{UL}_{RB} are dependent on a DL bandwidth and a UL bandwidth, respectively. N^{DL}_{symb} denotes the number of symbols in the DL slot, and N^{UL}_{symb} denotes the number of symbols in the UL slot. N^{RB}_{sc} denotes the number of subcarriers in one RB. The number of symbols in a slot may vary depending on SCSs and CP lengths (see Table 1). For example, while one slot includes 7 symbols in a normal CP case, one slot includes 6 symbols in an extended CP case.

An RB is defined as N^{DL/UL}_{symb} (e.g., 7) consecutive symbols in the time domain by N^{RB}_{sc} (e.g., 12) consecutive subcarriers in the frequency domain. The RB may be a physical resource block (PRB) or a virtual resource block (VRB), and PRBs may be mapped to VRBs in a one-to-one correspondence. Two RBs each being located in one of the two slots of a subframe may be referred to as an RB pair. The two RBs of an RB pair may have the same RB number (or RB index). A resource with one symbol by one subcarrier is referred to as a resource element (RE) or tone. Each RE in the resource grid may be uniquely identified by an index pair (k, 1) in a slot, where k is a frequency-domain index ranging from 0 to N^{DL/UL}_{RB}×N^{RB}_{sc-}1 and 1 is a time-domain index ranging from 0 to N^{DL/UL}_{symb-}1.

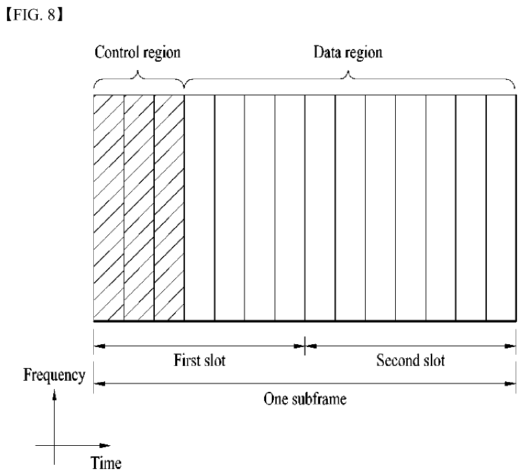

FIG. 8 illustrates a DL subframe structure in an LTE system to which the embodiments of the present disclosure are applicable.

Referring to FIG. 8, up to three (or four) OFDM(A) symbols at the beginning of the first slot of a subframe corresponds to a control region. The remaining OFDM(A) symbols correspond to a data region in which a PDSCH is allocated, and a basic resource unit of the data region is an RB. DL control channels include a physical control format indicator channel (PCFICH), a physical downlink control channel (PDCCH), a physical hybrid-ARQ indicator channel (PHICH), and so on.

The PCFICH is transmitted in the first OFDM symbol of a subframe, carrying information about the number of OFDM symbols (i.e., the size of a control region) used for transmission of control channels in the subframe. The PHICH is a response channel for a UL transmission, carrying a hybrid automatic repeat request (HARQ) acknowledgement (ACK)/negative acknowledgement (NACK) signal. Control information delivered on the PDCCH is called downlink control information (DCI). The DCI includes UL resource allocation information, DL resource control information, or a UL transmit (TX) power control command for any UE group.

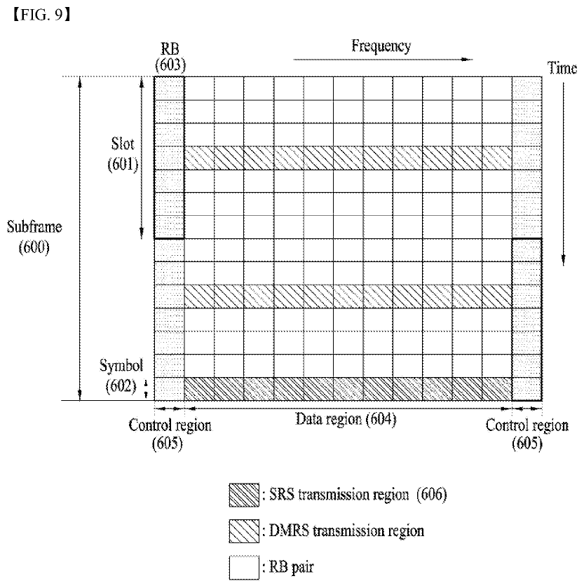

FIG. 9 is a diagram illustrating a UL subframe structure in an LTE system to which the embodiments of the present disclosure are applicable.

Referring to FIG. 9, one subframe 600 includes two 0.5-ms slots 601. Each slot includes a plurality of symbols 602, each corresponding to one SC-FDMA symbol. An RB 603 is a resource allocation unit corresponding to 12 subcarriers in the frequency domain by one slot in the time domain.

A UL subframe is divided largely into a data region 604 and a control region 605. The data region is communication resources used for each UE to transmit data such as voice, packets, and so on, including a physical uplink shared channel (PUSCH). The control region is communication resources used for each UE to transmit an ACK/NACK for a DL channel quality report or a DL signal, a UL scheduling request, and so on, including a physical uplink control channel (PUCCH).

A sounding reference signal (SRS) is transmitted in the last SC-FDMA symbol of a subframe in the time domain.

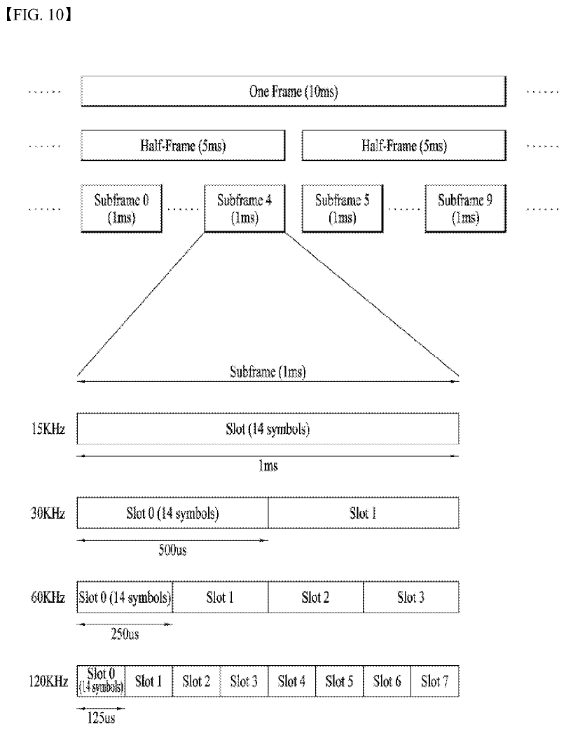

FIG. 10 is a diagram illustrating a radio frame structure in an NR system to which the embodiments of the present disclosure are applicable.

In the NR system, UL and DL transmissions are based on a frame as illustrated in FIG. 10. One radio frame is 10 ms in duration, defined as two 5-ms half-frames. One half-frame is defined as five 1-ms subframes. One subframe is divided into one or more slots, and the number of slots in a subframe depends on an SCS. Each slot includes 12 or 14 OFDM(A) symbols according to a CP. Each slot includes 14 symbols in a normal CP case, and 12 symbols in an extended CP case. Herein, a symbol may include an OFDM symbol (or a CP-OFDM symbol) and an SC-FDMA symbol (or a DFT-s-OFDM symbol).

Table 4 lists the number of symbols per slot, the number of slots per frame, and the number of slots per subframe in the normal CP case, and Table 5 lists the number of symbols per slot, the number of slots per frame, and the number of slots per subframe in the extended CP case.

TABLE 4

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 5

| μ | N_{symb}^{slot} | Nₛₗₒₜ^{frame,μ} | Nₛₗₒₜ^{subframe,μ} |
|---|---|---|---|
| 2 | 12 | 40 | 4 |

In the above tables, N^{slot}_{symb} denotes the number of symbols in a slot, N^{frame,μ}ₛₗₒₜ denotes the number of slots in a frame, and N^{subframe,μ}ₛₗₒₜ denotes the number of slots in a subframe.

In the NR system to which the present disclosure is applicable, different OFDM(A) numerologies (e.g., SCSs, CP length, and so on) may be configured for a plurality of cells aggregated for a UE. Therefore, the (absolute) duration of a time resource (e.g., an SF, slot, or TTI) (for the convenience of description, generically referred to as a time unit (TU)) including the same number of symbols may be different between the aggregated cells.

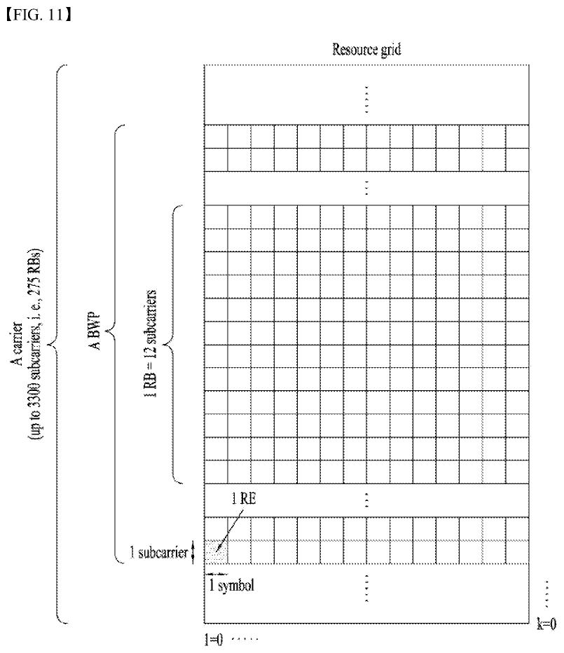

FIG. 11 is a diagram illustrating a slot structure in an NR system to which the embodiments of the present disclosure are applicable.

One slot includes a plurality of symbols in the time domain. For example, one slot includes 7 symbols in a normal CP case and 6 symbols in an extended CP case.

A carrier includes a plurality of subcarriers in the frequency domain. An RB is defined as a plurality of (e.g., 12) consecutive subcarriers in the frequency domain.

A bandwidth part (BWP) is defined as a plurality of consecutive (P)RBs in the frequency domain and may correspond to one numerology (e.g., SCS, CP length, and so on).

A carrier may include up to N (e.g., 5) BWPs. Data communication may be conducted in an active BWP, and only one BWP may be activated for one UE. In a resource grid, each element is referred to as an RE, to which one complex symbol may be mapped.

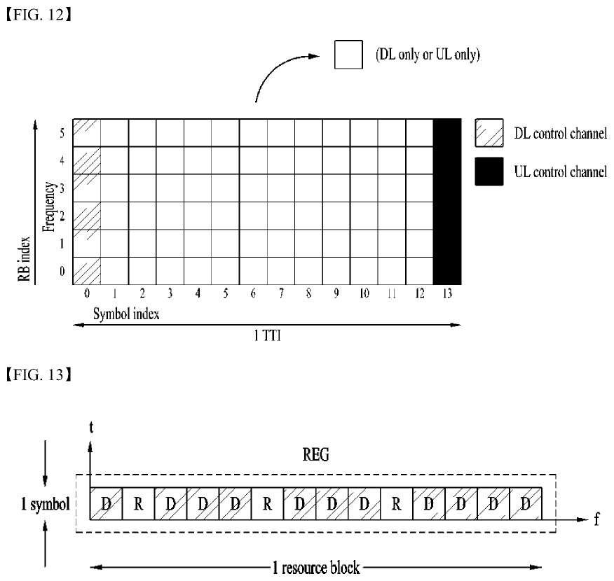

FIG. 12 is a diagram illustrating a self-contained slot structures in an NR system to which the embodiments of the present disclosure are applicable.

In FIG. 12, the hatched area (e.g., symbol index=0) indicates a DL control region, and the black area (e.g., symbol index=13) indicates a UL control region. The remaining area (e.g., symbol index=1 to 12) may be used for DL or UL data transmission.

Based on this structure, an eNB and a UE may sequentially perform DL transmission and UL transmission in one slot. That is, the eNB and UE may transmit and receive not only DL data but also a UL ACK/NACK for the DL data in one slot. Consequently, this structure may reduce a time required until data retransmission when a data transmission error occurs, thereby minimizing the latency of a final data transmission.

In this self-contained slot structure, a predetermined length of time gap is required to allow the eNB and UE to switch from transmission mode to reception mode and vice versa. To this end, in the self-contained slot structure, some OFDM symbols at the time of switching from DL to UL may be configured as a guard period (GP).

Although it has been described above that the self-contained slot structure includes both DL and UL control regions, these control regions may be selectively included in the self-contained slot structure. In other words, the self-contained slot structure according to the present disclosure may include either the DL control region or the UL control region as well as both the DL and UL control regions as illustrated in FIG. 12.

Further, the order of regions in one slot may vary in some embodiments. For example, one slot may be configured in the following order: DL control region, DL data region, UL control region, and UL data region, or UL control region, UL data region, DL control region, and DL data region.

A PDCCH may be transmitted in the DL control region, and a PDSCH may be transmitted in the DL data region. A PUCCH may be transmitted in the UL control region, and a PUSCH may be transmitted in the UL data region.

The PDCCH may deliver downlink control information (DCI), for example, DL data scheduling information, UL data scheduling information, and so on. The PUCCH may deliver uplink control information (UCI), for example, an ACK/NACK for DL data, channel state information (CSI), a scheduling request (SR), and so on.

The PDSCH carries DL data (e.g., DL-shared channel transport block (DL-SCH TB)) and uses a modulation scheme such as quadrature phase shift keying (QPSK), 16-ary quadrature amplitude modulation (16QAM), 64QAM, or 256QAM. A TB is encoded into a codeword. The PDSCH may deliver up to two codewords. Scrambling and modulation mapping are performed on a codeword basis, and modulation symbols generated from each codeword are mapped to one or more layers (layer mapping). Each layer is mapped to resources together with a demodulation reference signal (DMRS or DM-RS), created as an OFDM symbol signal, and then transmitted through a corresponding antenna port.

The PDCCH carries DCI and uses QPSK as a modulation scheme. One PDCCH includes 1, 2, 4, 8, or 16 control channel elements (CCEs) according to an aggregation level (AL). One CCE includes 6 resource element groups (REGs). One REG is defined as one OFDM symbol by one (P)RB.

FIG. 13 is a diagram illustrating the structure of one REG in an NR system to which the embodiments of the present disclosure are applicable.

In FIG. 13, D denotes an RE to which DCI is mapped, and R denotes an RE to which a DMRS is mapped. The DMRS is mapped to REs #1, #5, and #9 along the frequency axis in one symbol.

The PDCCH is transmitted in a control resource set (CORESET). A CORESET is defined as a set of REGs having a given numerology (e.g., SCS, CP length, and so on). A plurality of CORESETs for one UE may overlap with each other in the time/frequency domain. A CORESET may be configured by system information (e.g., a master information block (MIB)) or by UE-specific higher layer (RRC) signaling. Specifically, the number of RBs and the number of symbols (up to 3 symbols) included in a CORESET may be configured by higher-layer signaling.

The PUSCH carries UL data (e.g., UL-shared channel transport block (UL-SCH TB)) and/or UCI and is transmitted based on a CP-OFDM waveform or a DFT-s-OFDM waveform. When the PUSCH is transmitted in the DFT-s-OFDM waveform, the UE transmits the PUSCH by applying transform precoding. For example, when transform precoding is impossible (e.g., disabled), the UE may transmit the PUSCH in the CP-OFDM waveform, while when transform precoding is possible (e.g., enabled), the UE may transmit the PUSCH in the CP-OFDM or DFT-s-OFDM waveform. PUSCH transmission may be dynamically scheduled by a UL grant in DCI, or semi-statically scheduled by higher-layer (e.g., RRC) signaling (and/or layer 1 (L1) signaling such as a PDCCH) (configured grant). Both codebook based PUSCH transmission and non-codebook based PUSCH transmission may be allowed.

The PUCCH carries UCI, an HARQ-ACK, and/or an SR. Depending on the transmission duration of the PUCCH, the PUCCH is classified into a short PUCCH and a long PUCCH. Table 6 lists exemplary PUCCH formats.

TABLE 6

| | Length in | | | |
|---|---|---|---|---|
| PUCCH | OFDM symbols | Number | | |
| format | N_{symb}^{PUCCH} | of bits | Usage | Etc |
| 0 | 1-2 | ≤2 | HARQ, SR | Sequence |
| | | | | selection |
| 1 | 4-14 | ≤2 | HARQ, | Sequence |
| | | | [SR] | modulation |
| 2 | 1-2 | >2 | HARQ, | CP-OFDM |
| | | | CSI, [SR] | |
| 3 | 4-14 | >2 | HARQ, | DFT-s-OFDM |
| | | | CSI, [SR] | (no UE |
| | | | | multiplexing) |
| 4 | 4-14 | >2 | HARQ, | DFT-s- |
| | | | CSI, [SR] | OFDM (Pre |
| | | | | DFT OCC) |

PUCCH format 0 carries UCI of up to 2 bits and is mapped in a sequence-based manner, for transmission. Specifically, the UE transmits specific UCI to the eNB by transmitting one of a plurality of sequences on a PUCCH of PUCCH format 0. Only when the UE transmits a positive SR, the UE transmits the PUCCH of PUCCH format 0 in a PUCCH resource for a corresponding SR configuration.

PUCCH format 1 carries UCI of up to 2 bits and modulation symbols are spread with an orthogonal cover code (OCC) (which is configured differently depending on whether frequency hopping is performed) in the time domain. The DMRS is transmitted in a symbol in which a modulation symbol is not transmitted (i.e., transmitted by time division multiplexing (TDM)).

PUCCH format 2 carries UCI of more than 2 bits and modulation symbols are transmitted by frequency division multiplexing (FDM) with the DMRS. The DMRS is located in symbols #1, #4, #7, and #10 of a given RB with a density of 1/3. A pseudo noise (PN) sequence is used for a DMRS sequence. For 2-symbol PUCCH format 2, frequency hopping may be activated.

PUCCH format 3 does not support UE multiplexing in the same PRBs and carries UCI of more than 2 bits. In other words, PUCCH resources of PUCCH format 3 include no OCC. Modulation symbols are transmitted by TDM with the DMRS.

PUCCH format 4 supports multiplexing of up to 4 UEs in the same PRBs and carries UCI of more than 2 bits. In other words, PUCCH resources of PUCCH format 3 includes an OCC. Modulation symbols are transmitted in TDM with the DMRS.

1.3. Analog Beamforming

In a millimeter wave (mmW) system, since a wavelength is short, a plurality of antenna elements can be installed in the same area. That is, considering that the wavelength at 30 GHz band is 1 cm, a total of 100 antenna elements can be installed in a 5*5 cm panel at intervals of 0.5 lambda (wavelength) in the case of a 2-dimensional array. Therefore, in the mmW system, it is possible to improve the coverage or throughput by increasing the beamforming (BF) gain using multiple antenna elements.

In this case, each antenna element can include a transceiver unit (TXRU) to enable adjustment of transmit power and phase per antenna element. By doing so, each antenna element can perform independent beamforming per frequency resource.

However, installing TXRUs in all of the about 100 antenna elements is less feasible in terms of cost. Therefore, a method of mapping a plurality of antenna elements to one TXRU and adjusting the direction of a beam using an analog phase shifter has been considered. However, this method is disadvantageous in that frequency selective beamforming is impossible because only one beam direction is generated over the full band.

To solve this problem, as an intermediate form of digital BF and analog BF, hybrid BF with B TXRUs that are fewer than Q antenna elements can be considered. In the case of the hybrid BF, the number of beam directions that can be transmitted at the same time is limited to B or less, which depends on how B TXRUs and Q antenna elements are connected.

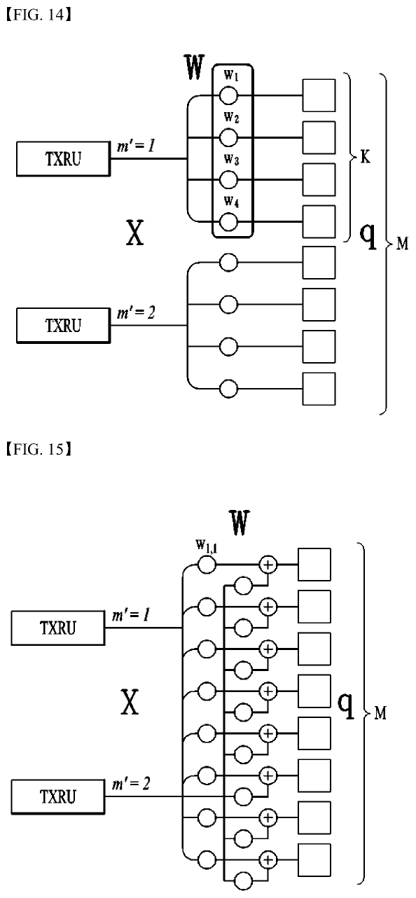

FIGS. 14 and 15 are diagrams illustrating representative methods for connecting TXRUs to antenna elements. Here, the TXRU virtualization model represents the relationship between TXRU output signals and antenna element output signals.

FIG. 14 shows a method for connecting TXRUs to sub-arrays. In FIG. 14, one antenna element is connected to one TXRU.

Meanwhile, FIG. 15 shows a method for connecting all TXRUs to all antenna elements. In FIG. 15, all antenna elements are connected to all TXRUs. In this case, separate addition units are required to connect all antenna elements to all TXRUs as shown in FIG. 15.

In FIGS. 14 and 15, W indicates a phase vector weighted by an analog phase shifter. That is, W is a major parameter determining the direction of the analog beamforming. In this case, the mapping relationship between channel state information reference signal (CSI-RS) antenna ports and TXRUs may be 1:1 or 1-to-many.

The configuration shown in FIG. 14 has a disadvantage in that it is difficult to achieve beamforming focusing but has an advantage in that all antennas can be configured at low cost.

On the contrary, the configuration shown in FIG. 15 is advantageous in that beamforming focusing can be easily achieved. However, since all antenna elements are connected to the TXRU, it has a disadvantage of high cost.

When a plurality of antennas is used in the NR system to which the present disclosure is applicable, a hybrid beamforming (BF) scheme in which digital BF and analog BF are combined may be applied. In this case, analog BF (or radio frequency (RF) BF) means an operation of performing precoding (or combining) at an RF stage. In hybrid BF, each of a baseband stage and the RF stage perform precoding (or combining) and, therefore, performance approximating to digital BF can be achieved while reducing the number of RF chains and the number of a digital-to-analog (D/A) (or analog-to-digital (A/D) converters.

For convenience of description, a hybrid BF structure may be represented by N transceiver units (TXRUs) and M physical antennas. In this case, digital BF for L data layers to be transmitted by a transmission end may be represented by an N-by-L matrix. N converted digital signals obtained thereafter are converted into analog signals via the TXRUs and then subjected to analog BF, which is represented by an M-by-N matrix.

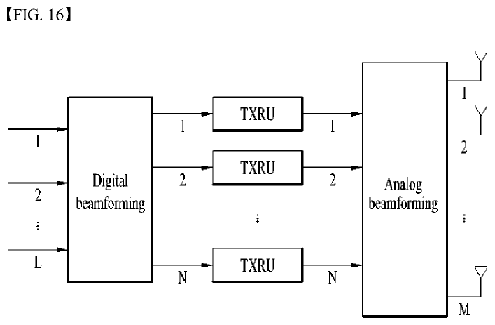

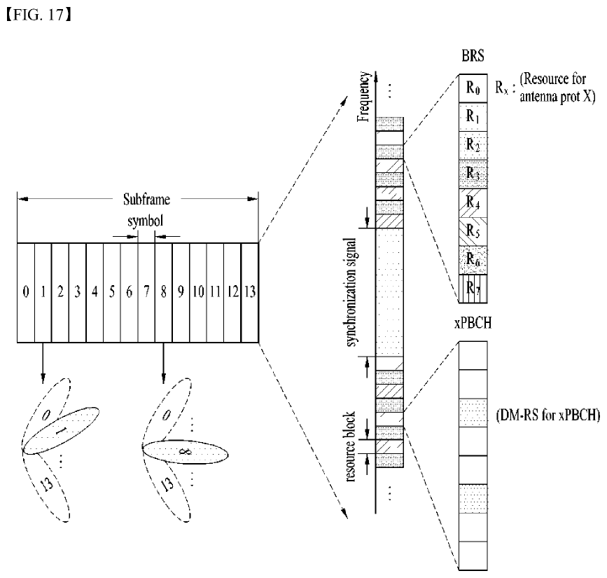

FIG. 16 is a diagram schematically illustrating an exemplary hybrid BF structure from the perspective of TXRUs and physical antennas according to the present disclosure. In FIG. 16, the number of digital beams is L and the number analog beams is N.

Additionally, in the NR system to which the present disclosure is applicable, an BS designs analog BF to be changed in units of symbols to provide more efficient BF support to a UE located in a specific area. Furthermore, as illustrated in FIG. 13, when N specific TXRUs and M RF antennas are defined as one antenna panel, the NR system according to the present disclosure considers introducing a plurality of antenna panels to which independent hybrid BF is applicable.

In the case in which the BS utilizes a plurality of analog beams as described above, the analog beams advantageous for signal reception may differ according to a UE. Therefore, in the NR system to which the present disclosure is applicable, a beam sweeping operation is being considered in which the BS transmits signals (at least synchronization signals, system information, paging, and the like) by applying different analog beams in a specific subframe (SF) or slot on a symbol-by-symbol basis so that all UEs may have reception opportunities.

FIG. 17 is a diagram schematically illustrating an exemplary beam sweeping operation for a synchronization signal and system information in a DL transmission procedure according to the present disclosure.

In FIG. 17 below, a physical resource (or physical channel) on which the system information of the NR system to which the present disclosure is applicable is transmitted in a broadcasting manner is referred to as an xPBCH. Here, analog beams belonging to different antenna panels within one symbol may be simultaneously transmitted.

As illustrated in FIG. 17, in order to measure a channel for each analog beam in the NR system to which the present disclosure is applicable, introducing a beam RS (BRS), which is a reference signal (RS) transmitted by applying a single analog beam (corresponding to a specific antenna panel), is being discussed. The BRS may be defined for a plurality of antenna ports and each antenna port of the BRS may correspond to a single analog beam. In this case, unlike the BRS, a synchronization signal or the xPBCH may be transmitted by applying all analog beams in an analog beam group such that any UE may receive the signal well.

1.4. Synchronization Signal Block (SSB) or SS/PBCH Block

In the NR system to which the present disclosure is applicable, a primary synchronization signal (PSS), a secondary synchronization signal (SSS), and/or a physical broadcast signal (PBCH) may be transmitted in one synchronization signal (SS) block or SS PBCH block (hereinafter, referred to as an SSB or SS/PBCH block). Multiplexing other signals may not be precluded within the SSB.

The SS/PBCH block may be transmitted in a band other than the center of a system band. Particularly, when the BS supports broadband operation, the BS may transmit multiple SS/PBCH blocks.

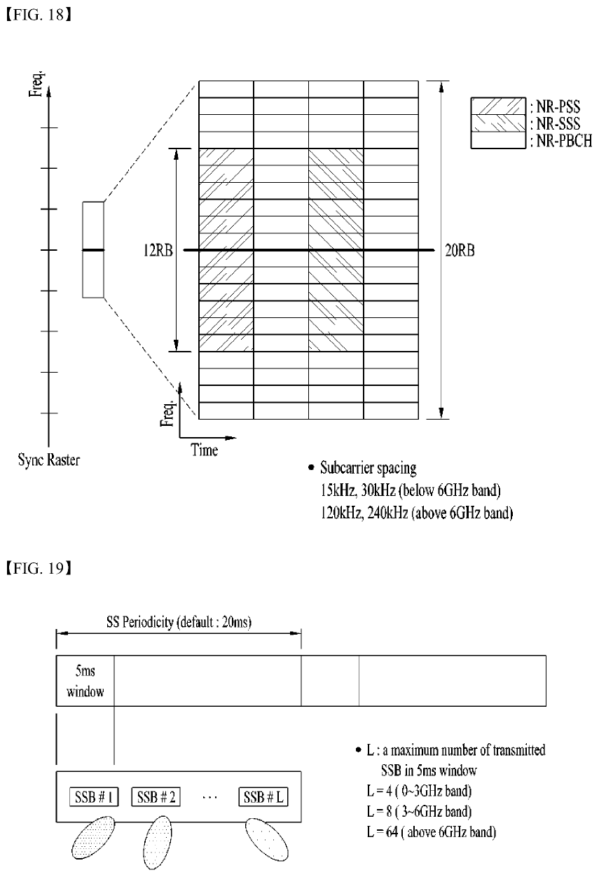

FIG. 18 is a schematic diagram illustrating an SS/PBCH block applicable to the present disclosure.

As illustrated in FIG. 18, the SS/PBCH block applicable to the present disclosure may include 20 RBs in four consecutive OFDM symbols. Further, the SS/PBCH block may include a PSS, an SSS, and a PBCH, and the UE may perform cell search, system information acquisition, beam alignment for initial access, DL measurement, and so on based on the SS/PBCH block.

Each of the PSS and the SSS includes one OFDM symbol by 127 subcarriers, and the PBCH includes three OFDM symbols by 576 subcarriers. Polar coding and QPSK are applied to the PBCH. The PBCH includes data REs and DMRS REs in every OFDM symbol. There are three DMRS REs per RB, with three data REs between every two adjacent DMRS REs.

Further, the SS/PBCH block may be transmitted even in a frequency band other than the center frequency of a frequency band used by the network.

For this purpose, a synchronization raster being candidate frequency positions at which the UE should detect the SS/PBCH block is defined in the NR system to which the present disclosure is applicable. The synchronization raster may be distinguished from a channel raster.

In the absence of explicit signaling of the position of the SS/PBCH block, the synchronization raster may indicate available frequency positions for the SS/PBCH block, at which the UE may acquire system information.

The synchronization raster may be determined based on a global synchronization channel number (GSCN). The GSCN may be transmitted by RRC signaling (e.g., an MIB, a system information block (SIB), remaining minimum system information (RMSI), other system information (OSI), or the like).

The synchronization raster is defined to be longer along the frequency axis than the channel raster and characterized by a smaller number of blind detections than the channel raster, in consideration of the complexity of initial synchronization and a detection speed.

FIG. 19 is a schematic diagram illustrating an SS/PBCH block transmission structure applicable to the present disclosure.

In the NR system to which the present disclosure is applicable, the BS may transmit an SS/PBCH block up to 64 times for 5 ms. The multiple SS/PBCH blocks may be transmitted on different beams, and the UE may detect the SS/PBCH block on the assumption that the SS/PBCH block is transmitted on a specific one beam every 20 ms.

As the frequency band is higher, the BS may set a larger maximum number of beams available for SS/PBCH block transmission within 5 ms. For example, the BS may transmit the SS/PBCH block by using up to 4 different beams at or below 3GHz, up to 8 different beams at 3 to 6 GHz, and up to 64 different beams at or above 6 GHz, for 5 ms.

1.5. Synchronization Procedure

The UE may acquire synchronization by receiving the above-described SS/PBCH block from the BS. The synchronization procedure largely includes cell ID detection and timing detection. The cell ID detection may include PSS-based cell ID detection and SSS-based cell ID detection. The timing detection may include PBCH DMRS-based timing detection and PBCH content-based (e.g., MIB-based) timing detection.

First, the UE may acquire timing synchronization and the physical cell ID of a detected cell by detecting a PSS and an SSS. More specifically, the UE may acquire the symbol timing of the SSB and detect a cell ID within a cell ID group, by PSS detection. Subsequently, the UE detects the cell ID group by SSS detection.

Further, the UE may detect the time index (e.g., slot boundary) of the SSB by the DMRS of the PBCH. The UE may then acquire half-frame boundary information and system frame number (SFN) information from an MIB included in the PBCH.

The PBCH may indicate that a related (or corresponding) RMSI PDCCH/PDSCH is transmitted in the same band as or a different band from that of the SS/PBCH block. Accordingly, the UE may then receive RMSI (e.g., system information other than the MIB) in a frequency band indicated by the PBCH or a frequency band carrying the PBCH, after decoding of the PBCH.

In relation to the operation, the UE may acquire system information.

The MIB includes information/parameters required for monitoring a PDCCH that schedules a PDSCH carrying SystemInformationBlock1 (SIB1), and is transmitted to the UE on the PBCH in the SS/PBCH block by the gNB.

The UE may check whether there is a CORESET for a Type0-PDCCH common search space, based on the MIB. The Type0-PDCCH common search space is a kind of PDCCH search space and used to transmit a PDCCH that schedules an SI message.

In the presence of a Type0-PDCCH common search space, the UE may determine (i) a plurality of contiguous RBs included in the CORESET and one or more consecutive symbols and (ii) a PDCCH occasion (e.g., a time-domain position for PDCCH reception), based on information (e.g., pdcch-ConfigSIB1) included in the MIB.

In the absence of a Type0-PDCCH common search space, pdcch-ConfigSIB1 provides information about a frequency position at which the SSB/SIB1 exists and a frequency range in which the SSB/SIB1 does not exist.

SIB1 includes information about the availability and scheduling of the other SIBs (hereinafter, referred to as SIBx where x is 2 or a larger integer). For example, SIB1 may indicate whether SIBx is periodically broadcast or provided in an on-demand manner (or upon request of the UE). When SIBx is provided in the on-demand manner, SIB1 may include information required for an SI request of the UE. SIB1 is transmitted on a PDSCH. A PDCCH that schedules SIB1 is transmitted in a Type0-PDCCH common search space, and SIB1 is transmitted on a PDSCH indicated by the PDCCH.

1.6. Quasi Co-located or Quasi Co-location (QCL)

In the present disclosure, QCL may mean one of the following.

(1) If two antenna ports are “quasi co-located (QCL)”, the UE may assume that large-scale properties of a signal received from a first antenna port may be inferred from a signal received from the other antenna port. The “large-scale properties” may include one or more of the following.

Delay spread

Doppler spread

Frequency shift

Average received power

Received Timing

(2) If two antenna ports are “quasi co-located (QCL)”, the UE may assume that large-scale properties of a channel over which a symbol on one antenna port is conveyed may be inferred from a channel over which a symbol on the other antenna port is conveyed). The “large-scale properties” may include one or more of the following.

Delay spread

Doppler spread

Doppler shift

Average gain

Average delay

Average angle (AA): When it is said that QCL is guaranteed between antenna ports in terms of AA, this may imply that when a signal is to be received from other antenna port(s) based on an AA estimated from specific antenna port(s), the same or similar reception beam direction (and/or reception beam width/sweeping degree) may be set and the reception is processed accordingly (in other words, that when operated in this manner, reception performance at or above a certain level is guaranteed).

Angular spread (AS): When it is said that QCL is guaranteed between antenna ports in terms of AS, this may imply that an AS estimated from one antenna port may be derived/estimated/applied from an AS estimated from another antenna port.

Power Angle(-of-Arrival) Profile (PAP): When it is said that QCL is guaranteed between antenna ports in terms of PAP, this may imply that a PAP estimated from one antenna port may be derived/estimated/applied from a PAP estimated from another antenna port (or the PAPs may be treated as similar or identical).

In the present disclosure, both of the concepts defined in (1) and (2) described above may be applied to QCL. Alternatively, the QCL concepts may be modified such that it may be assumed that signals are transmitted from a co-location, for signal transmission from antenna ports for which the QCL assumption is established (e.g., the UE may assume that the antenna ports are transmitted from the same transmission point).

In the present disclosure, partial QCL between two antenna ports may mean that at least one of the foregoing QCL parameters for one antenna port is assumed/applied/used as the same as for the other antenna port (when an associated operation is applied, performance at or above a certain level is guaranteed).

1.7. Bandwidth Part (BWP)

In the NR system to which the present disclosure is applicable, a frequency resource of up to 400 MHz may be allocated/supported for each CC. When a UE operating in such a wideband CC always operates with a radio frequency (RF) module for the entire CCs turned on, battery consumption of the UE may increase.

Alternatively, considering various use cases (e.g., enhanced mobile broadband (eMBB), ultra-reliable and low latency communication (URLLC), and massive machine type communication (mMTC), and so on) operating within a single wideband CC, a different numerology (e.g., SCS) may be supported for each frequency band within the CC.

Alternatively, the maximum bandwidth capability may be different for each UE.

In consideration of the above situation, the BS may indicate/configure the UE to operate only in a partial bandwidth instead of the entire bandwidth of the wideband CC. The partial bandwidth may be defined as a BWP.

A BWP may include consecutive RBs on the frequency axis, and one BWP may correspond to one numerology (e.g., SCS, CP length, slot/mini-slot duration, and so on).

The BS may configure a plurality of BWPs in one CC configured for the UE. For example, the BS may configure a BWP occupying a relatively small frequency region in a PDCCH monitoring slot, and schedule a PDSCH indicated by the PDCCH (or a PDSCH scheduled by the PDCCH) in a larger BWP. Alternatively, when UEs are concentrated on a specific BWP, the BS may configure another BWP for some of the UEs, for load balancing. Alternatively, the BS may exclude some spectrum of the entire bandwidth and configure both of the BWPs in the same slot in consideration of frequency-domain inter-cell interference cancellation between neighboring cells.

The BS may configure at least one DL/UL BWP for the UE associated with the wideband CC and activate at least one DL/UL BWP among the configured DL/UL BWP(s) at a specific time (through L1 signaling (e.g., DCI), MAC or RRC signaling, etc.). The activated DL/UL BWP may be called an active DL/UL BWP. The UE may fail to receive DL/UL BWP configurations from the BS during an initial access procedure or before setting up an RRC connection. A DL/UL BWP assumed by such a UE is defined as an initial active DL/UL BWP.

More specifically, the UE according to the present disclosure may perform the following bandwidth part operation.

For the UE configured to operate in the BWPs of the serving cell, up to four DL BWPs are configured within the DL bandwidth in the serving cell by a higher layer parameter (e.g., DL-BWP or BWP-Downlink), and up to 4 UL BWPs are configured within the UL bandwidth in the serving cell by a higher layer parameter (e.g., UL-BWP or BWP-Uplink).

When the UE is not provided with the higher layer parameter initialDownlinkBWP, the initial active DL BWP is defined by the positions and number of the following consecutive PRBs: consecutive PRBs from the least index to the greatest index among the PRBs included in the control resource set (CORESET) for the Type-0 PDCCH CSS (Common Search Space) set. In addition, the initial active DL BWP is defined by subcarrier spacing (SCS) and cyclic prefix for PDCCH reception in the CORESET for the Type-0 PDCCH CSS set. Alternatively, the initial active DL BWP is provided by the higher layer parameter initialDownlinkBWP. For operation in a primary cell or a secondary cell, the UE is provided with an initial active UL BWP by the higher layer parameter initialuplinkBWP. If a supplementary UL carrier is configured for the UE, the UE may be provided with an initial active UL BWP on the supplementary UL carrier by initialUplinkBWP in the higher layer parameter supplementaryUplink.

When the UE has a dedicated BWP configuration, the UE may be provided with a first active DL BWP for reception by the higher layer parameter firstActiveDownlinkBWP-Id, and may be provided with a first active UL BWP for transmission on the carrier of the primary cell by the higher layer parameter firstActiveUplinkGBWP-Id.

For each DL BWP in the set of DL BWP or each UL BWP in the set of UL BWPs, the UE may be provided with the following parameters:

Subcarrier spacing (SCS) provided based on a higher layer parameter (e.g., subcarrierSpacing);

Cyclic prefix (CP) provided based on a higher layer parameter (e.g., cyclicPrefix);

The number of common RBs and consecutive RBs is provided based on the higher layer parameter locationAndBandwidth. The higher layer parameter locationAndBandwidth indicates the offset RBₛₜₐᵣₜ and LRB based on a resource indication value (RIV). Here, it is assumed that N^{size}_{BWP} is 275 and that the value of O_{carrier} is provided by offsetToCarrier for the higher layer parameter subcarrierSpacing;

Index for each set of DL BWPs or UL BWPs provided based on higher a layer parameter (e.g., bwp-Id) for DL or UL;

BWP-common set parameter or BWP-dedicated set parameter provided based on a higher layer parameter (e.g., bwp-Common or bwp-Dedicated).

In an unpaired spectrum operation, when the DL BWP index and the UL BWP index are the same, a DL BWP configured to have an index provided by a higher layer parameter (e.g., bwp-Id) in the set of DL BWPs is linked to a UL BWP configured to have the same index in the set of UL BWPs. In the unpaired spectrum operation, when the higher layer parameter bwp-Id for the DL BWP and the higher layer parameter bwp-Id for the UL BWP are the same, the UE does not expect to receive has a configuration in which the center frequency for the DL BWP is different from the center frequency for the UL BWP.

For each DL BWP in the set of DL BWPs of a primary cell (hereinafter, referred to as PCell) or a PUCCH secondary cell (hereinafter, referred to as PUCCH-SCell), the UE may configure a CORESET for all CSS (Common Search Space) sets and USS (UE-specific Search Space). The UE does not expect a configuration to be established without a CSS in the PCell or PUCCH-SCell within the active DL BWP.

When the UE is provided with controlResourceSetZero and searchSpaceZero in the higher layer parameter PDCCH-ConfigSIB1 or the higher layer parameter PDCCH-ConfigCommon, the UE determines a CORESET for the search region set based on the higher layer parameter controlResourcesetZero, and determines corresponding PDCCH monitoring occasions. When the active DL BWP is not the initial DL BWP, the UE determines PDCCH monitoring occasions for the search region set only when the CORESET bandwidth is within the active DL BWP and the active DL BWP has the same SCS configuration and the same CP as the initial DL BWP.

For each UL BWP in the UL BWPs set of PCell or PUCCH-SCell, resource sets for PUCCH transmission are configured for the UE.

Within the DL BWP, the UE receives a PDCCH and a PDSCH based on the SCS and CP length configured for the DL BWP. Within the UL BWP, the UE transmits a PUCCH and a PUSCH based on the SCS and CP length configured for the UL BWP.

When a bandwidth part indicator field is configured in DCI format 1_1, the value of the bandwidth part indicator field indicates an active DL BWP for DL reception in the configured DL BWP set. When a bandwidth part indicator field is configured in DCI format 0_1, the bandwidth part indicator field indicates an active UL BWP for UL transmission in the configured UL BWP set.

When a bandwidth part indicator field is configured in DCI format 0_1 or DCI format 1_1, and the bandwidth part indicator field indicates a UL BWP or a DL BWP different from the active UL BWP or active DL BWP, the UE may operate as follows.

For each information field in the received DCI format 0_1 or DCI format 1_1,

When the size of the information field is smaller than the size required for interpretation of DCI format 0_1 or DCI format 1_1 for each of the UL BWP or DL BWP indicated by the bandwidth part indicator, the UE prepends zero to the information field until the size of the information field becomes the size required for the interpretation of the information field for the UL BWP or DL BWP before interpreting each of the DCI format 0_1 information field or the DCI format 1_1 information field.

When the size of the information field is larger than the size required for interpretation of DCI format 0_1 or DCI format 1_1 for each of the UL BWP or DL BWP indicated by the bandwidth part indicator, the UE uses the number of least significant bits (LSBs) of DCI format 0_1 or DCI format 1_1 corresponding to the size required for the UL BWP or DL BWP indicated by the bandwidth part indicator before interpreting each of the DCI format 0-1 information field or the DCI format 1_1 information field.

The UE sets the active UL BWP or the active DL BWP as a UL BWP or DL BWP indicated by the bandwidth part indicator in DCI format 0_1 or DCI format 1_1, respectively.

The UE does not expect to detect each of DCI format 1_1 or DCI format 0_1 indicating change of the active DL BWP or active UL BWP together with a time domain resource allocation field that provides a slot offset smaller than a delay required for the UE to change the active DL BWP or active UL BWP.

When the UE detects DCI format 1_1 indicating change of the active DL BWP of one cell, the UE is not required to receive or transmit a signal in the cell for the time duration from the third symbol from the end of the slot in which the UE receives the PDCCH containing DCI format 1_1 to the start point of the slot indicated by the slot offset value of the time domain resource allocation field in DCI format 1_1.

When the UE detects DCI format 0_1 indicating change of the active UL BWP of one cell, the UE is not required to receive or transmit a signal in the cell for the time duration from the third symbol from the end of the slot in which the UE receives the PDCCH containing DCI format 0_1 to the start point of the slot indicated by the slot offset value of the time domain resource allocation field in DCI format 0_1.

The UE does not expect to detect DCI format 1_1 indicating change of the active DL BWP or DCI format 0_1 indicating change of the active UL BWP in a slot other than the first slot in a slot set for the SCS of the cell overlapping with a time duration for which signal reception or transmission is not required to change the active BWP in another cell.

The UE expects to detect DCI format 0_1 indicating change of the active UL BWP or DCI format 1_1 indicating change of the active DL BWP only when the corresponding PDCCH is received in the first three symbols in one slot.

For the serving cell, the UE may be provided with a higher layer parameter defaultDownlinkBWP-Id, which indicates the default DL BWP among the configured DL BWPs. If the UE is not provided with the default DL BWP by the higher layer parameter defaultDownlinkBWP-Id, the default DL bWP may be set to the initial active DL BWP.

When the UE is provided with a timer value for the PCell by the higher layer parameter bwp-InactivityTimer and the timer is running, if the condition for re-start is not satisfied for a time interval corresponding to a subframe for Frequency Range 1 (FR1) (below 6 GHz) or a time interval corresponding to a half-subframe for Frequency Range 2 (FR2) (below 6 GHz), the UE decrements the timer at the end time of the subframe for FR1 or the end time of the half-subframe for FR2.

In order to provide a cell in which the UE has changed the active DL BWP and accommodate a delay in changing the active DL BWP or the active UL BWP at the request of the UE by the BWP inactivity timer expiration, the UE is not required to receive or transmit a signal form a time duration from the start time of the subframe for FR1 or the half-subframe for FR2 immediately after expiration of the BWP inactivity timer to the start time of a slot in which the UE can receive or transmit a signal.

When the BWP inactivity timer of the UE for a specific cell expires during a duration in which the UE is not required to receive or transmit a signal to change the active UL/DL BWP in the specific cell or another cell, the UE may delay the active UL/DL BWP change triggered by expiration of the GBWP activation timer for an interval from the time immediately after completing the change of the active UL/DL BWP in the specific cell or another cell to the subframe for FR1 or the half-subframe for FR2.

When the UE is provided with a first active DL BWP by the higher layer parameter firstActiveDownlinkBWP-Id and a first active UL BWP by the higher layer parameter firstActiveUplinkBWP-Id within the carrier of the secondary cell, the UE uses the indicated DL BWP and UL BWP as the first active DL BWP and the first active UL BWP on the carrier of the secondary cell.

In a paired spectrum operation, when the UE changes the active UL BWP on the PCell at a time between the detection time of DCI format 1_0 or DCI format 1_1 and the transmission time of a corresponding PUCCH containing HARQ-ACK information, the UE does not expect to transmit the PUCCH containing the HARQ-ACK information on a PUCCH resource indicated by DCI format 1_0 or DCI format 1_1.

When the UE performs RRM measurement for a bandwidth that is not within the active DL BWP for the UE, the UE does not expect to monitor the PDCCH.

1.8. Slot Configuration

In the present disclosure, a slot format includes one or more DL symbols, one or more UL symbols, and flexible symbols. In the present disclosure, for simplicity, the respective symbols are described as DL/UL/flexible symbol(s).

The following details may be applied to each serving cell.

When the UE is provided with the higher layer parameter TDD-UL-DL-ConfigurationCommon, the UE may configure a slot format for each slot within a predetermined number of slots indicated by the higher layer parameter TDD-UL-DL-ConfigurationCommon.

The higher layer parameter TDD-UL-DL-ConfigurationCommon may provide the followings:

Reference SCS setting μ_{ref} based on the higher layer parameter referenceSubcarrierSpacing;

Higher layer parameter pattern1 .

Here, the higher layer parameter pattern1 may provide the followings:

P msec, a periodicity of slot setting based on the higher layer parameter dl-UL-TransmissionPeriodicity;

dₛₗₒₜₛ, the number of slots with only DL symbols based on the higher layer parameter nrofDownlinkSlots;

d_{sym}, the number of DL symbols based on the higher layer parameter nrofDownlinkSymbols;

uₛₗₒₜₛ, the number of slots with only UL symbols based on the higher layer parameter nrofUplinkSlots;

u_{sym}, the number of UL symbols based on the higher layer parameter nrofUplinkSymbols

For SCS setting μ_{ref}=3, only P=0.625 mcec may be valid. For SCS setting μ_{ref}=2 or μ_{ref}=3, only P=1.25 msec may be valid. For SCS setting μ_{ref}=1, μ_{ref}=2, or μ_{ref}=3, only P=2.5 msec may be valid.

The slot setting periodicity (P msec) includes S=P·2^{μ}^{_{ref}} slots of the SCS setting μ_{ref}. Among the S slots, the first dₛₗₒₜₛ slots contain only DL symbols and the last uₛₗₒₜₛ slots contain only UL symbols. The d_{sym} symbols after the first dₛₗₒₜₛ slots are DL symbols. u_{sym} symbols before the uₛₗₒₜₛ slots are UL symbols. The remaining (S-dₛₗₒₜₛ-uₛₗₒₜₛ)·N_{symb}^{slot}-d_{sym}-u_{sym} symbols are flexible symbols.

The first symbol of every periodicity of 20/P is the first symbol of an even frame.

When the higher layer parameter TDD-UL-DL-ConfigurationCommon provides the higher layer parameter pattern1 and the higher layer parameter pattern2, the UE sets a slot format for each slot within a first number of slots based on the higher layer parameter pattern', and sets a slot format for each slot within a second number of slots based on the higher layer parameter pattern2.

Here, the higher layer parameter pattern2 may provide the followings:

P₂ msec, a slot setting periodicity based on the higher layer parameter dl-UL-TransmissionPeriodicity;

d_{slots,2,} the number of slots with only DL symbols based on the higher layer parameter nrofDownlinkSlots;

d_{sym,2}, the number of DL symbols based on the higher layer parameter nrofDownlinkSymbols;

u_{slots,2}, the number of slots with only UL symbols based on the higher layer parameter nrofUplinkSlots;

u_{sym,2}, the number of UL symbols based on the higher layer parameter nrofUplinkSymbols.

The value of P₂ applicable according to the SCS setting is the same as the value of P applicable according to the SCS setting.

The slot setting periodicity P+P₂ msec includes the first S=P·2^{μ}^{_{ref}} slots and the second S₂=P₂·2^{μ}^{_{ref}} slots.

Among the S₂ slots, the first d_{slots,2} slots contain only DL symbols and the last U_{slots,2} slots contain only UL symbols. The d_{sym,2} symbols after the first d_{slots,2} slots are DL symbols. The u_{sym,2} symbols before the U_{slots,2} slots are UL symbols. The remaining (S₂-d_{slots,2}-u_{slots,2})·N_{symb}^{slot}-d _{sym,2}-u_{sym}, symbols are flexible symbols.

The UE expects the value of P+P₂ to be divided by 20 msec. In other words, the UE expects that P+P2 is set to an integer multiple of 20 msec.

The first symbol of every periodicity of 20/(P+P2) is the first symbol of an even frame.

The UE expects that the reference SCS setting μ_{ref} is less than or equal to the SCS setting for the configured DL BWP or UL BWP. Each slot (configuration) provided by the higher layer parameter pattern1 or pattern2 is applicable to 2^{(μ-μ}^{_{ref}}⁾ consecutive slots within the active DL BWP or the active UL BWP in the first slot starting at the same time as the first slot for the reference SCS setting μ_{ref}. Each of the DL/flexible/UL symbols for the reference SCS setting μ_{ref} corresponds to the 2^{(μ-μ}^{_{ref}}⁾ consecutive DL/flexible/UL symbols for the SCS setting μ.

Additionally, when the UE is provided with the higher layer parameter TDD-UL-DL-ConfigDedicated, the higher layer parameter TDD-UL-DL-ConfigDedicated overrides only the flexible symbols for each slot within a certain number of slots provided by the higher layer parameter TDD-UL-DL-ConfigurationCommon.

The higher layer parameter TDD-UL-DL-ConfigDedicated may provide the followings:

A set of slot configurations based on the higher layer parameter slotSpecificConfigurations ToAddModList;

Each slot configuration in the sets of slot configurations;

Slot index based on the higher layer parameter slotIndex;

Set of symbols based on the higher layer parameter symbols:

If the higher layer parameter symbols is allDownlink, all symbols in the corresponding slot are DL symbols;

If the higher layer parameter symbols is allUplink, all symbols in the corresponding slot are UL symbols;

If the higher layer parameter symbols is explicit, the higher layer parameter nrofDownlinkSymbols provides the number of first DL symbols in the corresponding slot, and the higher layer parameter nrofUplinkSymbols provides the number of last UL symbols in the corresponding slot. If the higher layer parameter nrofDownlinkSymbols is not provided, this means that there are no first DL symbols in the corresponding slot. If the higher layer parameter nrofUplinkSymbols is not provided, this means that there are no last UL symbols in the corresponding slot. The remaining symbols in the slot are flexible symbols.

The UE applies the (slot) format provided by the corresponding symbols to each slot having an index provided by the higher layer parameter slotIndex. For each of the symbols indicated as a DL or UL symbol by the higher layer parameter TDD-UL-DL-ConfigurationCommon, the UE does not expect that the higher layer parameter TDD-UL-DL-ConfigDedicated indicates UL or DL symbol.

For each slot configuration provided by the higher layer parameter TDD-UL-DL-ConfigDedicated, the reference SCS setting is the same as the reference SCS setting μ_{ref} provided by the higher layer parameter TDD-UL-DL-ConfigurationCommon.

The slot configuration periodicity and the number of DL/UL/flexible symbols in each slot of the slot configuration periodicity are determined based on the higher layer parameters TDD-UL-DL-ConfigurationCommonTDD and TDD-UL-DL-ConfigDedicated, and this information is common to each configured BWP.

The UE considers that symbols indicated as DL in the slot by the higher layer parameter TDD-UL-DL-ConfigurationCommon or TDD-UL-DL-ConfigDedicated are available for signal reception. In addition, the UE considers that symbols indicated as UL in the slot by the higher layer parameter TDD-UL-DL-ConfigurationCommon or TDD-UL-DL-ConfigDedicated are available for signal transmission.

When the UE is not configured to monitor the PDCCH for DCI format 2_0; for a set of symbols indicated as flexible in the slot by the higher layer parameter TDD-UL-DL-ConfigurationCommon or TDD-UL-DL-ConfigDedicated; or when the higher layer parameters TDD-UL-DL-ConfigurationCommon and TDD-UL-DL-ConfigDedicated are not provided to the UE,

When the UE receives a corresponding indication by DCI format 1_0, DCI format 1_1, or DCI format 0_1, the UE may receive a PDSCH or CSI-RS within the set of symbols of the slot.

When the UE receives a corresponding indication by DCI format 0_0, DCI format 0_1, DCI format 1_0, DCI format 1_1, or DCI format 2_3, the UE may transmit a PUSCH, PUCCH, PRACH or SRS within the set of symbols of the slot.

It is assumed that the UE is configured to receive the PDCCH, PDSCH or CSI-RS in the set of symbols of the slot by a higher layer. If the UE does not detect DCI format 0_0, DCI format 0_1, DCI format 1_0, DCI format 1_1, or DCI format 2_3 indicating transmission of PUSCH, PUCCH, PRACH or SRS in at least one symbol from the set of symbols in the slot, the UE may receive a PDCCH, PDSCH or CSI-RS. Otherwise, that is, the UE detects DCI format 0_0, DCI format 0_1, DCI format 1_0, DCI format 1_1, or DCI format 2_3 indicating transmission of PUSCH, PUCCH, PRACH or SRS in at least one symbol from the set of symbols in the slot, the UE does not receive a PDCCH, PDSCH or CSI RS in the set of symbols of the slot.

The UE may be configured by a higher layer to transmit an SRS, PUCCH, PUSCH or PRACH in the set of symbols of a slot and may detect DCI format 1_0, DCI format 1_1 or DCI format 0_1 indicating that a CSI-RS or PDSCH should be received in a subset of the symbols set. In this case, the following operations are performed:

Assuming d_{2,1}=1, relative to the last symbol of the CORESET in which the UE detects DCI format 1_0, DCI format 1_1, or DCI format 0_1, the UE does not expect that signal transmission is canceled in a subset of symbols after the smaller number of symbols than a PUSCH preparation time T_{proc,2} for a corresponding UE processing capability;

The UE cancels PUCCH, PUSCH or PRACH transmission on the remaining symbols in the set of symbols, and cancels SRS transmission on the remaining symbols in the set of symbols.

For a set of symbols indicated as UL in a slot by a higher layer parameter TDD-UL-DL-ConfigurationCommon or TDD-UL-DL-ConfigDedicated, the UE does not receive PDCCH, PDSCH or CSI-RS within the set of symbols of the slot.

For a set of symbols indicated as DL in the slot by the higher layer parameter TDD-UL-DL-ConfigurationCommon or TDD-UL-DL-ConfigDedicated, the UE does not transmit PUSCH, PUCCH, PRACH or SRS within the set of symbols of the slot.

For a set of symbols indicated as flexible in the slot by the higher layer parameter TDD-UL-DL-ConfigurationCommon or TDD-UL-DL-ConfigDedicated, the UE does not expect to receive dedicated configuring transmission from the UE and dedicated configuring reception by the UE within the set of symbols of the slot.

In a set of symbols of a slot indicated by the higher layer parameter SystemInformationBlockTypel or the higher layer parameter ssb-PositionsInBurst in ServingCellConfigCommon, when signal transmission in the slot overlaps with some symbols in the symbol set for SS/PBCH block reception, the UE does not transmit PUSCH, PUCCH, or PRACH, and does not transmit SRS within the set of symbols of the slot. When the higher layer parameter TDD-UL-DL-ConfigurationCommon or TDD-UL-DL-ConfigDedicated is provided to the UE, the UE does not expect that the set of symbols of the slot is indicated as UL by the higher layer parameter.

For a set of symbols in a slot corresponding to a valid PRACH occasion and N_{gap} symbols before the valid PRACH occasion, when signal reception in the slot overlaps with some symbols in the set of symbols, the UE skips receiving PDCCH, PDSCH or CSI for the Type1-PDCCH CSS set. The UE does not expect that the set of symbols of the slot is indicated as DL by the higher layer parameter TDD-UL-DL-ConfigurationCommon or TDD-UL-DL-ConfigDedicated.

For the set of symbols in the slot indicated by the higher layer parameter pdcch-ConfigSIB1 in the MIB for the CORESET for the Type0-PDCCH CSS set, the UE does not expect that the set of symbols is indicated as UL by the higher layer parameter TDD-UL-DL-ConfigurationCommon or TDD-UL-DL-ConfigDedicated.

When the UE is scheduled by DCI format 1_1 so as to receive the PDSCH over multiple slots, and at least one symbol from a set of symbols scheduled to allow the UE in one slot among the multiple slots to receive a PDSCH is indicated as a UL symbol by the higher layer parameter TDD-UL-DL-ConfigurationCommon or TDD-UL-DL-ConfigDedicated, the UE skips receiving the PDSCH in the one slot.

When the UE is scheduled by the DCI format 0_1 so as to transmit the PUSCH over multiple slots, and at least one symbol from a set of symbols scheduled to allow the UE in one slot among the multiple slots to receive a PDSCH is indicated as a DL symbol by the higher layer parameter TDD-UL-DL-ConfigurationCommon or TDD-UL-DL-ConfigDedicated, the UE skips transmitting a PDSCH in the one slot.

Hereinafter, the operation of the UE to determine the slot format will be described in detail. The operation of the UE to be described below may be applied to the UE for a serving cell included in a set of serving cells configured by higher layer parameters slotFormatCombToAddModList and slotFormatCombToReleaseList.

When the higher layer parameter SlotFormatIndicator is configured for the UE, the UE is provided with the SFI-RNTI by a higher layer parameter sfi-RNTI, and provided with the payload size of DCI format 2_0 by a higher layer parameter dci-PayloadSize.

In addition, the UE is provided with a configuration for a search region set S and a corresponding CORESET P in relation to one or more serving cells. Here, the search region set S and the corresponding CORESET P may be provided to monitorM_{p,s}^{(L}^{_{SFI}}⁾ PDCCH candidates for DCI format 2_0 of a CCE aggregation level including L_{SFI} control channel elements (CCEs).

The PDCCH candidates refer to first M_{p,s}^{(L}^{_{SFI}}⁾ PDCCH candidates for CCE association level L_{SFI} for the search region set S in CORESET P.

For each serving cell in the set of serving cells, the UE may be provided with the following information:

An identifier of a serving cell based on a higher layer parameter servingCellId;

A position of the SFI-index field in DCI format 2_0 based on a higher layer parameter positionInDCI;

A set of slot format combinations based on a higher layer parameter slotFormatCombinations. Here, each slot format combination in the set of slot format combinations may include the following information:

One or more slot format(s) based on each higher layer parameter slotFormats for a slot format combination;

Mapping between a slot format combination provided by the higher layer parameter slotFormats and the corresponding SFI-index field value in DCI format 2_0 provided by a higher layer parameter slotFormatCombinationId;

Reference SCS setting μ_{SFI} based on a higher layer parameter subcarrierSpacing in an unpaired spectrum operation. Reference SCS setting μ_{SFI, SUL} based on a higher layer parameter subcarrierSpacing2 for a supplementary UL carrier when the supplementary UL carrier is configured for the serving cell;

In a paired spectrum operation, reference SCS setting μ_{SFI DL} for a DL BWP based on the higher layer parameter subcarrierSpacing and reference SCS setting μ_{SFI UL} for a UL BWP based on the higher layer parameter subcarrierSpacing2.

The value of the SFI-index field in DCI format 2_0 indicates a slot format for a slot for each DL BWP or each UL BWP included in a specific number of slots starting from the slot in which the UE detects DCI format 2_0. The specific number of slots is greater than or equal to the PDCCH monitoring periodicity of DCI format 2_0. The SFI-index field includes max {┌log₂ (maxSFIindex+1)┐1} bits. Here, maxSFIindex is the greatest value among the values provided by the corresponding higher layer parameter slotFormatCombinationId. The slot format is identified by the corresponding format index in Tables 7 to 10 below. In Tables 7 to 10 below, ‘D’ denotes a DL symbol, ‘U’ denotes a UL symbol, and ‘F’ denotes a flexible symbol.

TABLE 7

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |

TABLE 8

| | | | | | | | | | | | | | | |
|---|---|---|---|---|---|---|---|---|---|---|---|---|---|---|
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |

TABLE 9

| | | | | | | | | | | | | | | |
|---|---|---|---|---|---|---|---|---|---|---|---|---|---|---|
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |

TABLE 10

| | | | | | | | | | | | | | | |
|---|---|---|---|---|---|---|---|---|---|---|---|---|---|---|
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot |
| | based on TDD-UL-DL-ConfigurationCommon, |
| | or TDD-UL-DL-ConfigDedicated |
| | and, if any, on detected DCI formats |

When the PDCCH monitoring periodicity for DCI format 2_0 provided for the search area set S based on the higher layer parameter monitoringSlotPeriodicityAndOffset is shorter than the duration of a slot format combination obtained by the corresponding value of the SFI-index field in the PDCCH monitoring occasion for DCI format 2_0, and the UE detects more than one DCI format 2_0 indicating a slot format for one slot, the UE expects the more than one DCI format 2_0 to indicate the same (slot) format for the one slot.

The UE does not expect to be configured to monitor the PDCCH for DCI format 2_0 in the second serving cell that employs a larger SCS than the serving cell.

For the unpaired spectrum operation of the UE in the serving cell, the UE is provided with reference SCS setting μ_{SFI} for each slot format in a combination of slot formats indicated by the value of the SFI-index field in DCI format 2_0, by the higher layer parameter subcarrierSpacing. For the reference SCS setting μ_{SFI} and the SCS setting μ for the active DL BWP or active UL BWP, the UE expects μ≥μ_{SFI}. Each slot format in the combination of slot formats indicated by the value of the SFI-index field in DCI format 2_0 may be applied to 2^{(μ-μ}^{_{SFI}}⁾ consecutive slots within the active DL BWP or active UL BWP starting with the first slot at the same time as the first slot for the reference SCS setting μ_{SFI}. In addition, each DL/flexible/UL symbol for the reference SCS setting μ_{SFI} may correspond to 2^{(μ-μ}^{_{SFI}}⁾ consecutive DL/flexible/UL symbols for the SCS setting μ.

For the paired spectrum operation of the UE in the serving cell, the SFI-index field in DCI format 2_0 includes a combination of slot formats for a reference DL BWP of the serving cell and a combination of slot formats for a reference UL BWP of the serving cell. Reference SCS setting μ_{SFI} for each slot format in the combination of slot formats indicated by the value is provided. For the reference SCS setting μ_{SFI} and the SCS setting μ for the active DL BWP or active UL BWP, the UE expects μ≥μ_{SFI}. The UE is provided with the reference SCS setting μ_{SFI, DL} for a combination of slot formats indicated by the value of the SFI-index field in DCI format 2_0 for the reference DL BWP of the serving cell by the higher layer parameter subcarrierSpacing. The UE is provided with the reference SCS setting μ_{SFI UL} for a combination of slot formats indicated by the value of the SFI-index field in DCI format 2_0 for the reference UL BWP of the serving cell, by the higher layer parameter subcarrierSpacing2. If μ_{SFI, DL} ≥μ_{SFI, UL}, for 2^{(μ}^{_{SFI DL}}^{-μ}^{_{SFI UL}}⁾+1 provided by the value of the higher layer parameter slotFormats, the value of the higher layer parameter slotFormats is determined based on the higher layer parameter slotFormatCombinationId in the higher layer parameter slotFormatCombination; the value of the higher layer parameter slotFormatCombinationId is set based on the value of the SFI-index field in DCI format 2_0; the first 2^{(μ}^{_{SFI DL}}^{-μ}^{_{SFI UL}}⁾ values for the combination of slot formats are applicable to the reference DL BWP; and the next value is applicable to the reference UL BWP. If μ_{SFI DL}<μ_{SFI UL}, for 2^{(μ}^{_{SFI UL}}^{-μ}^{_{SFI DL}}⁾+1 provided by the value of the higher layer parameter slotFormats, the first value for the combination of slot formats is applicable to the reference DL BWP, and the next 2^{(μ}^{_{SFI UL}}^{-μ}^{_{SFI DL}}⁾ values are applicable to the reference UL BWP.

For a set of symbols in one slot, the UE detects DCI format 2_0 including an SFI-index field indicating the set of symbols in the one slot as UL, and does not expect to detect, in the set of symbols in the one slot, DCI format 1_0, DCI format 1_1, or DCI format 0_1 indicating reception of an PDSCH or CSI-RS.

For a set of symbols in one slot, the UE detects DCI format 2_0 including an SFI-index field indicating the set of symbols in the one slot as DL, and does not expect to detect, in the set of symbols in the one slot, DCI format 0_0, DCI format 0_1, DCI format 1_0, DCI format 1_1, DCI format 2_3, or RAR UL grant indicating transmission of a PUSCH, a PUCCH, a PRACH, or an SRS.

For a set of symbols of a slot indicated as DL/UL by the higher layer parameter TDD-UL-DL-ConfigurationCommon or TDD-UL-DL-ConfigDedicated, the UE does not expect to detect DCI format 2_0 including an SFI-index field indicating the set of symbols of the slot as UL/DL or flexible.

For a set of symbols of a slot indicated by the higher layer parameter SystemInformationBlockType1 or the higher layer parameter ssb-PositionsInBurst in ServingCellConfigCommon for reception of an SS/PBCH block, the UE does not expect to detect DCI format 2_0 including an SFI-index field indicating the set of symbols of the slot as UL.

For a set of symbols of a slot indicated by the higher layer parameter prach-ConfigurationIndex in the higher layer parameter RACH-ConfigCommon for PRACH transmission, the UE does not expect to detect DCI format 2_0 including an SFI-index field indicating the set of symbols of the slot as DL.

For a set of symbols of a slot indicated by the higher layer parameter pdcch-ConfigSIB1 in the MIB for the CORESET for the Type0-PDCCH CSS set, the UE does not expect to detect DCI format 2_0 including an SFI-index field indicating the set of symbols of the slot as UL.

For a set of symbols indicated as flexible in the slot by the higher layer parameter TDD-UL-DL-ConfigurationCommon and the higher layer parameter TDD-UL-DL-ConfigDedicated, or in the case where the higher layer parameter TDD-UL-DL-ConfigurationCommon and the higher layer parameter TDD-UL-DL-ConfigDedicated are not provided to the UE, when the UE detects DCI format 2_0 providing a slot format corresponding to a slot format value other than 255, the following operations are performed:

If at least one symbol in the set of symbols is a symbol in the CORESET configured for PDCCH monitoring, the UE receives a PDCCH in the CORESET only when the value of the SFI-index field in DCI format 2_0 indicates that the at least one symbol is a DL symbol;

If the value of the SFI-index field in DCI format 2_0 indicates the set of symbols of the slot as flexible and the UE detects DCI format 1_0, DCI format 1_1, or DCI format 0_1 indicating reception of a PDSCH or CSI-RS in the set of symbols of the slot, the UE receives the PDSCH or CSI-RS in the set of symbols of the slot;

If the value of the SFI-index field in DCI format 2_0 indicates the set of symbols of the slot as flexible and the UE detects DCI format 0_0, DCI format 0_1, DCI format 1_0, DCI format 1_1, DCI format 2_3, or RAR UL grant indicating transmission of a PUSCH, PUCCH, PRACH or SRS in the set of symbols of the slot, the UE transmits the PUSCH, PUCCH, PRACH, or SRS in the set of symbols of the slot:

If the value of the SFI-index field in DCI format 2_0 indicates the set of symbols of the slot as flexible and the UE fails to detect DCI format 1_0, DCI format 1_1, or DCI format 0_1 indicating that the UE should receive a PDSCH or CSI-RS in the set of symbols of the slot or fails to detect DCI format 0_0, DCI format 0_1, DCI format 1_0, DCI format 1_1, DCI format 2_3, or RAR UL grant indicating transmission of a PUSCH, PUCCH, PRACH or SRS in the set of symbols of the slot, the UE skips signal transmission or reception in the set of symbols of the slot;

When the UE is configured to receive a PDSCH or CSI-RS in the set of symbols of the slot by a higher layer, the UE receives the PDSCH or CSI-RS in the set of symbols of the slot only when the value of the SFI-index field in DCI format 2_0 indicates the set of symbols of the slot as DL;

When the UE is configured to transmit PUCCH, PUSCH or PRACH in the set of symbols of the slot by a higher layer, the UE transmits the PUCCH, PUSCH or PRACH has a value of the SFI-index field in DCI format 2_0 only when the value of the SFI-index field in DCI format 2_0 indicates the set of symbols of the slot as UL;

When the UE is configured to transmit an SRS in the set of symbols of the slot by a higher layer, the UE transmits the SRS on only some symbols indicated as UL symbols in the set of symbols of the slot by the value of the SFI-index field in DCI format 2_0.

When the UE detects DCI format 2_0 including the SFI-index field indicating the set of symbols in one slot as DL, the UE does not expect to detect DCI format 0_0, DCI format 0_1, DCI format 1_0, DCI format 1_1, DCI format 2_3, or RAR UL grant indicating transmission of a PUSCH, PUCCH, PRACH, or SRS in one or more symbols from the set of symbols in the one slot.

When the set of symbols in one slot includes symbol(s) corresponding to a certain repetitive transmission for PUSCH transmission activated by a UL Type 2 grant PDCCH, the UE does not expect to detect DCI format 2_0 including the SFI-index field indicating the set of symbols in the slot as DL or as flexible;

The UE detects DCI format 2_0 including an SFI-index field indicating a set of symbols in one slot as UL and does not expect to detect DCI format 1_0, DCI format 1_1, or DCI format 0_1 indicating reception of a PDSCH or CSI-RS in one or more symbols from the set of symbols in the slot.

When the UE is configured to receive a CSI-RS or PDSCH in a set of symbols in one slot by a higher layer, and detects DCI format 2_0 indicating a slot format in which some symbols in the set of symbols are UL or flexible symbols, or detects DCI format 0_0, DCI format 0_1, DCI format 1_0, DCI format 1_1, or DCI format 2_3 indicating transmission of a PUSCH, PUCCH, SRS or PRACH in at least one symbol in the symbol set, the UE cancels CSI-RS reception or PDSCH reception in the slot.

When the UE is configured to transmit an SRS, PUCCH, PUSCH or PRACH in a set of symbols in one slot by a higher layer, and the UE detects DCI format 2_0 indicating a slot format in which some symbols in the set of symbols are DL or flexible symbols or detects DCI format 1_0, DCI format 1_1, or DCI format 0_1 indicating reception of a CSI-RS or PDSCH in at least one symbol in the set of symbols, the following operations are performed:

The UE, relative to the last symbol of the CORESET in which the UE detects DCI format 2_0, DCI format 1_0, DCI format 1_1, or DCI format 0_1, the UE does not expect that signal transmission is canceled in a subset of symbols after the smaller number of symbols than a PUSCH preparation time T_{proc,2} for a corresponding UE processing capability;

The UE cancels PUCCH, PUSCH or PRACH transmission on the remaining symbols in the set of symbols, and cancels SRS transmission on the remaining symbols in the set of symbols.

When the UE fails to detect DCI format 2_0 indicating a set of symbols in one slot as flexible or UL or DCI format 0_0, DCI format 0_1, DCI format 1_0, DCI format 1_1, or DCI format 2_3 indicating transmission of an SRS, PUSCH, PUCCH or PRACH in the set of symbols, the UE assumes that flexible symbols in the CORESET configured for PDCCH monitoring are DL symbols.

For a set of symbols indicated as flexible in the slot by the higher layer parameter TDD-UL-DL-ConfigurationCommon and the higher layer parameter TDD-UL-DL-ConfigDedicated, or in the case where the higher layer parameter TDD-UL-DL-ConfigurationCommon and the higher layer parameter TDD-UL-DL-ConfigDedicated are not provided to the UE, when the UE fails to detect DCI format 2_0 providing a slot format for the slot, the following operations are performed:

When the UE receives a corresponding indication by DCI format 1_0, DCI format 1_1, or DCI format 0_1, the UE receives a PDSCH or CSI-RS within the set of symbols in the slot;

When the UE receives a corresponding indication by DCI format 0_0, DCI format 0_1, DCI format 1_0, DCI format 1_1, or DCI format 2_3, the UE transmits a PUSCH, PUCCH, PRACH, or SRS;

The UE may receive the PDCCH;

When the UE is configured to receive a PDSCH or CSI-RS within the set of symbols of the slot by a higher layer, the UE skips receiving a PDSCH or CSI-RS within the set of symbols of the slot;

When the UE is configured to transmit an SRS, PUCCH, PUSCH or PRACH within the set of symbols of the slot by a higher layer, the following operation is performed:

The UE does not transmit the PUCCH, or the PUSCH, or the PRACH in the slot and does not transmit the SRS in symbols from the set of symbols in the slot, if any, starting from a symbol that is a number of symbols equal to the PUSCH preparation time N₂ for the corresponding PUSCH timing capability after a last symbol of a CORESET where the UE is configured to monitor PDCCH for DCI format 2_0;

The UE does not expect to cancel the transmission of the SRS, or the PUCCH, or the PUSCH, or the PRACH in symbols from the set of symbols in the slot, if any, starting before a symbol that is a number of symbols equal to the PUSCH preparation time N₂ for the corresponding PUSCH timing capability after a last symbol of a CORESET where the UE is configured to monitor PDCCH for DCI format 2_0.

2. Unlicensed Band System

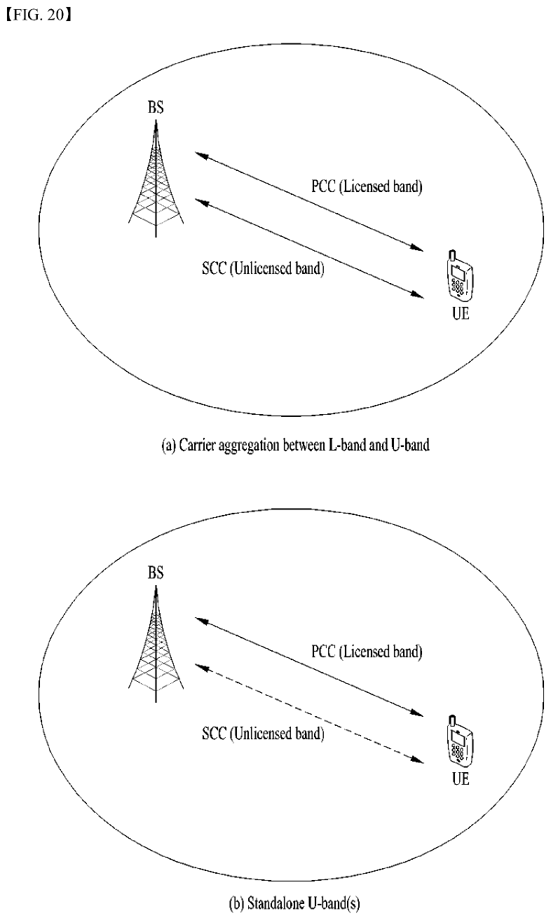

FIG. 20 illustrates an exemplary wireless communication system supporting an unlicensed band, which is applicable to the present disclosure.

Herein, a cell operating in a licensed band (L-band) is defined as an L-cell, and a carrier in the L-cell is defined as a (DL/UL) LCC. A cell operating in an unlicensed band (U-band) is defined as a U-cell, and a carrier in the U-cell is defined as a (DL/UL) UCC. The carrier/carrier-frequency of a cell may refer to the operating frequency (e.g., center frequency) of the cell. A cell/carrier (e.g., CC) is commonly called a cell.

When a BS and a UE transmit and receive signals on an LCC and a UCC where carrier aggregation is applied as shown in FIG. 20(a), the LCC and the UCC may be set to a primary CC (PCC) and a secondary CC (SCC), respectively.

The BS and UE may transmit and receive signals on one UCC or on a plurality of UCCs where the carrier aggregation is applied as shown in FIG. 20(b). In other words, the BS and UE may transmit and receive signals on UCC(s) with no LCC.

Signal transmission and reception operations in U-bands, which will be described later in the present disclosure, may be applied to all of the aforementioned deployment scenarios (unless specified otherwise).

2.1. Radio Frame Structure for U-Band

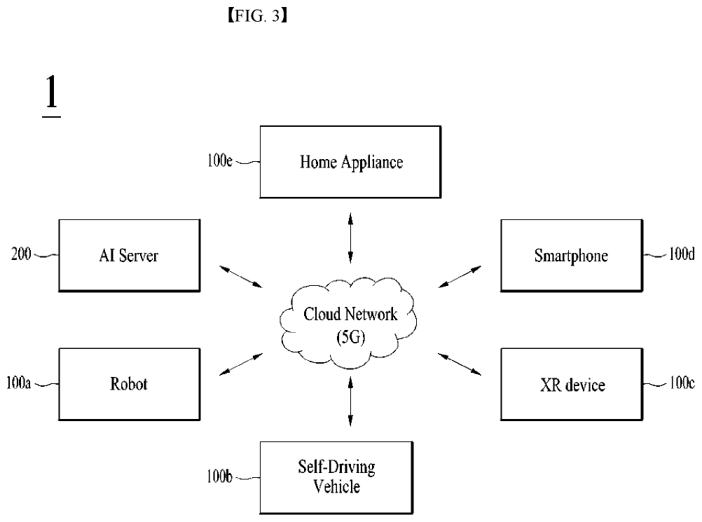

For operation in U-bands, LTE frame structure type 3 (see FIG. 3) or the NR frame structure (see FIG. 7) may be used. The configuration of OFDM symbols reserved for UL/DL signal transmission in a frame structure for U-bands may be determined by a BS. In this case, the OFDM symbol may be replaced with an SC-FDM(A) symbol.

To transmit a DL signal in a U-band, the BS may inform a UE of the configuration of OFDM symbols used in subframe #n through signaling. Herein, a subframe may be replaced with a slot or a time unit (TU).

Specifically, in the LTE system supporting U-bands, the UE may assume (or recognize) the configuration of occupied OFDM symbols in subframe #n based on a specific filed in DCI (e.g., ‘Subframe configuration for LAA’ field, etc.), which is received in subframe #n−1 or subframe #n from the BS.

Table 11 shows how the Subframe configuration for LAA field indicates the configuration of OFDM symbols used to transmit DL physical channels and/or physical signals in the current or next subframe.

TABLE 11

| Value of | Configuration of occupied |
|---|---|
| ‘Subframe configuration for LAA’ | OFDM symbols (current |
| field in current subframe | subframe, next subframe) |
| 0000 | (—, 14) |
| 0001 | (—, 12) |
| 0010 | (—, 11) |
| 0011 | (—, 10) |
| 0100 | (—, 9) |
| 0101 | (—, 6) |
| 0110 | (—, 3) |
| 0111 | (14, *) |
| 1000 | (12, —) |
| 1001 | (11, —) |
| 1010 | (10, —) |
| 1011 | (9, —) |
| 1100 | (6, —) |
| 1101 | (3, —) |
| 1110 | reserved |
| 1111 | reserved |

NOTE:
(—, Y) means UE may assume the first Y symbols are occupied in next subframe and other symbols in the next subframe are not occupied.
(X, —) means UE may assume the first X symbols are occupied in current subframe and other symbols in the current subframe are not occupied.
(X, *) means UE may assume the first X symbols are occupied in current subframe, and at least the first OFDM symbol of the next subfrarne is not occupied.

To transmit a UL signal in a U-band, the BS may provide information on a UL transmission interval to the UE through signaling.

Specifically, in the LTE system supporting U-bands, the UE may obtain ‘UL duration’ and ‘UL offset’ information for subframe #n from the ‘UL duration and offset’ field in detected DCI.

Table 12 shows how the UL duration and offset field indicates the configurations of a UL offset and a UL duration.

TABLE 12

| Value of ‘UL | UL offset, l | UL duration, d |
|---|---|---|
| duration and offset’ field | (in subframes) | (in subframes) |
| 00000 | Not configured | Not configured |
| 00001 | 1 | 1 |
| 00010 | 1 | 2 |
| 00011 | 1 | 3 |
| 00100 | 1 | 4 |
| 00101 | 1 | 5 |
| 00110 | 1 | 6 |
| 00111 | 2 | 1 |
| 01000 | 2 | 2 |
| 01001 | 2 | 3 |
| 01010 | 2 | 4 |
| 01011 | 2 | 5 |
| 01100 | 2 | 6 |
| 01101 | 3 | 1 |
| 01110 | 3 | 2 |
| 01111 | 3 | 3 |
| 10000 | 3 | 4 |
| 10001 | 3 | 5 |
| 10010 | 3 | 6 |
| 10011 | 4 | 1 |
| 10100 | 4 | 2 |
| 10101 | 4 | 3 |
| 10110 | 4 | 4 |
| 10111 | 4 | 5 |
| 11000 | 4 | 6 |
| 11001 | 6 | 1 |
| 11010 | 6 | 2 |
| 11011 | 6 | 3 |
| 11100 | 6 | 4 |
| 11101 | 6 | 5 |
| 11110 | 6 | 6 |
| 11111 | reserved | reserved |

For example, when the UL duration and offset field configures (or indicates) a UL offset 1 and UL a duration d for subframe #n, the UE may not need to receive DL physical channels and/or physical signals in subframe #n+l+i (where i=0, 1, . . . , d−1).

2.2. Downlink Channel Access Procedures

To transmit a DL signal in a U-band, a BS may perform a channel access procedure (CAP) for the U-band as follows. In the following description, it is assumed that a BS is basically configured with a PCell corresponding to an L-band and at least one SCell, each corresponding to a U-band. The U-band may be referred to as a licensed assisted access (LAA) SCell. Hereinafter, a description will be given of DL CAP operation applicable to the present disclosure. In this case, the DL CAP operation may be equally applied when the BS is configured only with U-bands.

2.2.1. Channel Access Procedure for Transmission(s) Including PDSCH/PDCCH/EPDCCH

A BS may transmit a transmission including a PDSCH/PDCCH/EPDCCH on a carrier on which LAA SCell(s) transmission(s) are performed after sensing whether the channel is idle during the slot durations of a defer duration T_{d} and after a counter N becomes zero in step 4. In this case, the counter N is adjusted by sensing the channel for an additional slot duration according to the following steps.

1) N is set to Nᵢₙᵢₜ (N=Nᵢₙᵢₜ), where Nᵢₙᵢₜ is a random number uniformly distributed between 0 and CWₚ. Then, step 4 proceeds.

2) If N>0 and the BS chooses to decrease the counter, N is set to N−1 (N=N−1).

3) The channel for the additional slot duration is sensed. If the additional slot duration is idle, step 4 proceeds. Otherwise, step 5 proceeds.

4) If N=0, the corresponding process is stopped. Otherwise, step 2 proceeds.

5) The channel is sensed until either a busy slot is detected within an additional defer duration T_{d} or all the slots of the additional defer duration T_{d} are detected to be idle.

6) If the channel is sensed to be idle during all the slot durations of the additional defer duration T_{d}, step 4 proceeds. Otherwise, step 5 proceeds.

The CAP for the transmission including the PDSCH/PDCCH/EPDCCH performed by the BS may be summarized as follows.

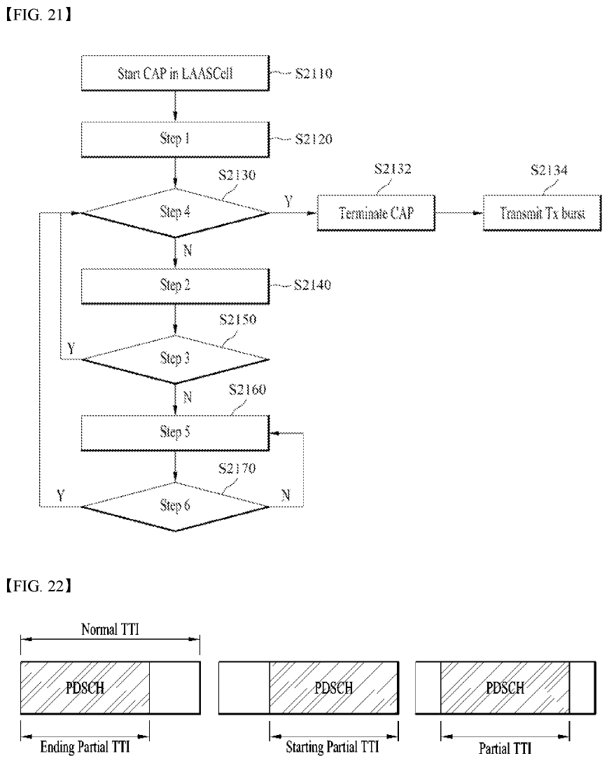

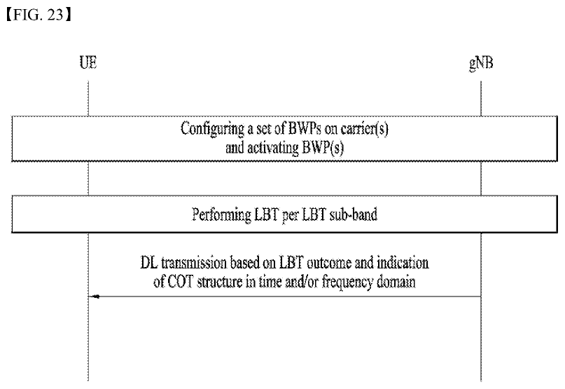

FIG. 21 is a diagram for explaining a CAP for U-band transmission applicable to the present disclosure.

For DL transmission, a transmission node (e.g., BS) may initiate a CAP to operate in LAA SCell(s), each corresponding to a U-band cell (S2110).

The BS may randomly select a backoff counter N within a contention window (CW) according to step 1. In this case, N is set to an initial value, Nᵢₙᵢₜ (S2120). Nᵢₙᵢₜ may have a random value between 0 and CWₚ.

If the backoff counter value (N) is 0 (YES in S2130), the BS terminates the CAP according to step 4 (S2132). Then, the BS may transmit a transmission (Tx) burst including the PDSCH/PDCCH/EPDCCH (S2134). If the backoff counter value is non-zero (NO in S2130), the BS decreases the backoff counter value by 1 according to step 2 (S2140).

The BS checks whether the channel of the LAA SCell(s) is idle (S2150). If the channel is idle (YES in S2150), the BS checks whether the backoff counter value is 0 (S2130).

If the channel is not idle in S2150, that is, if the channel is busy (NO in S2150), the BS checks whether the corresponding channel is idle during the defer duration Ta (longer than or equal to 25 usec), which is longer than the slot duration (e.g., 9 usec), according to step 5 (S2160). If the channel is idle (YES in S2170), the BS may resume the CAP.

For example, when the backoff counter value Nᵢₙᵢₜ is 10, if the channel is determined to be busy after the backoff counter value is reduced to 5, the BS determines whether the channel is idle by sensing the channel during the defer duration. In this case, if the channel is idle during the defer duration, the BS performs the CAP again starting at the backoff counter value of 5 (or at 4 by decreasing the backoff counter value by 1), instead of configuring the backoff counter value Nᵢₙᵢₜ.

On the other hand, if the channel is busy during the defer duration (NO in S2170), the BS performs steps S2160 again to check whether the channel is idle during a new defer duration.

When the BS does not transmit the transmission including the PDSCH/PDCCH/EPDCCH on the carrier on which the LAA SCell(s) transmission(s) are performed after step 4 in the above procedure, the BS may transmit the transmission including the PDSCH/PDCCH/EPDCCH on the carrier if the following conditions are satisfied:

When the BS is ready to transmit the PDSCH/PDCCH/EPDCCH and the channel is sensed to be idle at least in a slot duration Tₛₗ; and when the channel is sensed to be idle during all the slot durations of the defer duration T_{d} immediately before the transmission.

If the channel is sensed not to be idle during the slot duration Tₛₗ when the BS senses the channel after being ready to transmit or if the channel is sensed not to be idle during any one of the slot durations of the defer duration T_{d} immediately before the intended transmission, the BS proceeds to step 1 after sensing the channel to be idle during the slot durations of the defer duration T_{d}.

The defer duration T_{d} includes a duration T_{f}(=16 us) immediately followed by mₚ consecutive slot durations. Here, each slot duration (Tₛₗ) is 9 us long, and T_{f} includes an idle slot duration Tₛₗ at the start thereof.

When the BS senses the channel during the slot duration Tₛₗ if the power detected by the BS for at least 4 us within the slot duration is less than an energy detection threshold X Thresh, the slot duration Tₛₗ is considered to be idle. Otherwise, the slot duration Tₛₗ is considered to be busy.

CW_{min,p}≤CWₚ≤CW_{max,p} represents the CW. The adjustment of CWₚ will be described in detail in section 2.2.3.

CW_{min,p} and CW_{max,p} are selected before step 1 of the above procedure.

mₚ, CW_{min,p}, and CW_{max,p} are determined based on channel access priority classes associated with transmissions at the BS (see Table 13 below).

The adjustment of X_{Thresh} will be described in section 2.2.4.

TABLE 13

| Channel | | | | | |
|---|---|---|---|---|---|
| Access | | | | | |
| Priority | | | | | allowed |
| Class (p) | mₚ | CW_{min, p} | CW_{max, p} | T_{mcot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

When N>0 in the above procedure, if the BS transmits a discovery signal not including the PDSCH/PDCCH/EPDCCH, the BS may not decrease the counter N during slot duration(s) overlapping with the discovery signal transmission.

The BS may not continuously perform transmission on the carrier on which the LAA SCell(s) transmission(s) are performed for a period exceeding T_{mcot,p} in Table 9 above.

For p=3 and p=4 in Table 13 above, if the absence of any other technologies sharing the carrier can be guaranteed on a long term basis (e.g., by level of regulation), T_{mcot,p} is set to 10 ms. Otherwise, T_{mcot,p} is set to 8 ms.

2.2.2. Channel Access Procedure for Transmissions Including Discovery Signal Transmission(s) and Not Including PDSCH

When a BS has a transmission duration less than or equal to 1 ms, the BS may performs transmission including a discovery signal but not including a PDSCH on a carrier on which LAA SCell(s) transmission(s) are performed immediately after sensing that the channel is idle at least for a sensing interval T_{drs} of 25 us. T_{drs} includes a duration T_{f}(=16 us) immediately followed by one slot duration Tₛₗ of 9 us. T_{f} includes an idle slot duration Tₛₗ at the start thereof. When the channel is sensed to be idle during the slot durations of T_{drs}, the channel is considered to be idle for T_{drs}.

2.2.3. Contention Window Adjustment Procedure

If a BS transmits transmissions including PDSCHs that are associated with the channel access priority class p on a carrier, the BS maintains the CW value CWₚ and adjusts CWₚ for the transmissions before step 1 of the procedure described in section 2.2.1 (i.e., before performing the CAP) according to the following steps.

1> For every priority class p ∈ {1,2,3,4}, CWₚ is set to CW_{min,p}.

2> If at least Z=80% of HARQ-ACK values corresponding to PDSCH transmission(s) in reference subframe k are determined as NACK, CWₚ for every priority class p ∈ {1,2,3,4} increases to a next higher allowed value, and step 2 remains. Otherwise, step 1 proceeds.

In other words, the probability that the HARQ-ACK values corresponding to the PDSCH transmission(s) in reference subframe k are determined as NACK is at least 80%, the BS increases the CW values configured for the individual priority classes to next higher allowed values, respectively. Alternatively, the BS may maintain the CW value configured for each priority class as an initial value.

In this case, reference subframe k is the starting subframe of the most recent transmission on the carrier made by the BS, for which at least some HARQ-ACK feedback is expected to be available.

The BS may adjust the value of CWₚ for every priority class p ∈ {1,2,3,4} based on given reference subframe k only once.

If CWₚ=CW_{max, p}, the next higher allowed value for adjusting CWₚ is CW_{max, p}.

To determine the probability Z that the HARQ-ACK values corresponding to the PDSCH transmission(s) in reference subframe k are determined as NACK, the following may be considered.

When the BS's transmission(s) for which HARQ-ACK feedback is available start in the second slot of subframe k, HARQ-ACK values corresponding to PDSCH transmission(s) in subframe k+1 are also used in addition to the HARQ-ACK values corresponding to the PDSCH transmission(s) in subframe k.

When the HARQ-ACK values correspond to PDSCH transmission(s) on an LAA SCell that are assigned by a (E)PDCCH transmitted on the same LAA SCell,

If no HARQ-ACK feedback is detected for a PDSCH transmission by the BS, or if the BS detects ‘DTX’ state, ‘NACK/DTX’ state, or ‘any’ state, it is counted as NACK.

When the HARQ-ACK values correspond to PDSCH transmission(s) on an LAA SCell that are assigned by a (E)PDCCH transmitted on another serving cell,

If the HARQ-ACK feedback for a PDSCH transmission is detected by the BS, the ‘NACK/DTX’ state or the ‘any’ state is counted as NACK and the ‘DTX’ state is ignored.

If no HARQ-ACK feedback is detected for a PDSCH transmission by the BS,

If PUCCH format lb with channel selection, which is configured by the BS, is expected to be used by the UE, the ‘NACK/DTX’ state corresponding to ‘no transmission’ is counted as NACK, and the ‘DTX’ state corresponding to ‘no transmission’ is ignored. Otherwise, the HARQ-ACK for the PDSCH transmission is ignored.

When a PDSCH transmission has two codewords, the HARQ-ACK value of each codeword is considered separately.

Bundled HARQ-ACKs across M subframes are considered as M HARQ-ACK responses.

If the BS transmits transmissions including a PDCCH/EPDCCH with DCI format 0A/0B/4A/4B and not including a PDSCH that are associated with the channel access priority class p on a channel starting from time to, the BS maintains the CW value CWₚ and adjusts CWₚ for the transmissions before step 1 of the procedure described in section 2.2.1 (i.e., before performing the CAP) according to the following steps.

1> For every priority class p ∈ {1,2,3,4}, CWₚ is set to CW_{min, p}.

2> If less than 10% of the UL transport blocks scheduled for the UE by the BS according to a Type 2 CAP (which will be described in section 2.3.1.2) in a time interval from t₀ and t₀+T_{CO} are received successfully, CWₚ for every priority class p ∈ {1,2,3,4} increases to a next higher allowed value, and step 2 remains. Otherwise, step 1 proceeds.

The calculation of T_{CO} will be described in section 2.3.1.

If CWₚ=CW_{max, p} is consecutively used K times to generate Nᵢₙᵢₜ, CWₚ is reset to CW_{min, p} only for the priority class p for which CWₚ=CW_{max, p} is consecutively used K times to generate Nᵢₙᵢₜ. In this case, K is selected by the BS from a set of values {1, 2, . . . , 8} for each priority class p ∈ {1,2,3,4}.

2.2.4. Energy Detection Threshold Adaptation Procedure

A BS accessing a carrier on which LAA SCell(s) transmission(s) are performed may set an energy detection threshold (X_{Thresh}) to be less than or equal to a maximum energy detection threshold X_{Thresh_max}.

The maximum energy detection threshold X_{Thresh_max} is determined as follows.

If the absence of any other technologies sharing the carrier can be guaranteed on a long term basis (e.g., by level of regulation),

$${X}_{Thesh \_ max} = min \{ \begin{matrix}{T}_{max} + 10 dB , \\ {X}_{r}\end{matrix} \}$$

Xᵣ is a maximum energy detection threshold defined by regulatory requirements in dBm when such requirements are defined. Otherwise, Xᵣ=Tₘₐₓ+10 dB.

Otherwise,

$${X}_{Thesh \_ max} = max \{ \begin{matrix}- 72 + 10 \cdot log 10 ( BW MHz / 20 MHz ) dBm , \\ min \{ \begin{matrix}{T}_{max ,} \\ {T}_{max} - {T}_{A} + ( {P}_{H} + 10 \cdot log 10 ( BW MHz / 20 MHz ) - {P}_{T X} )\end{matrix} \}\end{matrix} \}$$

Each variable is defined as follows:
T_{A}=10 dB for transmission(s) including PDSCH;
T_{A}=5 dB for transmissions including discovery signal transmission(s) and not including PDSCH;
P_{H}=23 dBm;
P_{TX} is the set maximum eNB output power in dBm for the carrier:
   eNB uses the set maximum transmission power over a single earlier irrespective of whether single carrier or multi-carrier transmission is employed
Tₘₐₓ(dBm)=10·log 10(3.16228·10⁻⁸(mW 1 MHz)·BWMHz (MHz)):
BWMHz is the single carrier band width in MHz.

2.2.5. Channel Access Procedure for Transmission(s) on Multiple Carriers

A BS may access multiple carriers on which LAA Scell(s) transmission(s) are performed according to one of the following Type A or Type B procedures.

2.2.5.1. Type A Multi-Carrier Access Procedures

A BS may perform channel access on each carrier cᵢ ∈ C according to the aforementioned procedures, where C is a set of carriers on which the BS intends to transmit, and i=0, 1,. . . , q−1, where q is the number of carriers on which the BS intends to transmit.

The counter N described in section 2.2.1 (i.e., the counter N considered in the CAP) is determined for each carrier cᵢ. The counter for each carrier is denoted as N_{c}_{ᵢ}. N_{c}_{ᵢ} is maintained according to clause 2.2.5.1.1 or 2.2.5.1.2.

2.2.5.1.1. Type A1

The counter N described in section 2.2.1 (i.e., the counter N considered in the CAP) is independently determined for each carrier cᵢ, and the counter for each carrier is denoted as N_{c}_{ᵢ}.

When the BS ceases transmission on any one carrier cⱼ ∈ C for each carrier (where cᵢ≠cⱼ), if the absence of any other technologies sharing the carrier cannot be guaranteed on a long term basis (e.g., by level of regulation), the BS may resume decreasing N_{c}_{ᵢ} when an idle slot is detected after waiting for a duration of 4·Tₛₗ, or after reinitializing N_{c}_{ᵢ}.

2.2.5.1.2. Type A2

The counter N may be determined as described in section 2.2.1 for each carrier eⱼ ∈ C, and the counter for each carrier is denoted as N_{c}_{ⱼ}, where cⱼ is a carrier having the largest CWₚ value. For each carrier cᵢ, N_{c}_{ᵢ}=N_{c}_{ⱼ}.

When a BS ceases transmission on any one carrier for which N_{c}_{ᵢ} is determined, the BS reinitializes N_{c}_{ᵢ} for all carriers.

2.2.5.2. Type B Multi-Carrier Access Procedure

A carrier cⱼ ∈ C may be selected by a BS as follows.

The BS uniformly randomly selects cⱼ from C before performing transmission on multiple carriers cᵢ ∈ C, or

The BS selects cⱼ no more frequently than once every 1 second.

C is a set of carriers on which the BS intends to transmit, and i=0, 1,. . . , q−1, where q is the number of carriers on which the BS intends to transmit.

To perform transmission on the carrier cⱼ, the BS performs channel access on the carrier cⱼ according to the procedures described in section 2.2.1 with the following modifications, which will be described in 2.2.5.2.1 or 2.2.5.2.2.

To perform transmission on a carrier cᵢ≠cⱼ among carriers cᵢ ∈ C,

For each carrier cᵢ, the BS senses a carrier cᵢ for at least a sensing interval T_{mc}=25 us immediately before transmission on the carrier cⱼ. Then, the BS may transmit on the carrier cᵢ immediately after sensing the carrier cᵢ to be idle for at least the sensing interval T_{mc}. The carrier cᵢ is considered to be idle for T_{mc} if the channel is sensed to be idle during all the time durations in which such sensing for determining the idle state is performed on the carrier cⱼ in the given interval T_{mc}.

The BS may not continuously perform transmission on the carrier cᵢ≠cⱼ (where cᵢ ∈C) for a period exceeding T_{mcot,p} given in Table 6, where T_{mcot,p} is determined based on channel access parameters used for the carrier cⱼ.

2.2.5.2.1. Type B1

A single CWₚ value is maintained for a set of carriers C.

To determine CWₚ for channel access on a carrier cⱼ, step 2 of the procedure described in section 2.2.3 may be modified as follows.

If at least Z=80% of HARQ-ACK values corresponding to PDSCH transmission(s) in reference subframe k of all carriers cᵢ ∈C are determined as NACK, CWₚ for each priority class p ∈{1,2,3,4} increases to a next higher allowed value. Otherwise, step 1 proceeds.

2.2.5.2.2. Type B2

A CWₚ value is maintained independently for each carrier cᵢ ∈C according to the procedure described in section 2.2.3. To determine Nᵢₙᵢₜ for a carrier cⱼ, the CWₚ value of a carrier cⱼₗ ∈ C is used, where cⱼₗ is a carrier with the largest CWₚ value among all carriers in the set C.

2.3. Uplink Channel Access Procedures

A UE and a BS scheduling UL transmission for the UE may perform the following procedures to access channel(s) on which LAA SCell(s) transmission(s) are performed. In the following description, it is assumed that a UE and a BS are basically configured with a PCell corresponding to an L-band and at least one SCell, each corresponding to a U-band. The U-band may be referred to as an LAA SCell. Hereinafter, a description will be given of UL CAP operation applicable to the present disclosure. In this case, the UL CAP operation may be equally applied when the UE and BS are configured only with U-bands.

2.3.1. Channel Access Procedure for Uplink Transmission(s)

A UE may access a carrier on which LAA SCell(s) UL transmission(s) are performed according to either a Type 1 UL CAP or a Type 2 UL CAP. The Type 1 CAP will be described in section 2.3.1.1, and the Type 2 CAP will be described in section 2.3.1.2.

If a UL grant scheduling PUSCH transmission indicates the Type 1 CAP, the UE performs the Type 1 CAP for transmitting transmissions including the PUSCH transmission unless specified otherwise in this clause.

If a UL grant scheduling PUSCH transmission indicates the Type 2 CAP, the UE performs the Type 2 CAP for transmitting transmissions including the PUSCH transmission unless specified otherwise in this clause.

The UE performs the Type 1 CAP for transmitting an SRS not including PUSCH transmission. A UL channel access priority class p=1 is used for SRS transmission including no PUSCH.

TABLE 14

| Channel | | | | | |
|---|---|---|---|---|---|
| Access | | | | | |
| Priority | | | | | allowed |
| Class (p) | mₚ | CW_{mm, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE 1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

When the ‘UL configuration for LAA’ field configures a ‘UL offset’ l and a ‘UL duration’ d for subframe n,

If the end of UE transmission occurs in or before subframe n+l+d−1, the UE may use the Type 2 CAP for transmission in subframe n+l+i (where i=0, 1,. . . , d−1).

When the UE is scheduled to perform transmission including a PUSCH in a set of subframes n₀, n₁, . . . , n_{w-1} using PDCCH DCI format 0B/4B, if the UE is incapable of accessing a channel for transmission in subframe nₖ, the UE shall attempt to make a transmission in subframe nₖ₊₁ according to the channel access type indicated by DCI, where k ∈{0,1, . . . w−2}, and w is the number of scheduled subframes indicated by the DCI.

When the UE is scheduled to perform transmission including a PUSCH without gaps in a set of subframes n₀, n₁, . . . , n_{w-1} using one or more PDCCH DCI Format 0A/0B/4A/4B, if the UE performs transmission in subframe nₖ after accessing a carrier according to one of the Type 1 or Type 2 UL CAPs, the UE may continue transmission in subframes after nk, where k ∈{0,1,. . . w−1}.

If the start of a UE transmission in subframe n+1 immediately follows the end of a UE transmission in subframe n, the UE is not expected to be indicated with different channel access types for the transmissions in the subframes.

When the UE is scheduled to perform transmission without gaps in subframes n₀, n₁, . . . , n_{w-1} using one or more PDCCH DCI Format 0A/0B/4A/4B, if the UE stops transmitting during or before subframe nₖ₁ (where k1 ∈{0,1,, . . . w−2}), and if the UE senses that the channel is continuously idle after stopping the transmission, the UE may transmit after subframe nₖ₂ (where k2 ∈{1,. . . w−1}) using the Type 2 CAP. If the UE senses that the channel is not continuously idle after stopping the transmission, the UE may transmit after subframe nₖ₂ (where k2 ∈{1,. . . w−1}) using the Type 1 CAP with a UL channel access priority class indicated by DCI corresponding to subframe nₖ₂.

When the UE receives a UL grant, if the DCI indicates the start of PUSCH transmission in subframe n using the Type 1 CAP, and if the UE has an ongoing Type 1 CAP before subframe n,

If a UL channel access priority class value pi used for the ongoing Type 1 CAP is greater than or equal to a UL channel access priority class value p₂ indicated by the DCI, the UE may perform the PUSCH transmission in response to the UL grant by accessing the carrier based on the ongoing Type 1 CAP.

If the UL channel access priority class value pi used for the ongoing Type 1 CAP is smaller than the UL channel access priority class value p₂ indicated by the DCI, the UE terminates the ongoing CAP.

When the UE is scheduled to transmit on a set of carriers C in subframe n, if UL grants scheduling PUSCH transmissions on the set of carriers C indicate the Type 1 CAP, if the same ‘PUSCH starting position’ is indicated for all carriers in the set of carriers C, and if the carrier frequencies of the set of carriers C are a subset of one of the predetermined carrier frequency sets,

The UE may perform transmission on a carrier cᵢ ∈C using the Type 2 CAP.

If the Type 2 CAP is performed on the carrier c, immediately before the UE performs transmission on a carrier cⱼ ∈ C (where i≠j), and

If the UE has accessed the carrier cⱼ using the Type 1 CAP,

The UE selects the carrier cⱼ uniformly and randomly from the set of carriers C before performing the Type 1 CAP on any carrier in the set of carriers C.

When the BS has transmitted on the carrier according to the CAP described in section 2.2.1, the BS may indicate the Type 2 CAP in DCI of a UL grant scheduling transmission including a PUSCH on a carrier in subframe n.

Alternatively, when the BS has transmitted on the carrier according to the CAP described in section 2.2.1, the BS may indicate using the ‘UL configuration for LAA’ field that the UE may perform the Type 2 CAP for transmission including a PUSCH on a carrier in subframe n.

Alternatively, when subframe n occurs within a time interval that starts at to and ends at t₀+T_{CO}, the eNB may schedule transmission including a PUSCH on a carrier in subframe n, which follows transmission by the BS on a carrier with a duration of T_{short_ul}=25 us, where T_{CO}=T_{mcot,p}+T_{g}. The other variables are defined as follows.

t₀: a time instant when the BS starts transmission

T_{mcot,p}: a value determined by the BS as described in section 2.2

T_{g}: the total duration of all gaps greater than 25 us that occur between DL transmission from the BS and UL transmission scheduled by the BS and between any two UL transmissions scheduled by the BS starting from t₀

The BS schedules UL transmissions between t₀ and t₀+T_{CO} in consecutive subframes if the UL transmissions are capable of being scheduled contiguously.

For a UL transmission on a carrier that follows a transmission by the BS on the carrier within a duration of T_{short_ul}=25 us, the UE may use the Type 2 CAP for the UL transmission.

If the BS indicates the Type 2 CAP for the UE in the DCI, the BS indicates the channel access priority class used to obtain access to the channel in the DCI.

2.3.1.1. Type 1 UL Channel Access Procedure

A UE may perform transmission using the Type 1 CAP after sensing a channel to be idle during the slot durations of a defer duration T_{d} and after a counter N becomes zero in step 4. In this case, the counter N is adjusted by sensing a channel for additional slot duration(s) according to the following steps.

1) N is set to Nᵢₙᵢₜ (N=Nᵢₙᵢₜ), where Nᵢₙᵢₜ is a random number uniformly distributed between 0 and CWₚ. Then, step 4 proceeds.

2) If N>0 and the UE chooses to decrease the counter, N is set to N−1(N=N−1).

3) The channel for the additional slot duration is sensed. If the additional slot duration is idle, step 4 proceeds. Otherwise, step 5 proceeds.

4) If N=0, the corresponding process is stopped. Otherwise, step 2 proceeds.

5) The channel is sensed until either a busy slot is detected within an additional defer duration T_{d} or all the slots of the additional defer duration T_{d} are detected to be idle.

6) If the channel is sensed to be idle during all the slot durations of the additional defer duration T_{d}, step 4 proceeds. Otherwise, step 5 proceeds.

The Type 1 UL CAP performed by the UE may be summarized as follows.

For UL transmission, a transmission node (e.g., UE) may initiate a CAP to operate in LAA SCell(s), each corresponding to a U-band cell (S2110).

The UE may randomly select a backoff counter N within a CW according to step 1. In this case, N is set to an initial value, Nᵢₙᵢₜ (S2120). Nᵢₙᵢₜ may have a random value between 0 and CWₚ.

If the backoff counter value (N) is 0 (YES in S2130), the UE terminates the CAP according to step 4 (S2132). Then, the UE may transmit a Tx burst (S2134). If the backoff counter value is non-zero (NO in S2130), the UE decreases the backoff counter value by 1 according to step 2 (S2140).

The UE checks whether the channel of the LAA SCell(s) is idle (S2150). If the channel is idle (YES in S2150), the UE checks whether the backoff counter value is 0 (S2130).

If the channel is not idle in S2150, that is, if the channel is busy (NO in S2150), the UE checks whether the corresponding channel is idle during the defer duration T_{d} (longer than or equal to 25 usec), which is longer than the slot duration (e.g., 9 usec), according to step 5 (S2160). If the channel is idle (YES in S2170), the UE may resume the CAP.

For example, when the backoff counter value Nᵢₙᵢₜ is 10, if the channel is determined to be busy after the backoff counter value is reduced to 5, the UE determines whether the channel is idle by sensing the channel during the defer duration. In this case, if the channel is idle during the defer duration, the UE performs the CAP again starting at the backoff counter value of 5 (or at 4 by decreasing the backoff counter value by 1), instead of configuring the backoff counter value Nᵢₙᵢₜ.

On the other hand, if the channel is busy during the defer duration (NO in S2170), the UE performs steps S2160 again to check whether the channel is idle during a new defer duration.

When the UE does not transmit the transmission including the PUSCH on the carrier on which the LAA SCell(s) transmission(s) are performed after step 4 in the above procedure, the UE may transmit the transmission including the PUSCH on the carrier if the following conditions are satisfied:

When the UE is ready to perform the transmission including the PUSCH and the channel is sensed to be idle at least in a slot duration Tₛₗ; and

When the channel is sensed to be idle during all the slot durations of the defer duration T_{d} immediately before the transmission including the PUSCH.

If the channel is sensed not to be idle during the slot duration Tₛₗ when the UE senses the channel after being ready to transmit or if the channel is sensed not to be idle during any one of the slot durations of the defer duration T_{d} immediately before the intended transmission including the PUSCH, the UE proceeds to step 1 after sensing the channel to be idle during the slot durations of the defer duration T_{d}.

The defer duration T_{d} includes a duration T_{f}(=16 us) immediately followed by mₚ consecutive slot durations. Here, each slot duration (Tₛₗ) is 9 us long, and T_{f} includes an idle slot duration Tₛₗ at the start thereof.

When the UE senses the channel during the slot duration Ti, if the power detected by the UE for at least 4 us within the slot duration is less than an energy detection threshold X_{Thresh}, the slot duration Tₛₗ is considered to be idle. Otherwise, the slot duration Tₛₗ is considered to be busy.

CW_{min,p}≤CWₚ≤CW_{max,p} represents the CW. The adjustment of CWₚ will be described in detail in section 2.3.2.

CW_{min,p} and CW_{max,p} are selected before step 1 of the above procedure.

mₚ, CW_{min,p}, and CW_{max,p} are determined based on channel access priority classes signaled to the UE (see Table 9 above).

The adjustment of X_{Thresh} will be described in section 2.3.3.

2.3.1.2. Type 2 UL Channel Access Procedure

If a UE uses the Type 2 CAP for transmission including a PUSCH, the UE may transmit the transmission including the PUSCH immediately after sensing a channel to be idle for at least a sensing interval T_{short_ul}=25 us. T_{short_ul} includes a duration T_{f}=16 us immediately followed by one slot duration Tₛₗ=9 us, and T_{f} includes an idle slot duration Tₛₗ at the start thereof. When the channel is sensed to be idle during the slot durations of T_{short_ul}, the channel is considered to be idle for T_{short_ul}.

2.3.2. Contention Window Adjustment Procedure

If a UE transmits transmissions using the Type 1 channel access procedure that are associated with the channel access priority class p on a carrier, the UE maintains the CW value CWₚ and adjusts CWₚ for the transmissions before step 1 of the procedure described in section 2.3.1 (i.e., before performing the CAP) according to the following steps.

If the value of a new data indicator (NDI) for at least one HARQ process associated with HARQ_ID_ref is toggled,

For every priority class p ∈ {1,2,3,4}, CWₚ is set to CW_{min, p}.

Otherwise, CWₚ for every priority class p ∈ {1,2,3,4} increases to a next higher allowed value.

Here, HARQ_ID ref refers to the ID of a HARQ process of a UL-SCH in reference subframe n_{ref}. Reference subframe nref is determined as follows.

If the UE receives a UL grant in subframe n_{g}, subframe n_{w} is the most recent subframe before subframe n_{g}-3 in which the UE has transmitted a UL-SCH using the Type 1 channel access procedure.

If the UE performs transmission including the UL-SCH without gaps starting from subframe n₀ and in subframes n₀, n₁, . . . , n_{w}, reference subframe n_{ref} is subframe n₀.

Otherwise, reference subframe n_{ref} is subframe

When the UE is scheduled to perform transmission including a PUSCH without gaps in a set of subframes n₀, n₁, . . . , n_{w-1} using the Type 1 channel access procedure, if the UE is unable to perform any transmission including the PUSCH in the subframe set, the UE may maintain the value of CWₚ for every priority class p ∈ {1,2,3,4} without any changes.

If the reference subframe for the last scheduled transmission is also n_{ref}, the UE may maintain the value of CWₚ for every priority class p ∈ {1,2,3,4} to be the same as that for the last scheduled transmission including the PUSCH using the Type 1 channel access procedure.

If CWₚ=CW_{max, p}, the next higher allowed value for adjusting CWₚ is CW_{max, p}.

If CWₚ=CW_{max, p} is consecutively used K times to generate Nᵢₙᵢₜ, CWₚ is reset to CW_{min, p} only for the priority class p for which CWₚ=CW_{max, p} is consecutively used K times to generate Nᵢₙᵢₜ. In this case, K is selected by the UE from a set of values {1, 2, . . . , 8} for each priority class p ∈ {1,2,3,4}.

2.3.3. Energy Detection Threshold Adaptation Procedure

A UE accessing a carrier on which LAA Scell(s) transmission(s) are performed may set an energy detection threshold (X_{Thresh}) to be less than or equal to a maximum energy detection threshold X_{Thresh_max}.

The maximum energy detection threshold X_{Thresh_max} is determined as follows.

If the UE is configured with a higher layer parameter “maxEnergyDetectionThreshold-r14′,

X_{Thresh_max} is set equal to a value signaled by the higher layer parameter.

Otherwise,

The UE shall determine X′_{Thresh_max} according to the procedure described in section 2.3.3.1.

If the UE is configured with a higher layer parameter ‘maxEnergyDetectionThresholdOffset-r14’

X_{Thresh_max} is set by adjusting X′_{Thresh_max} according to an offset value signaled by the higher layer parameter.

Otherwise,

The UE sets X_{Thresh_max}=X′_{Thresh_max}.

The UE sets

2.3.3.1. Default Maximum Energy Detection Threshold Computation Procedure

If a higher layer parameter ‘absenceOfAnyOtherTechnology-r14’ indicates TRUE,

$${X}_{Thesh \_ max} = min \{ \begin{matrix}{T}_{max} + 10 dB , \\ {X}_{r}\end{matrix} \} .$$

Xᵣ is a maximum energy detection threshold defined by regulatory requirements in dBm when such requirements are defined. Otherwise, Xᵣ=Tₘₐₓ+10 dB.

Otherwise,

$${X}_{Thesh \_ max} = max \{ \begin{matrix}- 72 + 10 \cdot log 10 ( BW MHz / 20 MHz ) dBm , \\ min \{ \begin{matrix}{T}_{max ,} \\ {T}_{max} - {T}_{A} + ( {P}_{H} + 10 \cdot log 10 ( BW MHz / 20 MHz ) - {P}_{T X} )\end{matrix} \}\end{matrix} \}$$

Each variable is defined as follows:
T_{A}=10 dB
P_{H}−23 DBm,
P_{TX} is the set to the P_{CMAX_H} as defined in 3GPP TS 36.101.
Tₘₐₓ(dBm)=10·log 10(3.16228·10⁻⁸(mW/MHz)·BWMHz (MHz))
   BWMHz is the single cagier bandwidth in MHz.

2.4. Subframe/Slot Structure Applicable to U-band System

FIG. 22 is a diagram illustrating a partial transmission time interval (TTI) or a partial subframe/slot applicable to the present disclosure.

In the Rel-13 LAA system, a partial TTI is defined using the DwPTS to make the best use of a maximum channel occupancy time (MCOT) during transmission of a DL Tx burst and support continuous transmission. The partial TTI (or partial subframe) refers to an interval in which a signal is transmitted in a shorter period than the legacy TTI (e.g., 1 ms) in PDSCH transmission

In the present disclosure, a starting partial TTI or a starting partial subframe refers to a format in which some symbols located at the fore part of a subframe are left blank, and an ending partial TTI or an ending partial subframe refers to a format in which some symbols located at the rear part of a subframe are left blank (whereas a complete TTI is referred to as a normal TTI or a full TTI).

FIG. 22 illustrates various types of partial TTIs. In FIG. 12, the first block represents an ending partial TTI (or an ending partial subframe/slot), the second block represents a starting partial TTI (or a starting partial subframe/slot), and the third block represents a partial TTI (or a partial subframe/slot) where some symbols located at the fore and rear parts of a subframe are left blank. Here, a time interval obtained by removing a portion for signal transmission from a normal TTI is referred to as a transmission gap (Tx gap).

While FIG. 22 is based on DL operation, the present disclosure may be equally applied to UL operation. For example, the partial TTI structure shown in FIG. 22 is applicable to PUCCH and/or PUSCH transmission.

3. Proposed Embodiments

Hereinafter, the configurations according to the present disclosure will be described in detail based on the above-described technical features.

As a number of communication devices have required high communication capacity, the efficient use of limited frequency bands has been considered as an important issue. In a wireless communication system to which the present disclosure is applicable, a method of using U-bands commonly used in the conventional Wi-Fi system such as 2.4 GHz band or new attracted U-bands such as 5/6 GHz band and 60 GHz band for traffic offloading has been considered.

Basically, it is assumed that each communication node competes with other communication nodes to transmit and receive radio signals in U-bands. Thus, before transmitting a signal, each communication node needs to perform channel sensing to check whether other communication nodes perform signal transmission. In the present disclosure, such an operation is referred to as LBT or a channel access procedure (CAP). In particular, an operation of checking whether other communication nodes perform signal transmission is referred to as carrier sensing (CS). When it is determined that there is no communication node performing signal transmission, it may be said that clear channel assessment (CCA) is confirmed.

Accordingly, the eNB/gNB or the UE of the LTE/NR system to which the present disclosure is applicable should also perform the LBT or CAP for signal transmission in an unlicensed band (hereinafter, referred to as U-band). In other words, the eNB/gNB or the UE may perform signal transmission through the U-band using the CAP or may perform signal transmission through the U-band based on the CAP.

In addition, when the eNB/gNB or the UE transmits a signal through the U-band, other communication nodes such as Wi-Fi should not cause interference through the CAP. For example, in a Wi-Fi standard (e.g., 801.11ac), the CCA threshold is specified as—62 dBm for non-Wi-Fi signals and −82 dBm for Wi-Fi signals. Accordingly, an STA or AP operating based on the Wi-Fi standard may not transmit a signal so as not to cause interference when, for example, a signal other than the Wi-Fi signal is received at a power of −62 dBm or more.

In an NR system to which the present disclosure is applicable, BWP switching based on the following three methods may be supported.

(1) RRC (radio resource control) signaling;

(2) on DL/UL scheduling DCI (e.g., DCI format 0_0, 0_1, 1_0, 1_1); and

(3) Timer:

If DL and/or UL scheduling DCI is not found (or is not received/detected) in a specific BWP for a certain time or longer, the UE performs BWP switching to the (predefined) default BWP.

In the NR system to which the present disclosure is applicable, the UE may attempt signal transmission only in a BWP in which the UE has succeeded in CAP in the U-band (or in a BWP determined to be available based on the CAP). In consideration of this, the active BWP may be dynamically switched.

In view of the above, in the present disclosure, a specific method for supporting dynamic BWP switching and a specific UE operation related thereto will be described in detail.

In addition, in the NR system to which the present disclosure is applicable, the BS may dynamically configure the DL/UL configuration (or direction) for each slot for the UE through L1 signaling (e.g., physical layer signaling, PDCCH, DCI, etc.).

More specifically, the BS may configure the DL/UL configuration (or direction) (i.e., slot format indicator (SFI)) for each slot as an operation for the UE through DCI, wherein the DCI may be transmitted on a UE(-group) common PDCCH. In this operation, the BS may indicate whether each of the symbols constituting the slot is a DL, UL, or flexible symbol through corresponding signaling. Hereinafter, for simplicity, the UE(-group) common PDCCH on which the SFI is transmitted is referred to as a GC-PDCCH.

Accordingly, in the present disclosure, a specific signaling method for the GC-PDCCH (specifically, a UL direction signaling method) and a specific operation of a UE receiving the same will be described in detail.

In the present disclosure, an initial signal represents a signal transmitted at the start time of a DL transmission burst transmitted by the BS in the U-band (or at constant time intervals) for the purpose of announcement of the start of the burst (and/or the beam direction of the burst) or for automatic gain control (AGC). As the initial signal, an existing DL signal (e.g., the primary synchronization signal (PSS), the secondary synchronization signal (SSS), the channel state information reference signal (CSI-RS), the tracking reference signal (TRS), the demodulation reference signal (DMRS), etc.) may be employed, or a signal formed by partially modifying the DL signal may be employed. Alternatively, a specific DL channel (e.g., the physical broadcast channel (PBCH), the physical downlink control channel (PDCCH), the group common physical downlink control channel (GC-PDCCH), etc.) may be employed as the initial signal.

FIG. 23 is a diagram schematically illustrating the operation of a UE and a BS in an unlicensed band applicable to the present disclosure.

As shown in FIG. 23, the gNB may configure a set of BWPs on carrier(s) for the UE and activate some of the BWPs. Here, the carrier includes a U-band or a U-carrier, and one or more BWPs may be configured on one carrier.

Thereafter, the gNB or the UE may perform the CAP (or LBT) to perform signal transmission in the U-band. Here, the CAP (or LBT) may be performed for each CAP (or LBT) sub-band. The CAP sub-band may represent the minimum (frequency) unit/band (e.g., 20 MHz) of the CAP performed by the gNB or the UE. The CAP sub-band may be independently configured for each carrier (group) and/or BWP (group), or may be configured identically for every carrier (group) and/or BWP (group).

Thereafter, the gNB or the UE may perform a BWP-related operation based on the result of the CAP. For example, the CAP may transmit a DL signal in some or all CAP sub-bands according to the result of the CAP for each LBT sub-band, and indicate the time/frequency domain configuration (or structure) of the acquired DL channel occupancy time (DL COT) (e.g., DL/UL direction) to the UE.

Hereinafter, in the present disclosure, each of the above operations will be described in detail.

3.1. Method for supporting dynamic BWP switching

3.1.1. First method for supporting dynamic BWP switching: Supporting active BWP switching through an initial signal (or specific UE-specific DCI)

The UE may attach to a corresponding cell after initial access, or receive a service from a specific cell through RRC (or MAC CE) signaling, and may be provided with a configuration of multiple BWPs for the corresponding carrier. Then, the UE may be configured. Then, the UE may perform an operation according to one of the following options:

[Option 1] Attempt to receive an initial signal (or specific UE-specific DCI) in all the configured BWPs (i.e., for each configured BWP);

[Option 2] Attempt to receive an initial signal (or specific UE-specific DCI) in some BWP(s) among the configured BWPs through separate RRC (or MAC CE) signaling; and

[Option 3] Attempt to receive an initial signal (or specific UE-specific DCI) in some BWP(s) among the BWPs configured by a predetermined rule (e.g., BWPs having a specific bandwidth (e.g., 20 MHz)).

When the UE discovers (or detects) the initial signal (or specific UE-specific DCI) in a specific BWP, the UE may determine an active BWP (and/or a BWP in which DL/UL scheduling DCI is to be monitored and/or a BWP in which CSI/radio resource management (RRM) measurement is to be performed), using the following methods.

Method 1: Determine a BWP in which the initial signal (or specific UE-specific DCI) is discovered as the active BWP (and/or the BWP in which DL/UL scheduling DCI is to be monitored and/or the BWP in which CSI/RRM measurement is to be performed);

Method 2: Determine a BWP indicated through the initial signal (or specific UE-specific DCI) as the active BWP (and/or the BWP in which DL/UL scheduling DCI is to be monitored and/or the BWP in which CSI/RRM measurement is to be performed). In particular, this method is applicable when the BS succeeds in the CAP for a frequency band wider than the BWP in which the initial signal (or specific UE-specific DCI) is transmitted, or when the BS provides information on BWPs corresponding to the wide frequency band through the initial signal (or specific UE-specific DCI);

Method 3: When the UE discovers initial signals (or specific UE-specific DCI) in multiple BWPs simultaneously (or when multiple active BWPs are indicated by the initial signals or specific UE-specific DCIs discovered in multiple BWPs simultaneously), the UE may determine a BWP specified by a predetermined rule or RRC (or MAC CE) configuration (or L1 signaling indication) as the active BWP (and/or the BWP in which DL/UL scheduling DCI is to be monitored and/or the BWP in which CSI/RRM measurement is to be performed). For example, the UE may select a BWP having the widest (or narrowest) band and the highest (or lowest) BWP index as the active BWP.

One or more BWPs may be configured to attempt to receive an initial signal (or specific UE-specific DCI) in the various options described above and/or one or more BWPs may be determined with the various methods described above. Even in this case, the PDSCH received by the UE at a specific time may be limited to only one (active) BWP.

More specifically, it is assumed that a range from 5150 MHz to 5170 MHz is configured as BWP#0 and a range from 5170 MHz to 5190 MHz is configured as BWP#1, and a range from 5150 MHz to 5190 MHz is configured as BWP#2 for a UE. The UE may attempt to receive an initial signal for each of BWP#0/1/2. When the UE receives the initial signal in BWP#0 and BWP#2, the UE may determine BWP#2, which has a large BW, as the active BWP and perform PDCCH monitoring and CSI/RRM measurement in BWP#2.

3.1.2. Second Method for Supporting Dynamic BWP Switching: Configuring an Event for Incrementing/Decrementing a Timer Value and a Default BWP in the Timer-Based BWP Switching Support Operation

In the following detailed description, the term “timer” may be replaced with a “counter” according to an embodiment.

As an example applicable to the present disclosure, a maximum value of the timer may be set, and the timer value may be decremented by 1 from the maximum value as a specific event occurs. Accordingly, when the timer reaches 0, BWP switching to the default BWP may be triggered.

As another example applicable to the present disclosure, the timer value may be incremented by 1 from 0 as a specific event occurs. Accordingly, when the timer reaches the maximum value, BWP switching to the default BWP may be triggered.

In the present disclosure, the timer-based BWP switching support operation includes the two methods described above. Therefore, for simplicity, the following description is mainly based on the operation of triggering the BWP switching when the timer value is incremented by 1 and reaches the maximum timer value. However, the operation may be modified and similarly applied to the operation of triggering the BWP switching when the timer value is decremented by 1 and reaches 0.

Event of Incrementing the Timer Value

The UE may have discovered the initial signal, but failed to discover DL/UL scheduling DCI in the corresponding active BWP (or the active BWP switched based on the above-described first BWP switching support method). In this case, the UE may increase/decrease the timer value may be incremented/decremented as much as the number of slots in which the UE has failed to discover the DL/UL scheduling DCI (or by a function of the number of slots in which the UE has failed to discover the DL/UL scheduling DCI).

When the UE ever identifies the duration of the DL transmission burst through the initial signal and/or another DL channel, the UE may increment/decrement the timer value in the corresponding slot if it fails to discover the DL/UL scheduling DCI within the duration, and may reset the timer if it discovers the DL/UL scheduling DCI.

Alternatively, when it is difficult for the UE to identify the duration of the DL transmission burst through the initial signal and/or another DL channel, the UE may increment/decrement the timer value in the corresponding slot if it fails to discover the DL/UL scheduling DCI for a predetermined specific duration, and may reset the timer if the DL/UL scheduling DCI is discovered

In this case, the timer value may be maintained in a slot that is not determined to be the duration of the DL transmission burst.

Method for Configuring the Default BWP

The operation of defining a specific single BWP as the default BWP may be undesirable, considering that the BS may fail to perform the CAP for the BWP. Accordingly, the present disclosure proposes that a default BWP be defined by performing time division multiplexing (TDM) on a plurality of different BWP(s) at different times.

Here, there may be one or more default BWPs configured at a specific time. The pattern in which the BWP(s) are subjected to TDM at different times may be determined based on functions of cell index and/or slot index, or may be set by RRC (or MAC CE or L1) signaling. As an example, BWP#0 and BWP#1 may be set/determined as the default BWPs of slot#n and slot#n+1, and BWP#1 and BWP#2 may be set/determined as the default BWPs of slot#n+2 and slot#n+3. BWP#0 and BWP#2 may be set/determined as the default BWPs of slot#n+4 and slot#n+5.

3.2. GC-PDCCH

In a conventional LTE LAA system, a BS may inform one or more UEs of the UL duration on a common PDCCH (scrambled with the cell common radio network identifier (CC-RNTI)). Here, the UL duration should belong to the channel occupancy time (COT) occupied by the BS.

Accordingly, a UE scheduled to transmit the PUSCH only within the corresponding UL duration (regardless of the channel access type indicated in the UL grant) may perform a CAP available for transmission of the PUSCH (i.e., channel access type 2) and transmit the PUSCH if the corresponding U-band is idle for only 25 usec. On the other hand, a UE that has received information about the UL duration from the BS on a common PDCCH but does not have PUSCH transmission scheduled within the UL duration may not expect PDCCH monitoring (because the BS may schedule UL signal transmission to other UEs for the UL duration).

3.2.1. First Signaling Method Based on the GC-PDCCH

The BS may inform one or more UEs of a DL/UL/flexible symbol region for each slot on the GC-PDCCH. At this time, the BS may inform the UEs of whether a specific symbol is a UL (and/or flexible) symbol belonging to a COT occupied by the BS or a UL (and/or flexible) symbol not belonging to the COT.

As a specific example, when the size of the information by which the BS delivers SFI information for a specific slot duration to the UE is 4 bits, the BS may use 8-bit information that is twice the size of the information to signal, to one or more UEs, that the UL (and/or flexible) symbol(s) indicated in the 4 preceding bits belongs to the COT, and the UL (and/or flexible) symbol(s) indicated in the 4 following bits does not belong to the COT.

As another specific example, when the size of the information by which the BS delivers SFI information for a specific slot duration to the UE is 4 bits, the BS may use 8-bit information that is twice the size of the information to signal, to one or more UEs, that the UL (and/or flexible) symbol(s) indicated in the 4 preceding bits is irrelevant to the COT inclusion relationship, and the UL (and/or flexible) symbol(s) indicated in the 4 following bits belongs (or does not belong) to the COT.

Here, regardless of whether the symbol belongs to the COT, during a symbol period set as a UL symbol, the UE may not expect PDCCH monitoring and DL measurement for a symbol duration set as a UL symbol. In addition, when the UE attempts UL transmission for the UL (and/or flexible) symbol duration belonging to the COT, the UE may perform UL transmission based on the CAP of the channel access type allowed in COT sharing with the BS (regardless of the channel access type indicated in the UL grant).

3.2.2. Second Signaling Method Based on the GC-PDCCH

The BS may inform one or more UEs of the DL/UL/flexible symbol region for each slot on the GC-PDCCH. At this time, the BS may differently signal whether a specific symbol is a UL (and/or flexible) symbol belonging to a COT occupied by the BS or a UL (and/or flexible) symbol not belonging to the COT, depending on the BWP.

More specifically, according to the result of the CAP by the BS, the BWP combination in which the BS actually transmits a signal may differ among the respective DL transmission bursts. Accordingly, whether a specific duration (e.g., slot, symbol, etc.) belongs to the COT occupied by the BS may depend on the BWP.

Therefore, when the UE can receive information about the BWP in which the BS has successfully performed the CAP through the initial signal (or specific UE-specific DCI or the GC-PDCCH), the UE may interpret the SFI information differently according to the BWP.

As a more specific example, it is assumed that BWP#0 is set to 5150 MHz to 5170 MHz and BWP#1 is set to 5170 MHz to 5190 MHz for the UE. Subsequently, it is assumed that the UE recognizes, through an initial signal (or specific UE-specific DCI or the GC-PDCCH), that the BS has succeeded in the CAP only for BWP#0.

In this case, when the UE receives, on the GC-PDCCH, signaling indicating that slot#n/n+1 is an UL slot, but only slot#n belongs to the COT of the BS, the UE may operate as follows.

The UE does not expect PDCCH monitoring and CSI measurement in slot#n/n+1.

When transmitting a UL signal in BWP#0, the CAP of the channel access type allowed during COT sharing is allowed for UL transmission in slot#n, whereas only the CAP of the channel access type is allowed for UL transmission in slot#n+1.

When transmitting a UL signal in BWP#1, only the CAP of a channel access type in the UL grant for UL transmission within slot#n/n+1 is allowed.

3.2.3. Third Signaling Method Based on the GC-PDCCH

In the present disclosure, it is assumed that the minimum (frequency) unit of the CAP performed by the BS is a CAP sub-band (e.g., 20 MHz). The BS may perform the CAP for signal transmission through a BWP larger than the CAP sub-band in the U-band, but may succeed only in the CAP sub-band(s) smaller than the BWP. In this case, the BS may signal, to one or more UEs, that DL transmission is performed only in the CAP sub-band(s) in which the CAP is successful, or that some UL symbols belong to the DL COT only in the CAP sub-band(s) in which the CAP is successful, using the following method.

More specifically, each UE may be configured with a BWP corresponding to a separate frequency band and/or bandwidth. For example, UE1 may be configured with a BWP of 40 MHz BW corresponding to 5150 MHz to 5190 MHz, and UE2 may be configured with a BWP of 20 MHz BW corresponding to 5170 MHz to 5190 MHz. In this case, if the CAP sub-band is 20 MHz and the BS succeeds in the CAP only for the CAP sub-band corresponding to 5170 MHz to 5190 MHz, the BS may signal, through the GC-PDCCH, that DL transmission is performed only at the sub-band of 20 MHz to one or more UEs. In this case, the BS may send signaling to one or more UEs such that there is no ambiguity between UEs expecting BWP reception of different frequency bands and/or bandwidths, using the following methods.

As one method, the position of a field that each UE should receive in the GC-PDCCH may be configured UEs expecting BWP reception of different frequency bands and/or bandwidths. As an example, field A on the GC-PDCCH may be configured for UEs expecting a BWP like UE1, and field B on the GC-PDCCH may be configured for UEs expecting a BWP like UE2. In this case, each field may contain SFI information configured for the corresponding UEs. As an applicable example, each field may contain SFI information according to section 3.2.1 (that is, SFI information distinguishing between a UL (and/or flexible) symbol/or UL (and/or flexible) slot occupied by the BS and a UL (and/or flexible) symbol/or UL (and/or flexible) slot). Accordingly, each UE may recognize a band in which the DL COT is actually configured from the information in the field configured in the received GC-PDCCH.

As another method, UEs expecting BWP reception of different frequency bands and/or bandwidths may refer to a field on the common GC-PDCCH, but interpret the field according to a predetermined method. For example, when the field is composed of 2 bits, it may be determined (or configured) between the BS and the UE the first bit corresponds to 5150 MHz to 5170 MHz, and the second bit corresponds to 5170 MHz to 5190 MHz. Accordingly, UE1 may obtain configuration information about the DL COT in the 40 MHz range using all the two bits, and UE2 may obtain the configuration information about the DL COT in the 20 MHz range using only the second bit.

Alternatively, when only signal transmission through consecutive CAP sub-bands is allowed in any case, signaling overhead according to the above-described methods may be additionally reduced. For example, when there are 4 CAP sub-bands in the 80 MHz BWP/CC, the BS may signal the presence or absence of transmission in the CAP sub-band to one or more UEs through bitmap information of 4 bits, or may signal transmission information about consecutive CAP sub-bands to one or more UEs through bitmap information about the size of ceiling{log₂(n*(n+1)/2)} bits (where n is the number of LBT sub-bands belonging to the BWP/CC or multi-BWP/CC, and ceiling {X} means the least integer greater than or equal to X) (as in the LTE UL resource allocation type 0 RIV scheme).

3.2.4. Fourth Signaling Method Based on the GC-PDCCH

When the BS transmits the GC-PDCCH to one or more UEs, the BS may consider that a BWP corresponding to a separate frequency band and/or bandwidth may be configured for each UE. As a specific example, UE1 may be configured with a BWP of 40 MHz BW corresponding to 5150 MHz to 5190 MHz, and UE2 may be configured with a BWP of 20 MHz BW corresponding to 5170 MHz to 5190 MHz. In this case, when the CAP sub-band is 20 MHz and the BS succeeds in the CAP only for the CAP sub-band corresponding to 5150 MHz to 5170 MHz, the BS may signal, on the GC-PDCCH, that DL transmission is performed only in the corresponding 20 MHz range to one or more UEs.

In addition, the BS may signal that k slots from slot#n are DL slots to one or more UEs on the GC-PDCCH.

However, in the above case, since the GC-PDCCH is transmitted only in the BWP corresponding to 5150 MHz to 5170 MHz, UE2 may fail to receive the GC-PDCCH in the expected BWP (i.e., the BWP of 20 MHz BW corresponding to 5170 MHz to 5190 MHz), and accordingly may fail to obtain information about the corresponding DL slots. Accordingly, when there is UL transmission pre-configured for UE2 for the duration of the DL slots, the UE2 may perform UL transmission based on the CAP for the duration.

In consideration of such signal transmission, the BS needs an operation of receiving a signal on an adjacent carrier at the same time as the signal transmission. This may significantly increase the complexity of implementation of the BS. Further, if the BS fails to properly receive the signal, the UL signal transmission may cause interference to other coexisting nodes.

To address this issue, the BS may be allowed to perform DL transmission only when the CAP for a common CAP sub-band of 5170 to 5190 MHz for a plurality of UEs (e.g., UE1 and UE2 ) is successful. In other words, a reference sub-band through which the GC-PDCCH may be transmitted may be separately configured (as one or more sub-bands included in a CAP sub-band common to the plurality of UEs). In response, the UE may receive the GC-PDCCH only in the reference sub-band to obtain information on whether the DL COT is configured in a band other than the sub-band, or may (additionally) receive the GC-PDCCH through a sub-band other than the reference sub-band. In this case, the UE may assume that identical DL COT information is acquired in different sub-bands.

3.2.5. Fifth Signaling Method Based on the GC-PDCCH: A Method of Transmitting and Receiving a Signal/Channel Configured by Higher Layer Signaling

In an NR system to which the present disclosure is applicable, a UE for which DCI format 2_0 signaling SFI in a dynamic manner is not configured may operate as follows.

When the SFI is not configured by RRC signaling, reception of a downlink signal/channel (e.g., PDSCH, CSI-RS) and transmission of an uplink signal/channel (e.g., SRS, PUCCH, PUSCH, PRACH) configured by higher layer signaling may be allowed.

When the SFI is configured by RRC signaling (e.g., TDD-UL-DL-ConfigurationCommon or TDD-UL-DL-ConfigDedicated, etc.), reception of a downlink signal/channel (e.g., PDSCH, CSI-RS) and transmission of an uplink signal/channel (e.g., SRS, PUCCH, PUSCH, PRACH) configured by higher layer signaling may be allowe in a slot/symbol region configured as a flexible region by the RRC signaling.

On the other hand, a UE for which DCI format 2_0 is configured may operate as follows.

In a slot/symbol region that has no SFI configured by RRC signaling and is not indicated as DL by DCI format 2_0, the UE skips reception of a downlink signal/channel configured by higher layer signaling (e.g., PDSCH, CSI-RS).

In the slot/symbol region that has no SFI configured by RRC signaling and is not indicated as UL by DCI format 2_0, the UE skips transmitting an uplink signal/channel (e.g., SRS, PUCCH, PUSCH, PRACH) configured by higher layer signaling (after the processing time capability for UL transmission preparation from the last symbol of the CORESET configured for reception of DCI format 2_0).

When the SFI is configured through RRC signaling (e.g., TDD-UL-DL-ConfigurationCommon or TDD-UL-DL-ConfigDedicated, etc.), the UE skips receiving a downlink signal/channel configured by higher layer signaling (e.g., PDSCH, CSI-RS) in a slot/symbol region that is not indicated as DL by DCI format 2_0 in a slot/symbol region configured as a flexible region.

When the SFI is configured through RRC signaling (e.g., TDD-UL-DL-ConfigurationCommon or TDD-UL-DL-ConfigDedicated, etc.), the UE skips transmitting an uplink signal/channel (e.g., SRS, PUCCH, PUSCH, PRACH) configured by higher layer signaling (after the processing time capability for UL transmission preparation from the last symbol of the CORESET configured for reception of DCI format 2_0) in a slot/symbol region that is not indicated as UL by DCI format 2_0 in a slot/symbol region configured as a flexible region.

On the other hand, according to the operation of the BS in the unlicensed band, the BS may fail to provide an indication that a specific slot/symbol region is a DL or UL region to the UE through DCI format 2_0 for a slot/symbol region that is configured as a flexible region by RRC signaling due to failure in the CAP (or for a region in which the SFI is not configured by RRC signaling). In this case, it may be difficult to transmit/receive a DL/UL signal/channel configured by higher layer signaling in the slot/symbol region.

Accordingly, the present disclosure proposes an operation method in the unlicensed band as described above. More specifically, in the following description, the DL and UL operations in a more specific unlicensed band will be described in detail for reception of a downlink signal/channel (e.g., PDSCH, CSI-RS) and/or transmission of an uplink signal/channel (e.g., SRS, PUCCH, PUSCH, PRACH)) configured by higher layer signaling.

(1) Option 1

When DCI format 2_0 is configured for the UE, the UE may operate as if the DCI is not configured as follows.

More specifically, even when a slot/symbol region configured as a flexible region by RRC signaling (e.g., TDD-UL-DL-ConfigurationCommon or TDD-UL-DL-ConfigDedicated) is not indicated as DL to the UE by DCI format 2_0, the UE may receive a downlink signal/channel (e.g., PDSCH, CSI-RS, etc.) configured by higher layer signaling in the slot/symbol region configured as the flexible region.

Alternatively, when the SFI is not configured for the UE by RRC signaling, the UE may receive a downlink signal/channel (e.g., PDSCH, CSI-RS, etc.) configured by higher layer signaling in the slot/symbol region not indicated as DL by DCI format 2_0.

Alternatively, even when a slot/symbol region configured as a flexible region by RRC signaling (e.g., TDD-UL-DL-ConfigurationCommon or TDD-UL-DL-ConfigDedicated) is not indicated as UL to the UE by DCI format 2_0, the UE may transmit an uplink signal/channel (e.g., SRS, PUCCH, PUSCH, PRACH, etc.) configured by higher layer signaling in the slot/symbol region configured as the flexible region.

Alternatively, when the SFI is not configured for the UE through RRC signaling, the UE may transmit an uplink signal/channel (e.g., SRS, PUCCH, PUSCH, PRACH, etc.) configured by higher layer signaling in the slot/symbol region not indicated as UL by DCI format 2_0.

(2) Option 2

When DCI format 2_0 is configured for the UE, the UE may operate in a similar manner to the operation supported by the NR system as follows.

More specifically, when the UE discovers a signal/channel (e.g., DCI format 2_0, initial signal, DL burst, etc.) for DL transmission burst detection of a serving cell in a slot/symbol region configured as a flexible region by RRC signaling (e.g., TDD-UL-DL-ConfigurationCommon or TDD-UL-DL-ConfigDedicated), and thus recognizes that the UL/DL configuration is a DL direction for a specific duration, the UE may receive a downlink signal/channel (e.g., PDSCH, CSI-RS, etc.) configured by higher layer signaling for the duration.

Alternatively, when the SFI is not configured for the UE by RRC signaling, and the UE discovers a signal/channel (e.g., DCI format 2_0, initial signal, DL burst, etc.) for DL transmission burst detection of the serving cell, and thus recognizes that the UL/DL configuration is a DL direction for a specific duration, the UE may receive a downlink signal/channel (e.g., PDSCH, CSI-RS, etc.) configured by higher layer signaling for the duration.

Alternatively, when the UE discovers a signal/channel (e.g., DCI format 2_0, initial signal, DL burst, etc.) for DL transmission burst detection of a serving cell in a slot/symbol region configured as a flexible region by RRC signaling (e.g., TDD-UL-DL-ConfigurationCommon or TDD-UL-DL-ConfigDedicated), and thus recognizes that the UL/DL configuration is a UL direction for a specific duration, the UE may transmit an uplink signal/channel (e.g., SRS, PUCCH, PUSCH, PRACH, etc.) configured by higher layer signaling for the duration.

Alternatively, when the SFI is not configured for the UE by RRC signaling, and the UE discovers a signal/channel (e.g., DCI format 2_0, initial signal, DL burst, etc.) for DL transmission burst detection of the serving cell, and thus recognizes that the UL/DL configuration is a UL direction for a specific duration, the UE may transmit an uplink signal/channel (e.g., SRS, PUCCH, PUSCH, PRACH, etc.) configured by higher layer signaling for the duration.

(3) Option 3

Different rules may be configured for DL signal reception according to a monitoring periodicity set for the UE to receive DCI format 2_0.

For example, when the monitoring periodicity is less than a specific value, the BS may have an occasion to transmit DCI more frequently. In this case, the UE according to the present disclosure may skip receiving a DL signal/channel configured by higher layer signaling in the corresponding slot/symbol region (i.e., a slot/symbol region configured as a flexible region by RRC signaling (e.g., TDD-UL-DL-ConfigurationCommon or TDD-UL-DL-ConfigDedicated) or a slot/symbol region in which the SFI is not configured by the RRC signaling).

On the other hand, when the monitoring periodicity exceeds a specific value, the UE may perform DL signal reception according to Option 1 (or Option 2) described above.

Similarly, different rules may be configured for UL signal reception according to a monitoring periodicity set for reception of the DCI format 2_0 by the UE.

For example, when the monitoring periodicity is less than or equal to a specific value, the BS may have an occasion to transmit DCI more frequently. In this case, the UE according to the present disclosure may skip receiving a UL signal/channel configured by higher layer signaling in the corresponding slot/symbol region (i.e., a slot/symbol region configured as a flexible region by RRC signaling (e.g., TDD-UL-DL-ConfigurationCommon or TDD-UL-DL-ConfigDedicated) or a slot/symbol region in which the SFI is not configured by the RRC signaling).

On the other hand, when the monitoring periodicity exceeds a specific value, the UE may perform UL signal transmission according to Option 1 (or Option 2) described above.

Among the above-described options, the same option or different options may be applied according to DL and UL. For example, Option 2 may be applied for DL and Option 1 may be applied for UL. Alternatively, reception of a DL signal/channel configured by higher layer signaling may be skipped for DL in a slot/symbol region configured as a flexible region as in the case of the conventional NR system, and Option 1 may be applied for UL.

Additionally, when a separate DCI providing the time/frequency domain information about the COT occupied by the BS is introduced in the NR system to which the present disclosure is applicable, the DCI may be applied instead of DCI format 2_0 for the previously proposed methods to perform the same operation.

3.2.6. Sixth Signaling Method Based on the GC-PDCCH: a Signaling Method based on a combination of the above-described signaling methods

As described above, in one frequency band (e.g., BWP), a frequency sub-band (e.g., CAP BW, CAP Unit, 20 MHz, etc.) through which the BS may substantially transmit a DL signal may be determined (based on the BS's CAP). In this case, the BS according to the present disclosure may provide one or more UEs with SFI information and occupancy information about the BS for each frequency sub-band through a GC-PDCCH as described below. Hereinafter, for simplicity, a frequency band is simplified to a BWP, and one frequency sub-band is simplified to a CAP BW. However, the technical configuration described below may be extended to various examples according to embodiments (e.g., one frequency band=a frequency band that has a certain size and is larger than one BWP; and one frequency sub-band=a frequency band corresponding to one BWP).

In the following description, it is assumed that one BWP includes a plurality of CAP BWs. It is also assumed that the BS performs/attempts DL signal transmission based on an independent CAP for each CAP BW. Here, the independent CAP merely means that the occupancy status of the BS is independently determined for each CAP BW, and does not mean that all CAP types performed for the respective CAP BWs are different.

The BS may provide the following information to one or more UEs in common on the GC-PDCCH:

Information about a CAP BW occupied by the BS in one BWP; and

Information indicating a UL (and/or flexible) symbol/slot occupied by the BS in the CAP BW occupied by the BS and information indicating a UL (and/or flexible) symbol/slot not occupied by the BS in the CAP BW occupied by the BS, wherein the UL (and/or flexible) symbol/slot information may be included in the SFI information or may be configured separately from the SFI information.

In this case, the BS may provide the information to the one or more UEs (i) through fields distinguished from each other for respective UE groups for which different CAP BWs are configured, or (ii) through fields distinguished for the respective CAP BWs.

In the following description, it is assumed that CAP BW#0 and CAP BW#1 are configured for UE1, and CAP BW#1 is configured for UE2.

According to an example, the BS may distinguish between a field for UE1 (hereinafter, field #A) and a field for UE2 (hereinafter, field #B) to provide the UE1 and UE2 with (a) information about a CAP BW occupied by the BS and (b) information indicating UL (and/or flexible) symbols/slots occupied by the BS in the CAP BW occupied by the BS and information indicating UL (and/or flexible) symbols/slots unoccupied by the BS in the CAP BW occupied by the BS.

More specifically, when the BS occupies both CAP BW#0 and CAP BW#1 for DL signal transmission, the BS may provide (a) information indicating that the BS occupies both CAP BW#0 and CAP BW#1 and (b) information indicating UL (and/or flexible) symbols/slots occupied by the BS and UL (and/or flexible) symbols/slots unoccupied by the BS for each of the CAP BWs occupied by the BS (i.e., CAP BW#0 and CAP BW#1) to UE 1 through field #A. Here, the UL (and/or flexible) symbol/slot information occupied by the BS and the UL (and/or flexible) symbol/slot information unoccupied by the BS for CAP BW#0 occupied by the BS and the UL (and/or flexible) symbol/slot information occupied by the BS and the UL (and/or flexible) symbol/slot information unoccupied by the BS for CAP BW#1 occupied by the BS may be separately configured or may be commonly configured.

Similarly, the BS may provide (a) information indicating that the BS occupies CAP BW#1 and (b) information indicating UL (and/or flexible) symbols/slots occupied by the BS and UL (and/or flexible) symbols/slots unoccupied by the BS in CAP BW#1 to UE2 through field #B.

Alternatively, when the BS occupies only CAP BW#1 for DL signal transmission (i.e., the BS does not occupy CAP BW#0), the BS may provide (a) information indicating that the BS does not occupy any of CAP BW#0 CAP BW#1 to UE1 through field #A. Here, field #A may or may not contain (b) information indicating UL (and/or flexible) symbols/slots unoccupied by the BS in CAP BW#0 and CAP BW#1. n information (b) is not contained in field #A, UE1 may acquire slot format information including information (b) through a field other than field #A.

In addition, the BS may provide (a) information indicating that the BS occupies CAP BW#1 and (b) information indicating UL (and/or flexible) symbols/slots occupied by the BS and UL (and/or flexible) symbols/slots unoccupied by the BS in CAP BW#1 to UE2 through field #B.

According to another example, the BS may provide related information to the one or more UE through fields distinguished for the respective CAP BWs.

More specifically, when the BS occupies both CAP BW#0 and CAP BW#1 for DL signal transmission, the BS may provide (a) information indicating that the BS occupies CAP BW#0 and (b) information indicating UL (and/or flexible) symbols/slots occupied by the BS and UL (and/or flexible) symbols/slots unoccupied by the BS in CAP BW#0 to UE1 through a field for CAP BW#0 (hereinafter referred to as field #C). Similarly, the BS may provide (a) information indicating that the BS occupies CAP BW#1 and (b) information indicating UL (and/or flexible) symbols/slots occupied by the BS and UL (and/or flexible) symbols/slots unoccupied by the BS in CAP BW#1 to UE1 and UE2 through a field for CAP BW#1 (hereinafter referred to as field #D)

Alternatively, when the BS occupies only CAP BW#1 for DL signal transmission, the BS may provide (a) information indicating that the BS does not occupy CAP BW#0 to UE1 through field #C. Here, field #C may or may not contain (b) information indicating UL (and/or flexible) symbols/slots unoccupied by the BS in CAP BW#0. When information (b) is not contained in field #C, UE1 may acquire slot format information including information (b) through a field other than field #C.

In addition, the BS may provide (a) information indicating that the BS occupies CAP BW#1 and (b) information indicating UL (and/or flexible) symbols/slots occupied by the BS and UL (and/or flexible) symbols/slots unoccupied by the BS in CAP BW#1 to UE1 and UE2 through field #D.

In the above-described configuration, information (b) may be configured according to section 3.2.1 (namely, by distinguishing the information indicating the UL (and/or flexible) symbols/slots occupied by the BS and the information indicating the UL (and/or flexible) symbols/slots unoccupied by the BS) or may be configured based on joint encoding including the two pieces of information.

Particularly, in the above configuration, when the slot format (or the UL and/or flexible symbol/slot configuration) differs between the respective CAP BWs, the BS may independently distinguish (or jointly encode) a slot format per CAP BW (or the information indicating the UL (and/or flexible) symbols/slots occupied by the BS and the information indicating the UL (and/or flexible) symbols/slots unoccupied by the BS) for each CAP BW and provide the same to one or more UEs.

Based on the above-described information, the one or more UEs may acquire information about a UL symbol/slot occupied by the BS (or a UL symbol/slot in which CAP according to COT sharing with the BS is allowed) and a UL symbol/slot unoccupied by the BS (or a UL symbol/slot in which CAP according to COT sharing with the BS is not allowed) for each CAP BW, together with the information indicating the CAP BW occupied by the BS. Based on the above-mentioned information, the one or more UEs may not expect to receive a downlink signal, transmit an uplink signal, or configure PDCCH monitoring for a predetermined duration, through a CAP BW configured for each UE.

3.2.7. Seventh Signaling Method Based on the GC-PDCCH

The BS according to the present disclosure may provide one or more UEs with DL COT length information and slot format information for each CAP BW occupied by the BS through the GC-PDCCH.

To this end, the BS may provide the above-described information to the one or more UEs (i) through fields distinguished from each other for respective UE groups for which different CAP BWs are configured, or (ii) through fields distinguished for the respective CAP BWs.

As described above, the BS may provide one or more UEs with DL COT length information and slot format information (or UL (and/or flexible) symbol/slot information) occupied by the BS for one or more CAP BWs for each UE group (i) through the fields distinguished from each other for the respective UE groups for which different CAP BWs are configured.

Alternatively, the BS may provide one or more UEs with DL COT length information and slot format information (or UL (and/or flexible) symbol/slot information) occupied by the BS for each CAP BW (ii) through the fields distinguished for the respective CAP BWs.

In the above-described configuration, when the slot format information (or UL (and/or flexible) symbol/slot information) for a specific UE group or CAP BW is the same as the slot format information (or UL (and/or flexible) symbol/slot information) for another UE group or CAP BW, the slot format information (or UL (and/or flexible) symbol/slot information) for the specific UE group or CAP BW may be omitted.

By receiving the GC-PDCCH configured as described above, one or more UEs may acquire the UL (and/or flexible) symbol/slot information included in the DL COT of the BS and the UL (and/or flexible) symbol/slot information not included in the DL COT of the BS for each CAP BW. Based on the above-mentioned information, the one or more UEs may not expect to receive a downlink signal, transmit an uplink signal, or configure PDCCH monitoring for a predetermined duration, through a CAP BW configured for each UE.

3.3. SCS Setting

In sharing the channel occupancy time (COT) occupied by the BS with UL transmission of the UE, the sub-carrier spacing (SCS) for DL transmission may be set to be the same as the SCS for UL transmission.

Specifically, when the SCS is changed, it may take a switching time (due to radio frequency (RF) tuning, and/or configuration information update, and/or software update, etc.) in SCS switching. In this case, in order to reduce the delay in transmission of HARQ-ACK feedback (in the DL COT) for the PDSCH included in the DL COT, the corresponding switching gap may be narrowed.

To this end, the SCS for UL transmission performed in the DL COT and the SCS for UL transmission that is not performed in the DL COT may be set differently from each other. As an example, when the SCS for DL transmission is set to 15 kHz and the SCS for UL transmission is set to 15 kHz or 30 kHz, the UE may assume that the SCS for the UL transmission scheduled (or performed) in the DL COT is 15 kHz.

Specifically, the UE may acquire time resource information about the DL COT (occupied by the BS) through UE-specific or group-common DCI. Subsequently, when UL transmission is scheduled/configured in the time resource information, the UE may assume that the SCS for the UL transmission is 15 kHz.

Alternatively, when the CAP of the channel access type allowed in sharing the COT with the BS is indicated through the UL grant, the UE may assume that the SCS for the UL transmission is 15 kHz.

Alternatively, when one or more of the PUCCH resource, HARQ feedback timing, or HARQ-ACK codebook type allowed in sharing the COT with the BS is indicated through the UL grant (or DL scheduling DCI, common DCI, or the like), the UE may assume that the SCS for the UL transmission is 15 kHz.

3.4. Network Initial Access and Communication Procedure Applicable to the Present Disclosure

The UE according to the present disclosure may perform a network access procedure to carry out the procedures and/or methods described/proposed above. For example, while accessing a network (e.g., a BS), the UE may receive system information and configuration information necessary to carry out the procedures and/or methods described/proposed above and store the same in a memory. The configuration information required for the present disclosure may be received through higher layer (e.g., RRC layer; medium access control (MAC) layer) signaling.

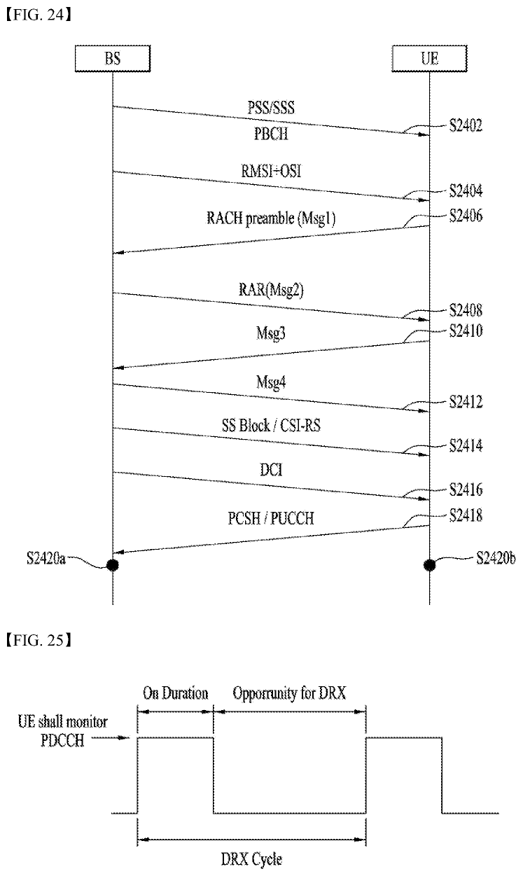

FIG. 24 illustrates an exemplary procedure for network initial access and subsequent communication. In NR, a physical channel and an RS may be transmitted by beamforming. When beamforming-based signal transmission is supported, a beam management process may be performed for beam alignment between a BS and a UE. Further, a signal proposed by the present disclosure may be transmitted/received by beamforming. Beam alignment may be performed based on an SSB in RRC IDLE mode, and based on a CSI-RS (in DL) and an SRS (in UL) in RRC CONNECTED mode. When beamforming-based signal transmission is not supported, a beam-related operation may be skipped in the following description.

Referring to FIG. 24, a BS may transmit an SSB periodically (S2402). The SSB includes a PSS/SSS/PBCH. The SSB may be transmitted by beam sweeping. The BS may then transmit remaining minimum system information (RMSI) and other system information (OSI) (S2404). The RMSI may include information (e.g., PRACH configuration information) required for the UE to initially access the BS. After the SSB detection, the UE identifies a best SSB. The UE may then transmit an RACH preamble (Message 1 or Msg 1) in PRACH resources linked/corresponding to the index (i.e., beam) of the best SSB (S2406). The beam direction of the RACH preamble is associated with the PRACH resources. Association between PRACH resources (and/or RACH preambles) and SSBs (SSB indexes) may be configured by system information (e.g., RMSI). Subsequently, the BS may transmit a random access response (RAR) (Message 2 or Msg 2) in response to the RACH preamble in an RACH procedure (S2408). The UE may transmit Message 3 (Msg 3) (e.g., RRC Connection Request) based on a UL grant included in the RAR (S2410), and the BS may transmit a contention resolution message (Message 4 or Msg 4) (S2412). Msg 4 may include RRC Connection Setup.

Once an RRC connection is established between the BS and the UE in the RACH procedure, beam alignment may be subsequently performed based on an SSB/CSI-RS (in DL) and an SRS (in UL). For example, the UE may receive the SSB/CSI-RS (S2414). The SSB/CSI-RS may be used for the UE to generate a beam/CSI report. The BS may request a beam/CSI report to the UE by DCI (S2416). The UE generates the beam/CSI report based on the SSB/CSI-RS and transmit the generated beam/CSI report to the BS on a PUSCH/PUCCH (S2418). The beam/CSI report may include information about a preferred beam as a result of beam measurement. The BS and the UE may switch beams based on the beam/CSI report (S2420a and S2420b).

Subsequently, the UE and the BS may perform the later-described/proposed procedures and/or methods. For example, the UE and the BS may transmit a radio signal by processing information stored in a memory, or process a received radio signal and store the processed radio signal in the memory based on configuration information obtained in the network access procedure (e.g., the system information acquisition process, the RACH-based RRC connection process, and so on) according to a proposal of the present disclosure. The radio signal may include at least one of a PDCCH, a PDSCH, or an RS in DL, and at least one of a PUCCH, a PUSCH, or an SRS in UL.

3.5. Discontinuous Reception (DRX) Applicable to the Present Disclosure

In the present disclosure, the UE may perform the DRX operation while carrying out the procedures and/or methods described/proposed above. A UE for which DRX is configured may discontinuously receive a DL signal. Thereby, power consumption may be reduced. The DRX may be performed in a radio resource control (RRC)_IDLE mode, an RRC_INACTIVE mode, or the RRC_CONNECTED mode. In the RRC_IDLE mode and the RRC_INACTIVE mode, the DRX is used to receive paging signals discontinuously. Hereinafter, DRX performed in the RRC_CONNECTED mode (RRC_CONNECTED_DRX) will be described.

FIG. 25 is a diagram illustrating a DRX cycle (RRC_CONNECTED state).

Referring to FIG. 25, the DRX cycle includes On Duration and Opportunity for DRX. The DRX cycle defines a time interval in which On Duration is periodically repeated. On Duration is a time period during which the UE monitors to receive a PDCCH. When DRX is configured, the UE performs PDCCH monitoring during the On Duration. When there is any successfully detected PDCCH during the PDCCH monitoring, the UE operates an inactivity timer and is maintained in an awake state. On the other hand, when there is no successfully detected PDCCH during the PDCCH monitoring, the UE enters a sleep state, when the On Duration ends. Therefore, if DRX is configured, PDCCH monitoring/reception may be performed discontinuously in the time domain, when the afore-described/proposed procedures and/or methods are performed. For example, if DRX is configured, PDCCH reception occasions (e.g., slots having PDCCH search spaces) may be configured discontinuously according to a DRX configuration in the present disclosure. On the contrary, if DRX is not configured, PDCCH monitoring/reception may be performed continuously in the time domain, when the afore-described/proposed procedures and/or methods are performed. For example, if DRX is not configured, PDCCH reception occasions (e.g., slots having PDCCH search spaces) may be configured continuously in the present disclosure. PDCCH monitoring may be limited in a time period configured as a measurement gap, irrespective of whether DRX is configured.

Table 15 describes a UE operation related to DRX (in the RRC CONNECTED state). Referring to Table 15, DRX configuration information is received by higher-layer (RRC) signaling, and DRX ON/OFF is controlled by a DRX command of the MAC layer. Once DRX is configured, the UE may perform PDCCH monitoring discontinuously in performing the described/proposed procedures and/or methods according to the present disclosure.

TABLE 15

| | Type of signals | UE procedure |
|---|---|---|
| 1^{st} step | RRC signalling (MAC- | Receive DRX configuration |
| | CellGroupConfig) | information |
| 2^{nd} Step | MAC CE ((Long) DRX | Receive DRX command |
| | command MAC CE) | |
| 3^{rd} Step | — | Monitor a PDCCH during an |
| | | on-duration of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.

Value of drx-OnDurationTimer: defines the length of the starting duration of a DRX cycle.

Value of drx-InactivityTimer: defines the length of a time duration in which the UE is in the awake state after a PDCCH occasion in which a PDCCH indicating initial UL or DL data has been detected.

Value of drx-HARQ-RTT-TimerDL: defines the length of a maximum time duration from reception of a DL initial transmission to reception of a DL retransmission.

Value of drx-HARQ-RTT-TimerDL: defines the length of a maximum time duration from reception of a grant for a DL initial transmission to reception of a grant for a UL retransmission.

drx-LongCycleStartOffset: defines the time duration and starting time of a DRX cycle.

drx-ShortCycle (optional): defines the time duration of a short DRX cycle.

When at least one of drx-OnDurationTimer, drx-InactivityTimer, drx-HARQ-RTT-TimerDL, or drx-HARQ-RTT-TimerDL is running, the UE performs PDCCH monitoring in each PDCCH occasion, while staying in the awake state.

Based on the DRX operation and the like as described above, the UE and the BS according to the present disclosure may operate as described below.

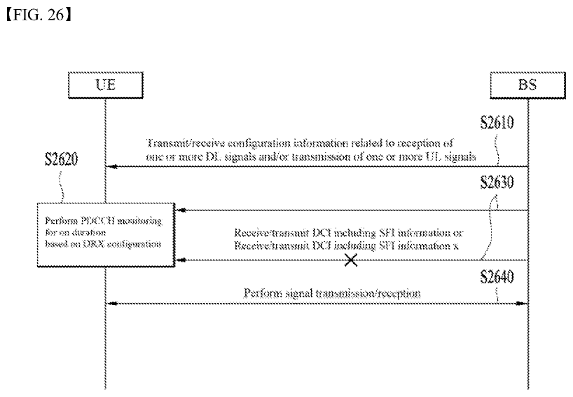

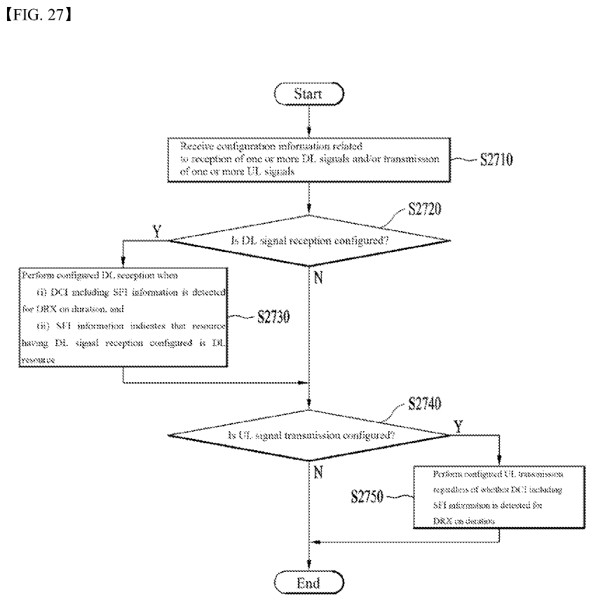

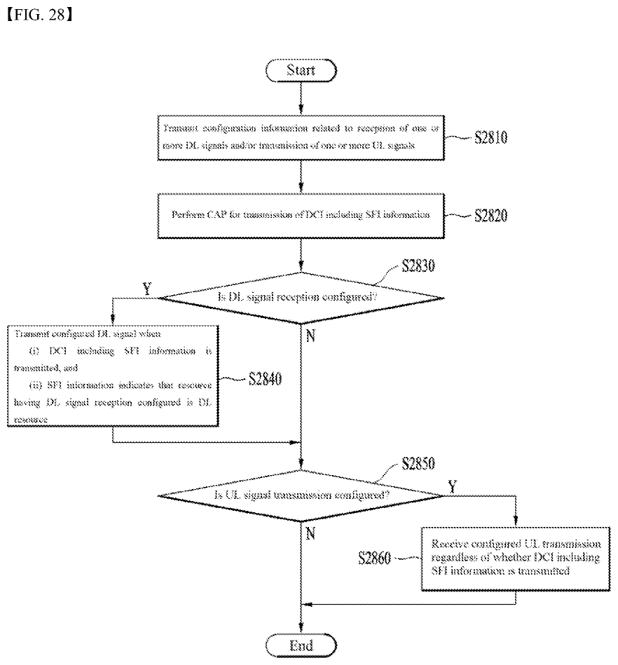

FIG. 26 is a diagram schematically illustrating a method of operating a UE and a BS according to the present disclosure, FIG. 27 is a flowchart illustrating a method of operating the UE according to the present disclosure, and FIG. 28 is a flowchart illustrating a method of operating the BS according to the present disclosure.

The UE receives, through higher layer signaling, configuration information related to one or more of reception of one or more DL signals or transmission of one or more UL signals on a resource not configured either as a DL resource or as a UL resource (S2610, S2710). In a corresponding operation, the BS transmits, through higher layer signaling, configuration information related to one or more of reception of one or more DL signals or transmission of one or more UL signals on a resource not configured either as a DL resource or as a UL resource (S2610, S2810).

As an example, the resource not configured either as a DL resource or as a UL resource may be configured as a flexible resource through the higher layer signaling.

As another example, the resource not configured either as a DL resource or as a UL resource may be a resource that is not configured as a flexible resource by the higher layer signaling.

Based on the DRX being configured for the UE, the UE performs physical downlink control channel (PDCCH) monitoring in the unlicensed band for the on duration (S2620).

In the present disclosure, the DRX configuration may be performed based on physical layer signaling (e.g., PDCCH, DCI, etc.) and/or higher layer signaling (e.g., RRC, MAC-CE, etc.).

In an operation corresponding to that of the UE, the BS performs a CAP to transmit DCI including SFI information to the UE through the unlicensed band (S2820). At this time, since contention-based channel access for the unlicensed band is required for signal transmission through the unlicensed band, the BS may or may not transmit DCI including SFI information to the UE based on the result of the CAP (S2620). In response, the UE may or may not detect the DCI including the SFI information (S2630). Alternatively, even when the BS succeeds in the CAP for transmission of DCI including the SFI information, the DCI including the SFI information may not be properly delivered to the UE if the channel state is poor. In other words, when the BS transmits the DCI information including the SFI information to the UE, the UE may fail to detect the DCI including the SFI information.

Accordingly, failing to detect the DCI including the SFI information by the UE according to the present disclosure may include not only a case where the BS fails to transmit the DCI including the SFI information (due to the characteristics of the unlicensed band), but also a case where the BS transmits the DCI including the SFI information, but the UE fails to properly detect the DCI including the SFI information (due to the channel state, etc.).

Based on such features, the UE may perform signal transmission/reception with the BS through the unlicensed band as follows (S2640).

First, the UE receives configuration information related to reception of the one or more DL signals (or reception of one or more DL signals is configured for the UE) (S2720). When (i) DCI including SFI information is detected through the PDCCH monitoring, and (ii) the SFI information indicates that the resource for receiving the one or more DL signals is a DL resource, the UE may receive the one or more DL signals on the DL resource in the unlicensed band (S2730).

Alternatively, when the UE receives configuration information related to transmission of one or more UL signals (or transmission of one or more UL signals is configured for the UE) (S2740), the UE transmits the one or more UL signals through the unlicensed band regardless of whether the DCI is detected through the PDCCH monitoring for the DRX on duration (S2750).

In the present disclosure, transmitting the one or more UL signals by the UE may include transmitting the one or more UL signals in the unlicensed band using a channel access procedure (CAP) in the unlicensed band..

In the present disclosure, the SFI information may indicate that each symbol included in one or more slots is related to one of a downlink symbol, an uplink symbol, or a flexible symbol.

Here, the one slot may include 14 symbols.

In the present disclosure, the one or more DL signals may include one or more of a physical downlink shared channel (PDSCH) signal and a channel state information reference signal (CSI-RS).

In the present disclosure, the one or more UL signals may include one or more of a sounding reference signal (SRS), a physical uplink control channel (PUCCH) signal, a physical uplink shared channel (PUSCH) signal, and a physical random access channel (PRACH) signal.

In the present disclosure, the DCI may be configured to be commonly transmitted to a plurality of UEs including the above-described UE.

In the present disclosure, the UE may switch to a sleep state based on the DRX configuration when it fails to receive the PDCCH including the DCI for the on duration of the DRX configuration.

In the present disclosure, in order to perform one or more of reception of the one or more DL signals or transmission of the one or more UL signals, the UE may perform the following operations:

Receiving a synchronization signal and a physical broadcast channel (PBCH) signal from the BS; and

Establishing a radio resource control (RRC) connection with the BS based on the synchronization signal and the PBCH signal.

Here, establishing the RRC connection may include the following operations:

Transmitting a random access channel preamble to the BS through a PRACH resource determined based on the synchronization signal and the PBCH signal;

Receiving a random access response (RAR) message in response to the random access channel preamble;

Transmitting an RRC connection request message to the BS based on an uplink grant included in the RAR message; and

Receiving a contention resolution message from the BS in response to the RRC connection request message.

In accordance with the UE, the BS according to the present disclosure may perform signal transmission and reception through the unlicensed band as follows (S2640).

First, the configuration information transmitted from the BS to the UE is related to the reception of the one or more DL signals (or the BS configures the reception of one or more DL signals for the UE) (S2530). When (i) the DCI is transmitted through the unlicensed band on the basis of the CAP of the BS, and (ii) the SFI information indicates that the resource for receiving the one or more DL signals is a DL resource, the BS transmits the one or more DL signals to the UE through the unlicensed band (S2540).

Alternatively, when the configuration information transmitted from the BS to the UE is related to the transmission of the one or more UL signals (or the BS configures the transmission of one or more UL signals for the UE) (S2550), the BS receives the one or more UL signals from the UE through the unlicensed band regardless of whether the DCI is transmitted through the unlicensed band based on the CAP (S2560).

Since examples of the above-described proposal method may also be included in one of implementation methods of the present disclosure, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal).

4. Device Configuration

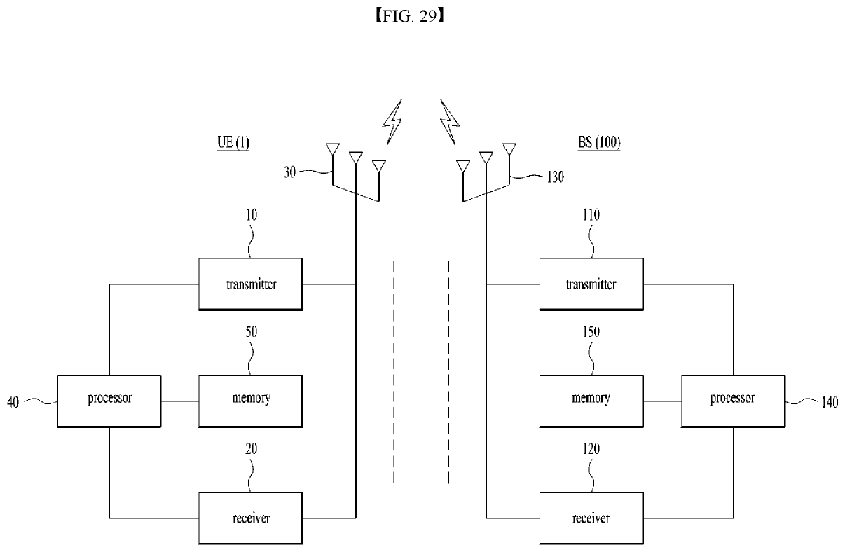

FIG. 29 is a diagram illustrating configurations of a UE and a BS by which proposed embodiments can be implemented. The UE and the BS illustrated in FIG. 29 operate to implement the embodiments of the above-described DL signal transmission and reception method between the UE and the BS.

The UE 1001 may operate as a transmission end on UL and as a reception end on DL. The BS (eNB or gNB) 1100 may operate as a reception end on UL and as a transmission end on DL

That is, the UE and the BS may include transmitters 1010 and 1110 and receivers 1020 and 1120, respectively, to control transmission and reception of information, data and/or messages and may include antennas 1030 and 1130, respectively, to transmit and receive information, data, and/or messages.

The UE and the BS further include processors 1040 and 1140, respectively, for performing the above-described embodiments of the present disclosure. The processors 1040 and 1140 control memories 1050 and 1150, the transmitters 1010 and 1110, and/or the receivers 1020 and 1120, respectively, to implement the above-described/proposed procedures and/or methods.

For example, the processors 1040 and 1140 include communication modems designed to implement radio communication technology (e.g., LTE or NR). The memories 1050 and 1150 are connected to the processors 1040 and 1140 and store various information related to operations of the processors 1040 and 1140. As an example, the memories 1050 and 1150 may perform a part or all of processes controlled by the processors 1040 and 1140 or store software code including the above-described/proposed procedures and/or methods. The transmitters 1010 and 1110 and/or the receivers 1020 and 1120 are connected to the processors 1040 and 1140 and transmit and/or receive radio signals. The processors 1040 and 1140 and the memories 1050 and 1150 may be a part of a processing chip (e.g., system-on-chip (SoC)).

The transmitters and receivers included in the UE and the BS may perform a packet modulation and demodulation function, a high-speed packet channel coding function, an OFDMA packet scheduling function, and/or a channelization function, for data transmission. The UE and the BS of FIG. 29 may further include low-power radio frequency (RF)/intermediate frequency (IF) units.

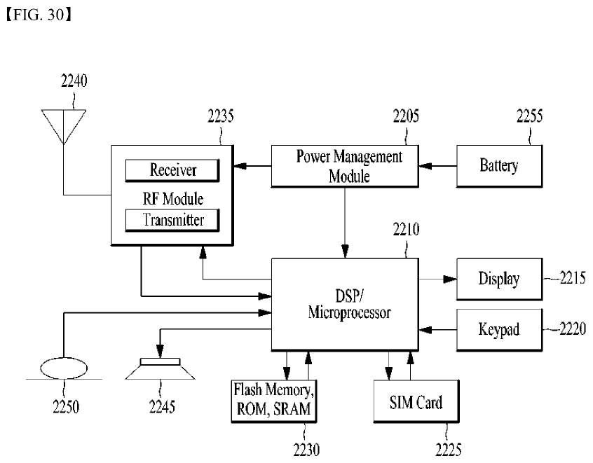

FIG. 30 is a block diagram of a communication device for implementing proposed embodiments.

The device illustrated in FIG. 30 may be a UE and/or a BS (e.g., an eNB or a gNB) adapted to perform the above mechanism or may be any device for performing the same operation.

As illustrated in FIG. 30, the device may include a digital signal processor (DSP)/microprocessor 2210 and an RF module (transceiver) 2235. The DSP/microprocessor 2210 is electrically connected to the transceiver 2235 to control the transceiver 2235. The device may further include a power management module 2205, a battery 2255, a display 2215, a keypad 2220, a SIM card 2225, a memory device 2230, a speaker 2245, and an input device 2250, according to the selection of a designer.

Specifically, FIG. 30 illustrates a UE including the receiver 2235 configured to receive a request message from a network and the transmitter 2235 configured to transmit transmission or reception timing information to the network. The receiver and the transmitter may constitute the transceiver 2235. The UE may further include the processor 2210 connected to the transceiver 2235 (receiver and transmitter).

In addition, FIG. 30 illustrates a network device including the transmitter 2235 configured to transmit a request message to the UE and the receiver 2235 configured to receive transmission or reception timing information from the UE. These transmitter and receiver may constitute the transceiver 2235. The network further includes the processor 2210 connected to the transmitter and the receiver. This processor 2210 may be configured to calculate latency based on the transmission or reception timing information.

Thus, the processor included in the UE (or a communication device included in the UE) according to the present disclosure and the processor included in the BS (or a communication device included in the BS) according to the present disclosure may control the corresponding memories and operate as follows.

In the present disclosure, the UE may include at least one radio frequency (RF) module; at least one processor; and at least one memory operably connected to the at least one processor, for storing instructions for causing the at least one processor to perform a specific operation when the at least one processor is executed. In this case, the communication device included in the UE may be configured to include the at least one processor and the at least one memory. The communication device may be configured to include that at least one RF module or may be configured to be connected to at least one RF module without including the at least one RF module.

The processor included in the UE (or the processor of the communication device included in the UE) receives, through higher layer signaling, configuration information related to one or more of reception of one or more DL signals or transmission of one or more UL signals on a resource not configured either as a DL resource or as a UL resource., and performs PDCCH monitoring in the unlicensed band for the on duration based on DRX being configured for the UE. Based on f receiving configuration information related to the reception of the one or more DL signals and detecting DCI including SFI information through the PDCCH monitoring, the processor may perform the reception of the one or more DL signals on the DL resource in the unlicensed band only when the SFI information indicates that the resource for the reception of the one or more DL signals is a DL resource. Based on receiving configuration information related to the transmission of the one or more UL signals, the processor may transmit the one or more UL signals through the unlicensed band, regardless of whether the DCI is detected through the PDCCH monitoring,.

In a corresponding operation, the processor included in the BS (or the processor of the communication device included in the BS) transmits, through higher layer signaling, configuration information related to one or more of reception of one or more DL signals or transmission of one or more UL signals on a resource not configured either as a DL resource or as a UL resource, and performs a CAP for transmission of DCI including SFI information through the unlicensed band. Based on the configuration information being related to the reception of the one or more DL signals and the DCI being transmitted through the unlicensed band based on the CAP, the processor may transmit the one or more DL signals to the UE through the unlicensed band only when the SFI information indicates that a resource for receiving the one or more DL signals is a DL resource. When the configuration information is related to transmission of the one or more UL signals, the processor may receive the one or more UL signals from the UE through the unlicensed band regardless of whether the DCI is transmitted through the unlicensed band based on the CAP.

Meanwhile, the UE may be any of a Personal Digital Assistant (PDA), a cellular phone, a Personal Communication Service (PCS) phone, a Global System for Mobile (GSM) phone, a Wideband Code Division Multiple Access (WCDMA) phone, a Mobile Broadband System (MBS) phone, a hand-held PC, a laptop PC, a smart phone, a multi-mode multi-band (MM-MB) terminal, etc.

The smart phone is a terminal taking the advantages of both a mobile phone and a PDA. It incorporates the functions of a PDA, that is, scheduling and data communications such as fax transmission and reception and Internet connection into a mobile phone. The MB-MM terminal refers to a terminal which has a multi-modem chip built therein and which can operate in any of a mobile Internet system and other mobile communication systems (e.g., CDMA 2000, WCDMA, etc.).

Embodiments of the present disclosure may be achieved by various means, for example, hardware, firmware, software, or a combination thereof.

In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiments of the present disclosure may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

The present disclosure is applicable to various wireless access systems including a 3GPP system, and/or a 3GPP2 system. Besides these wireless access systems, the embodiments of the present disclosure are applicable to all technical fields in which the wireless access systems find their applications. Moreover, the proposed method can also be applied to mmWave communication using an ultra-high frequency band.

1. A method of operating a terminal in a wireless communication system supporting an unlicensed band, the method comprising:
receiving, through higher layer signaling, configuration information related to one or more of reception of one or more downlink (DL) signals or transmission of one or more uplink (UL) signals on a resource not configured either as a DL resource or as a UL resource;
performing physical downlink control channel (PDCCH) monitoring in the unlicensed band for an on duration, based on discontinuous reception (DRX) being configured for the terminal;
based on the configuration information related to the reception of the one or more DL signals being received, and downlink control information (DCI) including slot format indicator (SFI) information being detected through the PDCCH monitoring, performing the reception of the one or more DL signals on the DL resource in the unlicensed band only when the SFI information indicates that the resource for the reception of the one or more DL signals is a DL resource; and
based on the configuration information related to the transmission of the one or more UL signals being received, performing the transmission of the one or more UL signals through the unlicensed band regardless of whether the DCI is detected through the PDCCH monitoring.

2. The method of claim 1, wherein the resource not configured either as the DL resource or as the UL resource is configured as a flexible resource through the higher layer signaling.

3. The method of claim 1, wherein the resource not configured either as the DL resource or as the UL resource is a resource not configured as a flexible resource by the higher layer signaling.

4. The method of claim 1, wherein the performing of the transmission of the one or more UL signals by the terminal comprises:
transmitting the one or more UL signals in the unlicensed band using a channel access procedure (CAP) to the unlicensed band.

5. The method of claim 1, wherein the SFI information indicates that each symbol included in one or more slots is related to one of a DL symbol, a UL symbol, or a flexible symbol.

6. The method of claim 5, wherein the one slot comprises 14 symbols.

7. The method of claim 1, wherein the one or more DL signals comprises one or more of a physical downlink shared channel (PDSCH) signal or a channel state information reference signal (CSI-RS).

8. The method of claim 1, wherein the one or more UL signals comprises one or more of a sounding reference signal (SRS), a physical uplink control channel (PUCCH) signal, a physical uplink shared channel (PUSCH) signal, or a physical random access channel (PRACH) signal.

9. The method of claim 1, wherein the DCI is configured to be commonly transmitted to a plurality of terminals including the terminal.

10. The method of claim 1, wherein, based on the DRX being configured, the terminal switches to a sleep state when the terminal fails to receive a PDCCH including the DCI for the on duration of the configuration of the DRX.

11. The method of claim 1, further comprising:
receiving a synchronization signal and a physical broadcast channel (PBCH) signal from a base station; and
establishing a radio resource control (RRC) connection with the base station based on the synchronization signal and the PBCH signal,
wherein the receiving and the establishing are performed in order to perform the one or more of the reception of the one or more DL signals or the transmission of the one or more UL signals.

12. The method of claim 11, wherein the establishing of the RRC connection comprises:
transmitting a random access channel preamble to the base station through a physical random access channel (PRACH) resource determined based on the synchronization signal and the PBCH signal;
receiving a random access response (RAR) message in response to the random access channel preamble;
transmitting an RRC connection request message to the base station based on a UL grant included in the RAR message; and
receiving a contention resolution message from the base station in response to the RRC connection request message.

13. A method of operating a base station in a wireless communication system supporting an unlicensed band, the method comprising:
transmitting, through higher layer signaling, configuration information related to one or more of reception of one or more downlink (DL) signals or transmission of one or more uplink (UL) signals to a terminal on a resource not configured either as a DL resource or as a UL resource;
performing a channel access procedure (CAP) for transmission of downlink control information (DCI) including slot format indicator (SFI) information through the unlicensed band;
based on the configuration information being related to the reception of the one or more DL signals and the DCI being transmitted through the unlicensed band based on the CAP, transmitting the one or more DL signals to the terminal through the unlicensed band only when the SFI information indicates that the resource for the reception of the one or more DL signals is a DL resource; and
when the configuration information is related to the transmission of the one or more UL signals, receiving the one or more UL signals from the terminal through the unlicensed band, regardless of whether the DCI is transmitted through the unlicensed band based on the CAP.

14. A terminal operating in a wireless communication system supporting an unlicensed band, the terminal comprising:
at least one radio frequency (RF) module;
at least one processor; and
at least one memory operatively connected to the at least one processor and configured to store instructions causing, when executed, the at least one processor to perform the following operation,
wherein the following operation comprises:
receiving, through higher layer signaling, configuration information related to one or more of reception of one or more downlink (DL) signals or transmission of one or more uplink (UL) signals on a resource not configured either as a DL resource or as a UL resource by controlling the at least one RF module;
performing physical downlink control channel (PDCCH) monitoring in the unlicensed band for an on duration by controlling the at least one RF module, based on discontinuous reception (DRX) being configured for the terminal;
based on the configuration information related to the reception of the one or more DL signals being received, and downlink control information (DCI) including slot format indicator (SFI) information being detected through the PDCCH monitoring, performing the reception of the one or more DL signals on the DL resource in the unlicensed band by controlling the at least one RF module only when the SFI information indicates that the resource for the reception of the one or more DL signals is a DL resource; and
based on the configuration information related to the transmission of the one or more UL signals being received, performing the transmission of the one or more UL signals through the unlicensed band by controlling the at least one RF module, regardless of whether the DCI is detected through the PDCCH monitoring.
